(19) United States
(12) Patent Application Publication
(10) Pub. No.: US 2019/0325668 A1
(43) Pub. Date: Oct. 24, 2019

(54) SUBMERSIBLE INSPECTION SYSTEM

(71) Applicant: ABB Schweiz AG, Baden (CH)

(72) Inventors: Gregory A. Cole, West Hartford, CT (US); William J. Eakins, Bloomfield, CT (US); Daniel T. Lasko, Bloomfield, CT (US); Harshang Shah, Bloomfield, CT (US); Thomas A. Fuhlbrigge, Ellington, CT (US); Carlos Morato, Avon, CT (US); Luiz V. Cheim, St. Charles, MO (US); Poorvi Patel, Ballwin, MO (US); Biao Zhang, West Hartford, CT (US); Sanguen Choi, Simsbury, CT (US); Gregory F. Rossano, Enfield, CT (US); Andrew M. Salm, West Hartford, CT (US); Saumya Sharma, Hartford, CT (US); Stefan Rakuff, Windsor, CT (US); Nolan W. Nicholas, Granby, CT (US)

(21) Appl. No.: 16/434,371

(22) Filed: Jun. 7, 2019

Related U.S. Application Data
(63) Continuation of application No. PCT/IB2017/001619, filed on Dec. 7, 2017.
(60) Provisional application No. 62/431,316, filed on Dec. 7, 2016.
(60) Provisional application No. 62/431,317, filed on Dec. 7, 2016.
(60) Provisional application No. 62/431,319, filed on Dec. 7, 2016.
(60) Provisional application No. 62/431,321, filed on Dec. 7, 2016.
(60) Provisional application No. 62/431,323, filed on Dec. 7, 2016.
(60) Provisional application No. 62/431,325, filed on Dec. 7, 2016.
(60) Provisional application No. 62/431,328, filed on Dec. 7, 2016.
(60) Provisional application No. 62/431,329, filed on Dec. 7, 2016.
(60) Provisional application No. 62/431,332, filed on Dec. 7, 2016.
(60) Provisional application No. 62/431,334, filed on Dec. 7, 2016.
(60) Provisional application No. 62/431,338, filed on Dec. 7, 2016.

(51) Int. Cl. G07C 5/00; G05D 1/00; G01N 1/10

(52) U.S. Cl. CPC G07C 5/008; G05D 1/0038; G21C 17/013; G01N 1/10; G05D 1/0022

(57) ABSTRACT

A submersible inspection system for inspection of liquid cooled electrical transformers having a wirelessly controlled submersible inspective device. A submersion depth of the submersible can be controlled using a ballast system. The system can also include an input/output selector to switch between camera images from the submersible. A heartbeat signal indicative of a health of the transmitted signal can be transmitted to the submersible, and redundant channel selection logic can facilitate switching to a channel that includes a current heartbeat. A plurality of status interrogation systems disposed on the submersible can capture data regarding inspection procedures performed on the transformer, and the submersible can include tools for repair procedures. Data transmitted from the submersible, and overlayed with input data from an operator, can facilitate real time inspection analysis. The system can also form a model of an internal in the transformer, as well as produce a three-dimensional field of view.

### TECHNICAL FIELD

Embodiments of the present application generally relate to submersible inspection systems, and more particularly, but not exclusively, to a system having a submersible inspection device used in the evaluation of the interior of machines, including electrical transformers.

### BACKGROUND

Power transformers are a key component in power transformation and distribution. Large power transformers are extremely heavy, and are difficult to transport and replace. In addition, transformers have a limited life span even if not damaged, and it may be necessary to periodically inspect, maintain and repair power transformers. While online monitoring, dissolved gas analysis, noise level monitoring and related technologies are often used to identify potential transformer problems, the maintenance and repair work is typically required to be performed on site or in a repair shop, both of which require draining of the transformer oil. Yet, physically accessing the interior of the transformer for inspection by a human can be a costly and time-consuming undertaking. There are also safety and environmental considerations involved in the manual inspection, draining and refilling operations.

Therefore, the capability of inspecting the interior of a large power transformer with the cooling oil remaining in the tank is highly desired by the transformer servicing and manufacturing industry. However, internal inspection of transformers is typically possible in only limited applications. Further, for medium and large power transformers, due to certain technical issues, only limited internal areas of the transformer can be visually inspected. Thus, many transformer defects such as damage to transformer windings typcially have to be detected by using indirect techniques, such as by analyzing temperature of the oil, detection of gasses that appear in the oil under certain conditions, and noise level, for example. Further, real time data handling and analysis of the inspection data can present difficulties in such environments. Accordingly, there also remains a need for further contributions in this area of technology.

Accordingly, inspection systems for inspecting machines, e.g., transformers and other machines, remain an area of interest. Further, providing inspection systems having a variety of capabilities, as well as inspection systems that provide the ability to view wirelessly transmitted inspection images from a number of separate cameras on a remotely operated submersible remain areas of interest. Further, inspection systems that provide the ability to select a healthy wireless channel from among a plurality of channels on a remotely operated submersible, and which can provide the ability to inspect submerged objects and construct models of the objects remain areas of interest. Additionally, providing submersible inspection systems that provide liquid tanks with a launch system for inspection submersibles remains an area of interest.

### BRIEF SUMMARY

Embodiments of the present application provide a unique submersible inspection system and method for inspection and evaluation of a machine, including liquid filled electrical transformers. Further, embodiments of the present application provide a unique submersible inspection system and method for acquiring, charting and displaying inspection data related to defective components in a liquid filled housing. Additionally, embodiments of the present application provide a unique submersible inspection system having apparatuses, systems, devices, hardware, methods, and combinations for controlling depth of the submersible, and for wirelessly transmitting information from the submersible. Embodiments also provide a unique submersible inspection system having apparatuses, systems, devices, hardware, methods, and combinations for redundantly receiving wireless signals to submersible drone, and for vision-based modeling using information from the submersible. Further, embodiments of the present application provide a unique submersible inspection system having a unique tank and launch tube combination, and includes apparatuses, systems, devices, hardware, methods, and combinations for launching an inspection submersible into a tank. Additionally, embodiments of the present application provide a unique submersible system that includes apparatuses, systems, devices, hardware, methods, and combinations for wirelessly navigating and three-dimensional mapping of an internal structure of the transformer with a submersible remotely operable vehicle. Embodiments of the present application also provide a unique submersible system that includes an inspection vehicle having one or more maintenance or repair tools for performing maintenance on components in a liquid filled housing, such as a transformer or the like, and provides other embodiments that include apparatuses, systems, devices, hardware, methods, and combinations for an inspection vehicle with maintenance and repair tools. Additionally, embodiments of the present application can include a tethered vehicle for inspecting a liquid filled housing such as a transformer or the like that can include a controllable buoyancy and propulsion system, and can also include a unique vehicle deployment system with a tether arm to facilitate deployment and removal of an inspection vehicle into and out of a liquid filled housing. Other embodiments include apparatuses, systems, devices, hardware, methods, and combinations for a tether having a controllable buoyancy and propulsion system.

Various combinations of the embodiments discussed herein, as well as further embodiments, forms, features, aspects, benefits, and advantages of the present application shall become apparent from the description and figures provided herewith.

### BRIEF DESCRIPTION OF THE DRAWINGS

The description herein makes reference to the accompanying figures wherein like reference numerals refer to like parts throughout the several views.

FIG. 1 illustrates a schematic diagram of an embodiment of a submersible inspection system for in-situ inspection of a liquid filled transformer system according to one exemplary embodiment of the present disclosure.

FIG. 2 illustrates a perspective view of a submersible inspection vehicle or drone of a submersible inspection system according to one exemplary embodiment of the present disclosure.

FIG. 3 illustrates an exploded view of a submersible inspection vehicle or drone according to one exemplary embodiment of the present disclosure.

FIG. 4 illustrates a schematic diagram of at least a portion of a submersible inspection vehicle or drone according to one exemplary embodiment of the present disclosure.

FIG. 5 illustrates another schematic diagram of at least a portion of a submersible inspection vehicle or drone according to one exemplary embodiment of the present disclosure.

FIG. 6 illustrates an operation of an embodiment of a submersible inspection vehicle or drone according to one exemplary embodiment of the present disclosure.

FIG. 7 illustrates an operation of an embodiment of a submersible inspection vehicle or drone according to one exemplary embodiment of the present disclosure.

FIG. 8A illustrates an operation of an embodiment of a submersible inspection vehicle or drone according to one exemplary embodiment of the present disclosure.

FIG. 8B illustrates an operation of an embodiment of a submersible inspection vehicle or drone according to one exemplary embodiment of the present disclosure.

FIG. 9A illustrates an embodiment of a submersible inspection vehicle or drone according to one exemplary embodiment of the present disclosure.

FIG. 9B illustrates an exemplary embodiment of a submersible inspection vehicle or drone.

FIGS. 9C and 9D illustrate an exemplary embodiment of a submersible inspection vehicle or drone.

FIG. 10 illustrates a schematic diagram of a submersible inspection vehicle or drone according to one exemplary embodiment of the present disclosure where two pumps under one control move the submersible inspection vehicle or drone in the Z direction.

FIG. 11 illustrates a schematic diagram of a submersible inspection vehicle or drone according to one exemplary embodiment of the present disclosure where two pumps under two controls move the submersible inspection vehicle or drone in the X direction.

FIG. 12 illustrates a schematic diagram of a submersible inspection vehicle or drone according to one exemplary embodiment of the present disclosure where a single pump under one control moves the submersible inspection vehicle or drone in the Y direction.

FIGS. 13A and 13B illustrate schematic diagrams of a submersible inspection vehicle or drone according to one exemplary embodiment of the present disclosure wherein two pumps under one control operate to rotate the submersible inspection vehicle or drone in a counter-clockwise direction and in a clockwise direction, respectively.

FIGS. 14A and 14B illustrate schematic diagrams of a submersible inspection vehicle or drone according to one exemplary embodiment of the present disclosure wherein one pump operates to rotate the submersible inspection vehicle or drone in a counter-clockwise direction and in a clockwise direction, respectively.

FIG. 15 illustrates a schematic diagram of at least a portion of a submersible inspection vehicle or drone according to one exemplary embodiment of the present disclosure.

FIG. 16 illustrates an embodiment of a launch tube according to one exemplary embodiment of the present disclosure.

FIG. 17 illustrates an embodiment of a launch tube according to one exemplary embodiment of the present disclosure.

FIG. 18 illustrates an embodiment of a tank having a launch tube mounted on top of a tank.

FIG. 19 illustrates an embodiment of a tank having a launch tube mounted on a side of the tank.

FIG. 20 illustrates a schematic diagram of at least a portion of a submersible inspection vehicle or drone according to one exemplary embodiment of the present disclosure.

FIG. 21 illustrates an embodiment of an input/output selector used with a submersible drone.

FIG. 22 illustrates a schematic diagram of at least a portion of a submersible inspection vehicle or drone according to one exemplary embodiment of the present disclosure.

FIG. 23 illustrates exemplary operating logic to select a current channel according to one exemplary embodiment of the present disclosure.

FIG. 24 illustrates a schematic of one embodiment in which a plurality of radios are used in a submersible inspection device.

FIG. 25 illustrates some aspects of a non-limiting example of an inspection vehicle in accordance with an embodiment of the present invention.

FIG. 26 schematically illustrates some aspects of a non-limiting example of a status interrogation system in the form of an ultrasound sensor communicatively coupled to a controller, and to a base station computer via a wireless connection, in accordance with an embodiment of the present invention.

FIG. 27 illustrates some aspects of a non-limiting example of an inspection vehicle and a tank or housing wall having a wall thickness to be measured by an ultrasound sensor in accordance with an embodiment of the present invention.

FIG. 28 schematically illustrates some aspects of a non-limiting example of a status interrogation system in the form of a plurality of microphones communicatively coupled to a controller, and to a base station computer via a wireless connection, in accordance with an embodiment of the present invention.

FIG. 29 schematically illustrates some aspects of a non-limiting example of a status interrogation system in the form of a magnetometer communicatively coupled to a controller, and to a base station computer via a wireless connection, in accordance with an embodiment of the present invention.

FIG. 30 schematically illustrates some aspects of a non-limiting example of the magnetometer of FIG. 29 detecting magnetic field strength in three axes in accordance an embodiment of the present invention.

FIG. 31 schematically illustrates some aspects of a non-limiting example of a status interrogation system in the form of an aliquot collection system in accordance an embodiment of the present invention.

FIG. 32 schematically illustrates some aspects of a non-limiting example of an aliquot collection system plunger drive mechanism communicatively coupled to a controller, and to a base station computer via a wireless connection, in accordance with an embodiment of the present invention.

FIG. 33 schematically illustrates some aspects of a non-limiting example of a status interrogation system in the form of mechanical sampling system in accordance an embodiment of the present invention.

FIG. 34 schematically illustrates some aspects of a non-limiting example of a mechanical sample collection mechanism communicatively coupled to a controller, and to a base station computer via a wireless connection, in accordance with an embodiment of the present invention.

FIG. 35 schematically illustrates some aspects of a non-limiting example of a status interrogation system in the form of a chemical sensor communicatively coupled to a controller, and to a base station computer via a wireless connection, in accordance with an embodiment of the present invention.

FIG. 36 schematically illustrates some aspects of a non-limiting example of a status interrogation system in the form of an infrared thermometry sensor communicatively coupled to a controller, and to a base station computer via a wireless connection, in accordance with an embodiment of the present invention.

FIG. 37 illustrates a flow chart illustrating a method for real time acquiring, handling and displaying inspection data according to another embodiment of the present disclosure.

FIG. 38 illustrates a flow chart illustrating another method for real time acquiring, handling and displaying inspection data according to another embodiment of the present disclosure.

FIG. 39 illustrates a flow chart illustrating another method for real time acquiring, handling and displaying inspection data according to another embodiment of the present disclosure.

FIG. 40 illustrates a flow chart illustrating another method for real time acquiring, handling and displaying inspection data according to another embodiment of the present disclosure.

FIG. 41 illustrates another schematic diagram of at least a portion of a submersible inspection vehicle or drone according to one exemplary embodiment of the present disclosure.

FIG. 42 illustrates an embodiment of computer used with either or both the submersible drone or base station.

FIG. 43 illustrates an embodiment of a vision based modeling system used with a submersible drone.

FIG. 44 illustrates another schematic diagram of at least a portion of a submersible inspection vehicle or drone according to one exemplary embodiment of the present disclosure.

FIG. 45 illustrates a schematic flow diagram for processing video streams from N-cameras to produce a three dimensional field of view for autonomous navigation and mapping by a remotely operable submersible inspection vehicle or drone in a submersed environment.

FIG. 46 illustrates a representation of a projection of a three-dimensional point to a camera plane (u, v).

FIG. 47 illustrates a schematic flow diagram for real-time dense-map fusion and tracking rectification of the video streams from the cameras.

FIG. 48 illustrates a system with multiple cameras facing different views to provide a quasi-spherical field of view (FOV) from an observation position of a remotely operable submersible inspection vehicle or drone.

FIG. 49A illustrates a perspective view of one embodiment of an inspection vehicle with a maintenance tool.

FIG. 49B illustrates an enlarged side view of a portion of a inspection vehicle showing a filter attachment bracket coupled thereto.

FIG. 49C illustrates a side view of a portion of a inspection vehicle with a filter bag connected to the attachment bracket.

FIG. 50A illustrates a side view of a portion of an inspection vehicle with sediment particles being drawn into the inspection vehicle.

FIG. 50B illustrates a side view of a portion of an inspection vehicle with sediment particles discharged into the filter bag.

FIG. 50C illustrates a side view of a portion of an inspection vehicle with sediment particles being trapped in the filter bag while liquid is being discharged through from the filter bag.

FIG. 51 illustrates a component having damaged portions identified by an inspection vehicle.

FIG. 52A illustrates a perspective view of another embodiment of an inspection vehicle with a maintenance tool that includes a plurality of injection nozzles operably coupled thereto.

FIG. 52B illustrates a portion of the inspection vehicle of FIG. 52A approaching a damaged component.

FIG. 52C illustrates a portion of the inspection vehicle of FIG. 52A injecting a liquid repair compound onto the damaged portion of the component.

FIG. 52D illustrates a repaired component after a repair compound has hardened.

FIG. 53 shows a perspective view of another embodiment of an inspection vehicle with a plurality of exemplary maintenance tools operably associated therewith.

FIG. 54 illustrates a perspective view of one embodiment of an inspection system as defined in the present application.

FIG. 55 illustrates a schematic side view of a buoyant element having a plurality of valves to control a buoyancy level.

FIG. 56 illustrates a schematic view of a floating body having a plurality of valves for controlling a buoyancy level and a propulsion system for controlling a position of the floating body.

FIG. 57 illustrates an enlarged view of a tether support and cleaning device attached to a housing proximate an access port.

FIG. 58 illustrates a cross-sectional view of a housing with a deployment apparatus for an inspection vehicle according to one exemplary embodiment of the present disclosure.

FIG. 59A illustrates a cross-sectional view of a deployment apparatus according to one embodiment of the present disclosure.

FIG. 59B illustrates a top view of the deployment apparatus of FIG. 59A illustrating an extendable telescopic arm being rotatable in a plurality of angular locations.

FIG. 60A illustrates a cross-sectional side view of a deployment apparatus according to another exemplary embodiment of the present disclosure.

FIG. 60B illustrates a side view of the deployment apparatus of FIG. 60A with an extendable scissor jack arm illustrated in an extended position.

FIG. 60C illustrates a top view of the deployment apparatus of FIG. 60A illustrating an extendable scissor jack arm being rotatable in a plurality of angular locations.

FIG. 61A illustrates a cross-section side view of a deployment apparatus according to another embodiment of the present disclosure.

FIG. 61B illustrates a top view of the deployment apparatus of FIG. 61A illustrating an extendable articulated arm being movable in a plurality of positions.

The foregoing summary, as well as the following detailed description of certain embodiments of the present application, will be better understood when read in conjunction with the appended drawings. For the purpose of illustrating the application, there is shown in the drawings, certain embodiments. It should be understood, however, that the present application is not limited to the arrangements and instrumentalities shown in the attached drawings. Further, like numbers in the respective figures indicate like or comparable parts.

### DESCRIPTION OF THE ILLUSTRATED EMBODIMENTS

For the purposes of promoting an understanding of the principles of the application, reference will now be made to the embodiments illustrated in the drawings and specific language will be used to describe the same. It will nevertheless be understood that no limitation of the scope of the application is thereby intended. Any alterations and further modifications in the described embodiments, and any further applications of the principles of the application as described herein are contemplated as would normally occur to one skilled in the art to which the application relates.

The present disclosure is directed to a system for in-situ inspection of electrical components or the like in a liquid filled housing, also referred to herein as a tank. A liquid propelled inspection vehicle, also referred to herein as an inspection device, remotely operated vehicle (ROV), drone, and robot, can be controlled wirelessly or with a tether connection within the housing depending on the particular application. In some embodiments, the inspection vehicle can be automatically controlled with a control system. In other embodiments, the inspection vehicle can be controlled in part automatically and in part through manual operator control means. In yet other embodiments, the inspection vehicle can be controlled entirely through manual operator control means. In some embodiments, the inspection vehicle can be submersible, but not have self-propelled capabilities. The operator can be located in close proximity to the housing or alternatively be located anywhere that communication means are available, such as, for example, via internet, intranet or other network connection. Speed and efficiency are critical to inspecting large electrical components, among other machines, because they typically are powered down and/or taken off-line during the inspection and subsequent analysis of the component. Component downtime can be reduced if some of the operator burden in obtaining, charting, displaying and analyzing inspection data can be done automatically in real time during an inspection operation rather than after the inspection event.

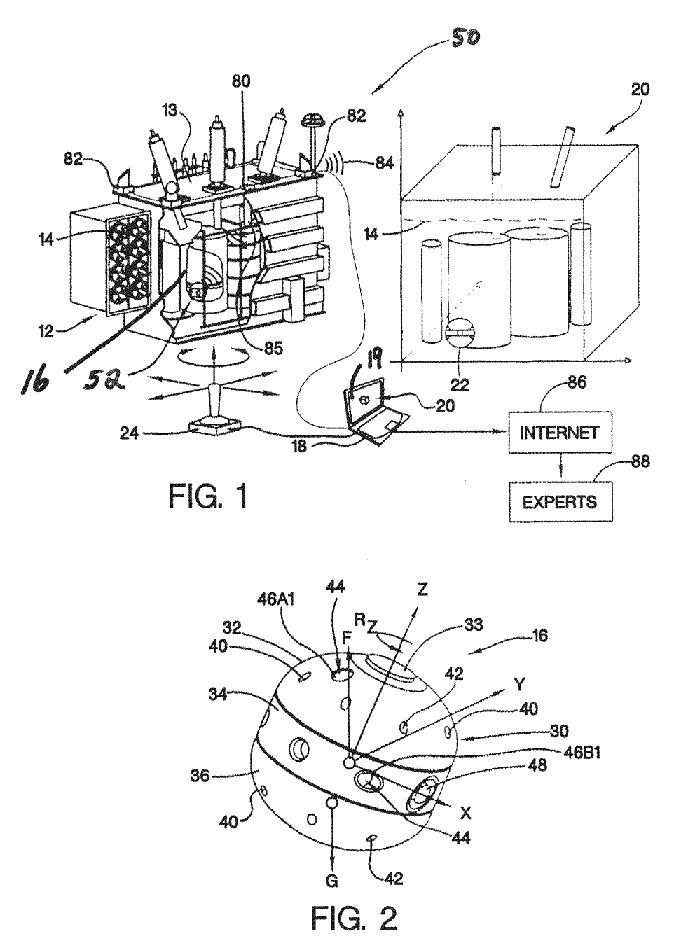

Referring to FIG. 1, a system for in-situ inspection of a liquid filled transformer system designated generally by the numeral 50 is illustrated. It should be understood that while liquid filled electrical transformers are described and referenced in this application, the systems and methods described herein are not limited to liquid filled transformers, but on the contrary can be used with any liquid filled machine, housing, structure or container wherein physical inspection, data collection, data transmittal and repair procedures or the like are desired without prior draining of the liquid from the housing. By way of example, and not limitation, in-situ inspection can be performed on portions of ship hulls, electrical interrupters, high voltage switch gears, nuclear reactors, fuel tanks, food processing equipment, floating roof storage system, chemical storage tank, or other apparatuses of similar nature. In one exemplary embodiment, the system 50 can include a transformer 12 that contains high-voltage electrical components immersed in a cooling fluid 14 such as, for example, a dielectric cooling liquid or oil. Skilled artisans will appreciate that the inspection typically, but not necessarily, occurs when the transformer 12 is offline or not in use. The transformer 12 utilizes the cooling fluid 14 to maintain temperature and disburse heat generated by the internal components during operation of the transformer 12. In some embodiments, the cooling fluid 14 can include dielectric properties such that electrical conduction is reduced or entirely eliminated in the fluid 14.

The transformer 12 can be maintained in a sealed configuration to prevent contaminants or other foreign matter from entering therein. As used herein, a “sealed configuration” of the housing 13, also referred to herein as a tank, allows for conduit ducts or other hardware associated with the transformer 12 to extend through a wall via a sealed joint formed with the housing 13 to allow for connection to the electrical components and/or monitoring devices maintained in the housing 13. The housing 13 is also provided with at least one opening to allow for ingress into and egress out of the housing 13 and/or the filling and/or draining of the cooling fluid. As shown by at least FIG. 1, the transformer 12 has at least one transformer hole 80. In general operation, the oil is inserted through any number of holes located in the top of the housing 13. Holes 80 can also be provided at the bottom of the housing 13 to allow the fluid to be drained. The holes 80 are provided with the appropriate plugs or caps.

The system 50 generally includes an inspection vehicle or device in the form of a submersible remotely operated vehicle (ROV) 52 that is wirelessly controlled from a control station, which, in the illustrated embodiment, includes a processing device, such as a computational device, laptop, or computer 18 and a display 19. The inspection vehicle or ROV 52, sometimes also referred to as a drone or “robot,” is insertable into the housing 13 of the transformer 12 or sealed container, and is contemplated for purposes of various embodiments herein as being movable utilizing either un-tethered, wireless remote control or control through a tether connection. Accordingly, it will be appreciated that the size of the ROV 52 can, according to at least certain embodiments, be sized to fit within the hole 80 of the housing 13. Moreover, the ROV 52 is insertable into the transformer 12 or sealed container and is contemplated for purposes of various embodiments herein as being movable utilizing un-tethered, wireless remote control, although tethering is not precluded. In some embodiments the inspection vehicle, or ROV 52, or a separable portion thereof, can be submersible without having self-propelled motion capability. Of note in FIG. 1, the system 50 includes components generally on the left and bottom side of the figure, with the components on the upper right representing a schematic model of certain aspects of the system 50 (e.g. the tank in which the ROV 52 is operating) which will be understood by those of skill in the art.

As used herein, the term “submersible” includes, but is not limited to, a vehicle capable of operation under the surface of a liquid body. Although much of the description that follows utilizes the term ROV for sakes of brevity and consistency, it will be understood that the various embodiments described herein are not strictly limited to remotely operated vehicles, but can also be utilized with autonomous submersibles as well such as but not limited to those that are remotely triggered but are otherwise autonomous. For example, the inspection vehicles or devices described herein can be static devices that observe and collect data whether remotely operated or in an autonomous configuration. Such a static device can be placed in its location as a result of operation of the ROV or autonomous device. Thus, embodiments of the device 52 are intended to cover a broad range of devices not simply limited to ROVs, and it will be understood that the term ROV encompasses various embodiments described herein, including autonomous submersible robots, drones, and other devices as well, such as but not limited to those that are remotely triggered but are otherwise autonomous. As one non-limiting example, use of the term “drone” is capable of covering ROV as well as autonomous devices or static inspection drones useful for monitoring and/or inspection duties. Thus, the ROV 52 is intended to cover a broad range of robotic inspection devices or vehicles.

Additionally, in many forms, the submersible vehicles described herein are capable of operating in a container that maintains a fluid such as a pool or chemical storage tank, but in other forms can be a sealed container such as a tank. Further, the liquid can take any variety of forms including water, but other liquid possibilities are also contemplated. For example, the submersible ROV 52 shown in the illustrated embodiment is being used to internally inspect a tank or housing 13 and the internal components 16 in the tank or housing 13 of a transformer 12, but other applications are contemplated herein. Skilled artisans will appreciate that the internal inspection typically, but not exclusively, occurs only when the transformer 12 is offline or not in use. In many embodiments, the transformer 12 utilizes its liquid as a cooling fluid 14 to maintain and disburse heat generated by the internal components 16 during operation of the transformer.

The cooling fluid 14 can be any liquid coolant contained within an electrical transformer, such as but not limited to a liquid organic polymer. Such liquid can therefore be transformer oil, such as but not limited to mineral oil. In other forms, the transformer liquid can be pentaerythritol tetra fatty acid natural and synthetic esters. Silicone or fluorocarbon-based oils can also be used. In still other forms a vegetable-based formulation, such as but not limited to using coconut oil, can also be used. It may even be possible to use a nanofluid for the body of fluid in which the robotic vehicle is operating. In some embodiments, the fluid used in the transformer includes dielectric properties. Mixtures using any combination of the above liquids, or possibly other liquids such as polychlorinated biphenyls can also be possible.

The processing device or computational device 18 (depicted as a laptop computer in the illustrated embodiment although other appropriate computer processing devices are also contemplated) can communicate with the ROV 52 either by direct connection through a tether or wirelessly. The computational device 18 can maintain a virtual transformer image 20 of the internal construction of the transformer 12. In some embodiments, this virtual image 20 can be a computer-aided-design (CAD) image generated in construction or design of the transformer 12. However, in other forms, images such as, for example, photographs or actual real time video generated by sensors and cameras associated with the ROV 52 can be utilized. As will be described in further detail, the computational device 18 can utilize the virtual transformer image 20 in conjunction with a virtual inspection vehicle 22, to represent the actual ROV 52, to monitor the positioning of the ROV 52 within the transformer 12.

A motion control input device, such as, for example, a joystick 24 can be connected to the computational device 18 and/or directly to the ROV 52 to allow an operator to control movement of the ROV 52 inside the transformer 12. Control of the ROV 52 can be aided by the visual awareness or observations of the operator or technician and/or by information made available on the display 19, such as, for example, display the virtual inspection vehicle 22 as it moves about the virtual transformer image 20 and/or three-dimensional mapping from an observation. In other words, an operator can control movement of the ROV 52 based on visual awareness of the technician, such as the observed position of the ROV 52, and/or by information made available via the display 19, including, for example, the observed position of the virtual inspection vehicle 22 as it moves about the virtual transformer image 20. Other types of motion control input devices, such as, for example, those used with video games, handheld computer tablets, and computer touch screens or the like can be employed without deviating from the teachings herein. It should be understood that in some applications the operator can be located on-site or near the apparatus to be inspected. However, in other applications the operator can be located off-site and indeed anywhere in the world through communication via World Wide Web internet or other network or internet connection.

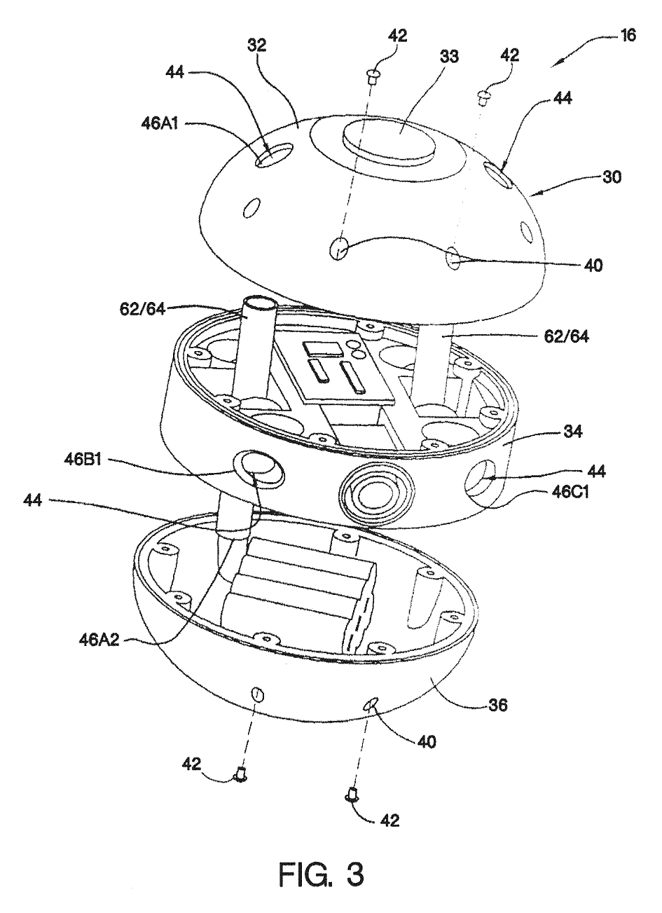

Referring now to FIGS. 2-4, the ROV 52 includes a vehicle housing 30 that is substantially cylindrical or spherical in construction with no significant protrusions or extensions that might otherwise be entangled with the internal components within the transformer 12. The vehicle housing 30 of the ROV 52 includes an upper cover 32 having a minimally extending nub 33, a middle section 34 and a lower cover 36. The nub 33 is sized to allow for grasping of the ROV 52 from within the transformer 12 by a tool or by an operator's hand. The nub 33 could have other shapes, such as, for example, a loop, to facilitate easy grasping, depending on the type of tool used to grasp the ROV 52. The cover 32, the middle section 34 and the cover 36 can be secured to one another with fastener apertures 40 that extend through at least the covers 32 and 36 to receive fasteners 42 to allow for attachment to the middle section 34. In most embodiments, the fasteners 42 are maintained flush with the surface of the cover to minimize drag and prevent entanglement with internal components of the transformer 12. Other forms of mechanical fastening can be used, such as, for example, threaded engagement, press-fit or mechanical clip or the like. Further, in some embodiments, the ROV 52 can only include two sections, and in other embodiments the ROV 52 can include four or more sections.

Extending through the vehicle housing 30 are at least two pump flow channels designated generally by the numeral 44. These channels extend vertically and horizontally through the vehicle housing 30 and are configured to be sealed from the internal components of the vehicle housing 30. Each flow channel 44 provides a pair of ports 46. As shown in the drawings, numeric and alphabetic designations are provided so as to identify particular ports. For example, port 46A1 is at one end or side of the vehicle housing 30 while the opposite end of the flow channel 44 is designated by port 46A2. As such, the fluid maintained within the transformer can flow from one port 46A1 through and exit out port 46A2. In a similar manner, the oil can flow through port 46B1 and out through port 46B2. As will be discussed, components maintained within the channels move the fluid in either direction, through the ROV 52 and thus allow the ROV 52 to move within the transformer 12. It should be appreciated that alternate flow channel configurations could be implemented. For example, fluid could enter the ROV 52 through a single inlet and internal valves could route the fluid to all outlet ports. In another example, the vertical path could have one inlet port and two or more outlet ports.

At least one sensor 48 is carried by the vehicle housing 30 and, in some embodiments, the sensor 48 is one or more cameras. Other sensors can be used in some embodiments such as, by way of non-limiting examples, proximity sensors, acoustic sensors, electromagnetic sensors, voltage sensors, amperage sensors, pressure sensors and temperature sensors. According to embodiments in which the sensor 48 is a camera, the camera can be configured to receive and transmit images through a plurality of wavelength images of the internal components of the transformer 12. The wavelengths can include visible, infrared, or others as desired. These images allow an operator to monitor and inspect various components within the transformer 12.

In some embodiments, the vehicle housing 30 can include one or more light sources 53 that facilitate illumination of the area surrounding the ROV 52. In some embodiments, the lights 53 can be light emitting diodes, but it will be appreciated that other illumination devices can be used. For example, one or more of the lights 53 can include ultraviolet (UV) frequencies that can be used to cure UV hardened adhesives or the like. The illumination devices can be oriented to illuminate the viewing area of a camera of the ROV 52. In some embodiments, the operator can control the intensity and wavelength of the light.

A battery pack 54 is maintained within the ROV 52 to power the internal components of the ROV 52, such as, for example, the sensor 48, the lights 53 and a controller 60. The controller 60 operates the sensor 48 and lights 53 and controls operation of a motor 62 and a pump 64 which are used in combination with each of the provided pump flow channels 44. The controller 60 maintains the necessary hardware and software to control operation of the connected components and maintain the ability to communicate with the computational device 18 as well as with other devices. The controller 60 provides functionality in addition to controlling the motion of the ROV 52. For example, the controller 60 can provide for a data recording function so that a high-resolution, high-speed video of the entire inspection area generated by the sensor 48 can be recorded and stored onboard by the storage device 68. On board storage can be used in instances where wireless streaming of the video is interrupted or the antenna transmission of the wireless signals has a lower than desired bandwidth. Skilled artisans will appreciate that the sensor 48 can also be a thermal camera, a sonar sensor, a radar sensor, a three-dimensional vision sensor, or any combination of sensors.

The motors 62 are used to provide power to a propulsor (e.g. an impeller) which are used to control and/or provide propulsive power to the ROV 52. Each motor 62 can be reversible to control the flow of fluid, such as, for example, cooling fluid or oil 14, through the flow channels. Moreover, each motor 62 can be operated independently of one another so as to control operation of an associated propulsor (e.g. a thruster pump), referred to herein as pump 64, such that rotation of the pump 64 in one direction causes the liquid to flow through the flow channel 44 in a specified direction and thus assist in propelling ROV 52 and/or vehicle housing 30 in a desired direction. Other configurations of the propulsor are also contemplated beyond the form of a propeller mentioned above, such as, for example, alternatively, or additionally, a paddle-type pump.

In some embodiments, a single motor can be used to generate a flow of fluid through more than one channel. In other words, the vehicle housing 30 of the ROV 52 could provide a single inlet and two or more outlets. Valves maintained within the vehicle housing 30 could be used to control and re-direct the internal flow of the fluid and, as a result, control movement of the ROV 52 and/or vehicle housing 30 within the transformer tank or housing 13. Fluid flow from the motor can also be diverted such as through use of a rudder, or other fluid directing device, to provide the steerage necessary to manipulate the vehicle. By coordinating operation of the motors and/or valves and/or a fluid directing device(s) with a controller, and thus the oil flowing through the vehicle housing 30 of the ROV 52, the ROV 52 can traverse all areas having sufficient space within the transformer 12. Moreover, the ROV 52 is able to maintain an orientational stability while maneuvering in the transformer tank or housing 13. In other words, the ROV 52 is stable such that it will not move end-over-end while moving within the transformer tank or housing 13.

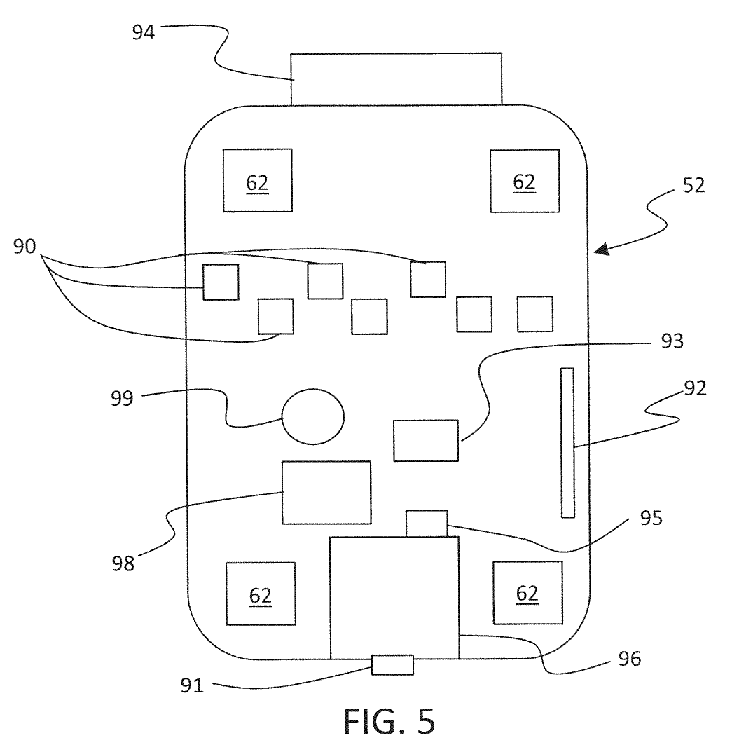

FIG. 5 illustrates another embodiment of the ROV 52 is depicted as including a number N of cameras 90, motors 62 and transmitter and/or receiver 92. Other components can also be included in the ROV but are not illustrated for sake of brevity (e.g. a battery to provide power to the cameras, additional sensors such as rate gyros or magnetometers, etc.). The cameras 90 are utilized to take visible and other wavelength images of the internal components of the transformer. In one embodiment of the ROV 52 a number of cameras are fixed in orientation and do not have separate mechanisms (e.g. a servo) two change their point of view. In other embodiments all cameras the ROV 52 have a fixed field of view and not otherwise capable of being moved. These images allow technicians to monitor and inspect various components within the transformer. The cameras 90 can take on any variety of forms including still picture and moving picture cameras (e.g. video camera). Any number and distribution of the cameras 90 are contemplated. In one form, ROV 52 can have an array of cameras 90 distributed in one region, but in other forms, the cameras 70 can be located on all sides of the ROV 52. In some embodiments, the ROV 52 is provided with lights that facilitate illumination of the area surrounding the inspection device 52. In some embodiments, the lights are light emitting diodes, but it will be appreciated that other illumination devices could be used. The illumination devices are oriented to illuminate the viewing area of one or more of the cameras 90. In some embodiments, the user can control the intensity and wavelength of the light.

The transmitter and/or receiver 92 can be connected to a controller on board the ROV 52 for the purpose of transmitting data collected from the cameras 90 and for sending and receiving control signals for controlling the motion and/or direction of the ROV 52 within the transformer. The transmitter and/or receiver 92 is structured to generate a wireless signal that can be detected by the computer or any intermediate device, such as through reception via the transmitter and/or receiver 82.

Other aspects of an exemplary remotely operated submersible that is operated in a fluid filled transformer tank, as described in FIG. 1 or 2, are described in international application publication WO 2014/120568, the contents of which are incorporated herein by reference.

Referring now to FIGS. 1 and 2, transmissions, including wireless signals, transmitted between the ROV 52 and computational device 18, and moreover, from either or both of transmitters and/or receivers 82 and 92, can occur over a variety of manners, including various frequencies, powers, and protocols. In some applications the communication between the ROV 52 and the base station, or computational device 18, can be supplemented with a repeater or relay station, but not all embodiments need include such devices. The manners of transmission between 82 and 92 need not be identical in all embodiments. To set forth just a few examples, the transmitter and/or receiver 68 used for broadcast of signals from the base station, or computational device 18, can transmit in power that ranges from 1 W to 5 W. The base station, or computational device 18, can also transmit in frequencies that that range from about 300 MHz to about 5 GHz, and in some forms are at any of 300 MHz, 400 MHz, 433 MHz, 2.4 GHz, and 5 GHz. Other frequencies can be employed in other embodiments. Transmission can occur using any variety of protocols/formats/modulation/etc. In one example, transmission from the base station can use digital radio communications such as that used for RC model cars/boats/airplanes/helicopters. The transmission can also occur as TCP/IP or UDP, it can occur over WiFi radios, serial communication over Bluetooth radios, etc. In one particular form, video transmissions can occur as streaming for a Wi-Fi camera over 2.4 GHz.

In much the same manner as the transmitter(s) and/or receiver(s) 82 of the base station, the transmitter(s) and/or receiver(s) 92 of the ROV 52 can transmit in power that ranges from 250 mW to 3 W. The base station can also transmit in frequencies that that range from about 300 MHz to about 5 GHz, and in some forms are at any of 300 MHz, 400 MHz, 433 MHz, 2.4 GHz, and 5 GHz. Transmission can occur using any variety of protocols/formats/modulation/etc. In one example, transmission from the base station can use digital radio communications such as that used for RC model cars/boats/airplanes/helicopters. The transmission could be video over IP, and one embodiment of IP could be WiFi/WLAN. In one non-limiting embodiment the transmission can therefore occur as TCP/IP or UDP, it can occur over WiFi radios, serial communication over Bluetooth radios, etc. In one particular form, video transmissions can occur as streaming for a Wi-Fi camera over 4.2 GHz. In short, a variety of transmission techniques/approaches/protocols/frequencies/etc. are contemplated herein.

Referring again to FIGS. 2-4, according to certain embodiments, the vehicle housing 30 of the ROV 52 provides for a center of gravity designated by the capital letter G. The ROV 52 components are designed so that the center of gravity G is lower than the center of the buoyant force of the ROV 52 designated by the capital letter F. As skilled artisans will appreciate, this enables the ROV 52 to be provided with stability during traversal motion.

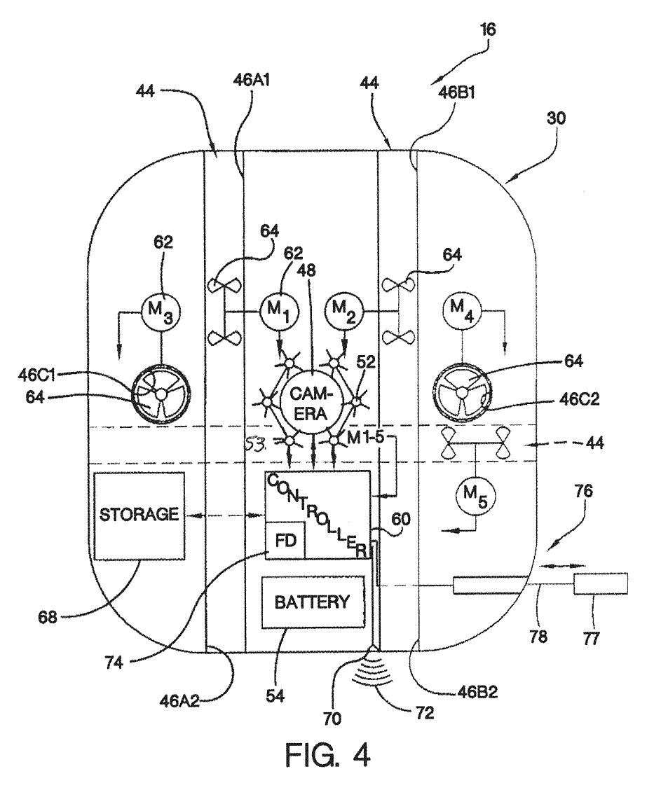

The vehicle housing 30 also carries a data storage device 68 that collects the data from the sensor 48, and which is adequately sized to provide for storage of video or still images taken by a camera. The storage device 68 is connected to the controller 60 to provide for reliable transfer of the data from the sensor/camera 48 to the storage device 68. It will be appreciated that in some embodiments, the storage device 68 is connected directly to the sensor 48 and the controller receives the data directly from the storage device 68. An antenna 70 is connected to the controller 60 for the purpose of transmitting data collected from the sensor 48 and for sending and receiving control signals for controlling the motion and/or direction of the ROV 52 within the transformer 12. The antenna generates a wireless signal 72 that can be detected by the computational device 18 or any intermediate device. A failure detection module 74 (designated as FD in FIG. 4) can be included in the controller 60 to shut down the internal components within the ROV 52 if a system failure is detected. For example, if a low battery level is detected by the controller 60, the module 74 and the controller 60 can begin a controlled shutdown of the ROV 52 that would cause the ROV 52 to float to the surface due to its positive buoyancy. In another example, a loss of connection to the remote system could also trigger a shutdown.

After floating to the surface, the vehicle housing 30 can be grasped by the nub 33. A borescope 76 can also be carried by the vehicle housing 30. One end of the borescope provides a camera 77 or other sensor connected to a retractable fiber-optic cable 78 that is connected at its opposite end to the controller 60. When in a retracted position the camera 77 is flush with the surface of the vehicle housing 30 to prevent entanglement with the components inside the transformer 12. When inspection of hard to view items is needed, such as, for example, the windings of the transformer 12, the cable 78 is extended while the ROV 52 is maintained in a stationary position. After images and other data are collected by the camera 77, the cable 78 is retracted. As a result, the borescope 76 allows further detailed inspection of the transformer 12.

As noted previously, the ROV 52 is configured to relatively easily move around the obstacles within the transformer 12. The vehicle housing 30 is a cylindrical-shaped with sphere ends or sphere shaped configuration and is provided with a buoyant design to allow the ROV 52 to float to the top of the oil when it is powered off purposefully or accidentally. The ROV 52 is configured to allow for the thruster pumps 64 to move the ROV 52 around by selective actuation of each pump. As a result, the ROV 52 has four degrees of freedom or motion: X, Y, Z and rotation around Z. As a result, by controlling the direction of the pump thrusters 64, the ROV 52 can be easily moved.

The transformer 12 can be configured with a plurality of signal transmitters and/or receivers 82 mounted on the upper corners, edges or other areas of the transformer 12, or in nearby proximity to the transformer 12. The signal transmitters and/or receivers 82 are structured to send and/or receive a wireless signal 72 from the ROV 52 to determine the position of the ROV 52 in the transformer tank or housing 13. It will be appreciated that in some forms the transmitter and/or receiver 82 can include any number of separate transmitter and/or receiver pairings to accommodate a similar number of transmitter and/or receivers that can be used in the ROV 52 for redundancy, some embodiments of which will be described further below. It will be appreciated given the disclosure herein that mention of transmitter and/or receiver 82 can refer to multiple separate transmitters and/or receivers that are paired with a corresponding transmitter and/or receiver on the ROV 52.

The transmitters and/or receivers 82 can be a transceiver in one embodiment, but can include a transmitter and antenna that are separate and distinct from one another in other embodiments. For example, the transmitter can be structured to send information using different frequencies/modulation/protocols/etc. than an antenna is structured to receive. Thus as used herein, the term “transmitter” and “antenna” can refer to constituent parts of a transceiver, as well as standalone components separate and apart from one another. No limitation is hereby intended unless explicitly understood to the contrary that the term “transmitter” and/or “antenna” are limited to stand-alone components unless otherwise indicated to the contrary. Furthermore, no limitation is hereby intended that the use of the phrase “transmitters and/or receivers” must be limited to separate components unless otherwise indicated to the contrary.

The transmitters and/or receivers 82 can use triangulation, based on the signals 72 received or other methodology, to determine a position of the ROV 52 in the transformer tank or housing 13. This position information is then transmitted by a signal 84, either wired or wirelessly, to the computational device 18.

Additionally, according to at least certain embodiments, the informational data collected or gathered by any sensor(s) associated with the ROV 52, such as, for example, visual data collected in connection with the use of previously discussed sensor 48, can be transferred to the computer or other visual receiving device separately. Further, the informational data generated by any sensor associated with the ROV 52, such as, for example, previously discussed sensor 48, can be transmitted to the controller of the ROV 52 and/or the computational device 18 through the fluid and the tank wall with the openings 80. Use of these different communication paths can be used to prevent interference between the signals, which can at least assist in reliable communication for the motion control of the ROV 52 and data/video streaming during the transformer 12 in-situ inspection. However, some embodiments can utilize the same communication path to transfer data related to positioning, data information, and control information as appropriate. Further, utilizing the dielectric feature of the transformer coolant oil, the ROV 52 can be controlled by radio frequencies rather effectively. Additionally, video streaming for a Wi-Fi camera (e.g. 4.2 GHz) has been proven sufficient.

According to certain embodiments, the reliability of communications between the ROV 52 and the computational device 18 can be enhanced by the inclusion of a transceiver 85 that can be inserted into the cooling oil tank through the service opening on the top of the transformer 12. According to certain embodiments, the transceiver 85 can be used to exchange data information from the sensor 48 and the camera 77, via the controller 60 to the computational device 18; and motion control or maneuvering signals from the joystick 24 via the computational device 18 to the controller 60 to operate the motors 62 and thrusters 64. Further, the signal 84, transmitted by the transmitters and/or receivers 82 can be used by the computational device 18 to provide a separate confirmation of the position of the ROV 52 within the transformer tank or housing 13.

The computational device 18 receives the position signals 84 and information signals 72 and in conjunction with the virtual image 20 correlates the received signals to the virtual image to allow an operator to monitor and control movement of the ROV 52. This allows the operator to inspect the internal components of the transformer 12 and pay particular attention to certain areas within the transformer 12 if needed. By utilizing a virtual image of the internal features of the transformer 12 and the position of the ROV 52 with respect to those virtual features, the image obtained can be matched with the corresponding site inside the actual transformer tank or housing 13. Based on the visual representation of the transformer image 20 and the virtual inspection vehicle 22 in relation to the image, an operator can manipulate the joystick 24 response. The computational device 18 receives the movement signals from the joystick 24 and transmits those wirelessly to the antenna 72, whereupon the controller 60 implements internally maintained subroutines to control the pump thrusters 64 to generate the desired movement. This movement is monitored in real-time by the operator who can re-adjust the position of the ROV 52 as appropriate.

In some embodiments the computational device 18 can be connected to another computer via a network 86, such as, for example, the internet, so as to allow for the images or sensor data to be transferred to experts, who can be remotely located, designated by the block 88 so that their input can be provided to the operator or technician so as to determine the nature and extent of the condition within the transformer 12 and then provide corrective action as needed. In some embodiments, control of the ROV 52 can also be transferred to an expert, who can be remotely located. In such embodiments, the expert would have another computer that can send control signals via the network 86 to the local computational device 18 that in turn sends signals to control the ROV 52 as described above.

Referencing FIGS. 10-14B, it can be seen that control of the motors and pump thrusters, and the direction of fluid flow through the channels, can control the motion of the ROV 52 within a fluid. For example, FIG. 10 shows the utilization of two pumps under one control to move the ROV 52 in a Z direction (see FIG. 2). To drive along the Z-axis and to remain a stable depth, the Z-axis thrusters have to run continuously. The Z thruster action can be controlled either manually by the operator or automatically by the controller. As used herein, the terminology “one control” refers to operating two pumps to operate in conjunction with one another so that the fluid flow is uniformly in one direction or the other.

In FIG. 11, it can be seen that an X direction (see FIG. 2) can be obtained by utilizing two pumps under two controls to allow for movement in an X direction. As used herein, operation of “two pumps under two controls” means that the controller operates the pumps separately from one another. In FIG. 12, it can be seen that the ROV 52 is movable along the Y direction (see FIG. 2) wherein one pump is utilized under one control. It will be appreciated that FIG. 12 is a side view of FIG. 11 and at a slightly different elevation with respect to the X directional flow channels. As mentioned above, other embodiments could use different combinations of channels. For example, the three or four channels could exist in the Z direction. Further, other embodiments could have one inlet port and two outlet ports for a channel, or vice versa or even use a different number of inlets and outlets. The number of pumps could also vary. For example, one pump could be used to control the flow of fluid from one inlet port that is then output through four outlet ports.

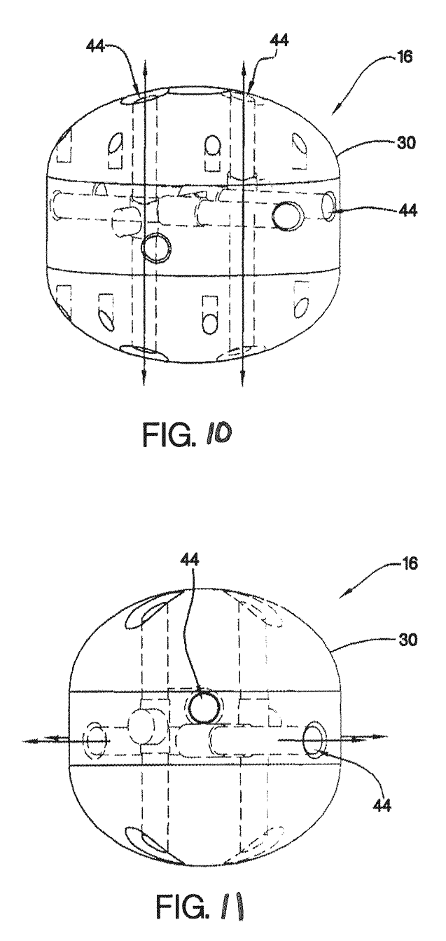

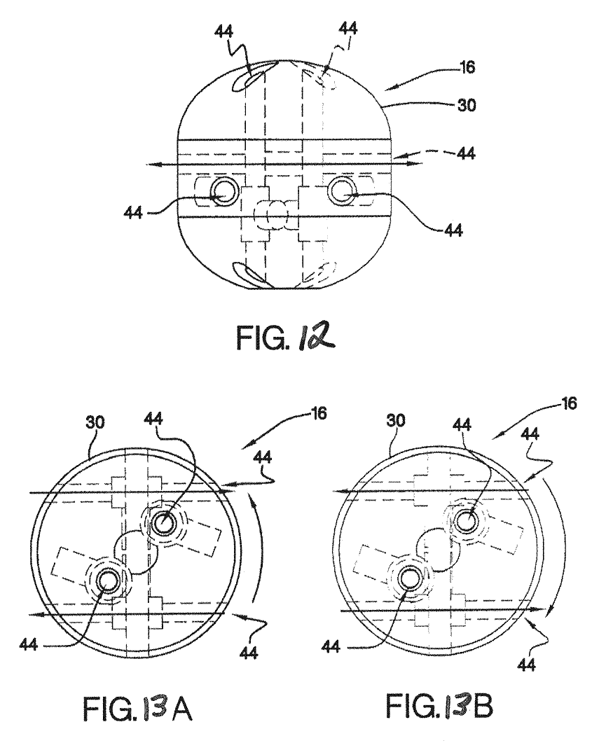

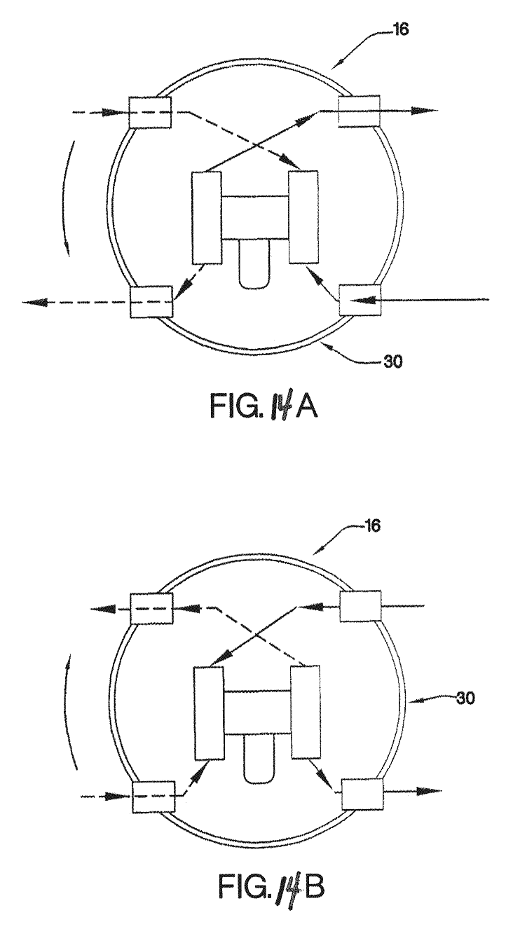

In FIGS. 13A and 13B, it can be seen that two pumps under one control allow for rotation of the ROV 52. In FIG. 13A, by directing the fluid flow in one direction through one channel and an opposite direction in another channel, counter-clockwise rotation can be obtained. By reversing the flows in both channels, clockwise rotation can be obtained as seen in FIG. 13B. In another variation, FIGS. 14A and 14B show rotation of the ROV 52 utilizing one pump under one control wherein the flow is directed from one side of the ROV 52 into the ROV 52 and then back out the same side. A corresponding flow is provided by the opposite side of the ROV 52 to provide for rotation about the Z-axis. Reversing the flow provides a corresponding reversal of the rotation of the ROV 52 along the Z-axis.

The ROV 52 allows for visual and other inspection without draining the transformer oil. This is accomplished by being able to control the ROV 52 in the oil and perform visual or other inspection through the oil. The ROV 52 is constructed to be resistant to an oil environment and is properly sealed. Additionally, the ROV 52 is small enough to be put inside a transformer tank or housing 13 using existing service holes, e.g. those used for filling the transformer oil. As a result, it is not needed to unseal the transformer tank top completely. Another aspect is that the ROV 52 can be controlled from the outside of the transformer using a joystick 24 and computing device 18 which can also be used for displaying or presenting visual data from the sensor(s).

As internal regions of a transformer have no ambient light, the sensor 48 utilizes a supporting light source carried by the ROV 52. Various wavelengths of light can be used (visible and/or non-visible light) for detailed inspection of the transformer 12 components inside. A remotely controlled arm that guides a thin fiber-optic camera head inside the transformer 12 winding block can also be used. Still another aspect of the ROV 52 is that all materials employed in the construction of the ROV 52 are oil compatible. This is to avoid any type of contamination introduced by the ROV 52, so that the transformer 12 can directly return to operation after the inspection of ROV 52 without oil treatment.

As skilled artisans will appreciate, the transformer 12 is typically maintained in a sealed configuration to prevent contaminants or other matter from entering. As used herein, a “sealed configuration” of the tank or housing 13 allows for sealed conduits and/or ducts to be associated with the transformer's tank or housing to allow for connection to the electrical components and/or monitoring devices maintained in the tank. The housing 13 is also provided with at least one opening, such as, for example, one or more holes 80, to allow for the filling and/or draining of the cooling fluid. As shown in FIG. 1, a hole 80 can be an existing service hole, e.g. those used for filling the cooling fluid 14, among other fluids, and/or those used to enter a tank or housing 13 upon servicing by a technician. In general, operation, the cooling fluid 14 is inserted through any number of holes 80 located in the top of the housing 13. Holes 80 can also be provided at the bottom of the housing 13 to allow for the cooling fluid 14 to be drained. The holes 80 are provided with the appropriate plugs or caps. In some embodiments the hole 80 can be sized and structured such that the transformer tank top need not be unsealed completely or at all to introduce the submersible ROV 52. Accordingly, it will be appreciated that the size of the inspection device, or ROV 52, can be such that it can fit within a designated hole, whether the hole is the hole 80 depicted in the illustration or other types of access points discussed elsewhere herein and/or appreciated by those of skill in the art.

As discussed below, according to certain embodiments, the system 50 can include a submersible inspection drone or ROV 52 having a ballast system that can include a pressure vessel for storing ballast fluid (e.g. air) and a ballast bag for inflating and deflating to change a displacement and thus buoyancy of the submersible inspection drone. A control valve and a check valve are also included. The control valve permits pressurized air in the ballast bag to inflate the ballast bag. A pump can be used to draw fluid from the ballast bag and store the fluid in the pressure vessel. The check valve can be used to draw air in from an open interior of the submersible inspection drone to be stored in the pressure vessel. Thus, as discussed below, according to certain embodiments, the ballast system can evacuate an internal cavity of the submersible inspection vehicle or ROV 52.

More specifically, referencing FIGS. 5-9, according to certain embodiments, the ROV 52 includes a ballast system capable of inflating and deflating a flexible ballast bag 94, also referred to herein as an inflatable bladder. The ballast system is also capable of removing air from an open interior 96 of the ROV 52 in some embodiments and storing the removed air in a pressure vessel 98. The ballast system can include the flexible ballast bag 94, the pressure vessel 98, a pump 99, valve 93, and check valve 95. In some embodiments, the open interior 96 can be considered part of the ballast system, but other embodiments can consider the open interior 96 to be apart from but nevertheless fluidically connected with the ballast system in the manner discussed above and further below.

The open interior can have a cover 91 that permits access to the open interior 96. The open interior 96 can be used for any variety of purposes, and have a variety of forms. In some embodiments, the open interior is a larger space that is connected to the opening through an open interior conduit. Thus, no limitation is hereby intended by virtue of the shape depicted in the embodiment shown in FIG. 5. In some embodiments, the open interior provides a space for components of the ROV 52 such as, but not limited to batteries, controllers, sensors, electronics, etc. In some embodiments, the cover 91 can be considered integral with the housing of the ROV 52. For example, the housing/hull of the ROV 52 can be capable of being split in two, with either a top half or bottom half considered the ‘cover’ 91 which permits access to the open interior 96. The cover 91 can be fastened to enclose the interior of the ROV 52 by any variety of mechanisms, including mechanical (e.g. screw threaded cover, bolted connection, riveted, etc.), metallurgical (e.g. brazing or welding, etc.), or chemical (e.g. bonding, etc.), to set forth just a few non-limiting embodiments.

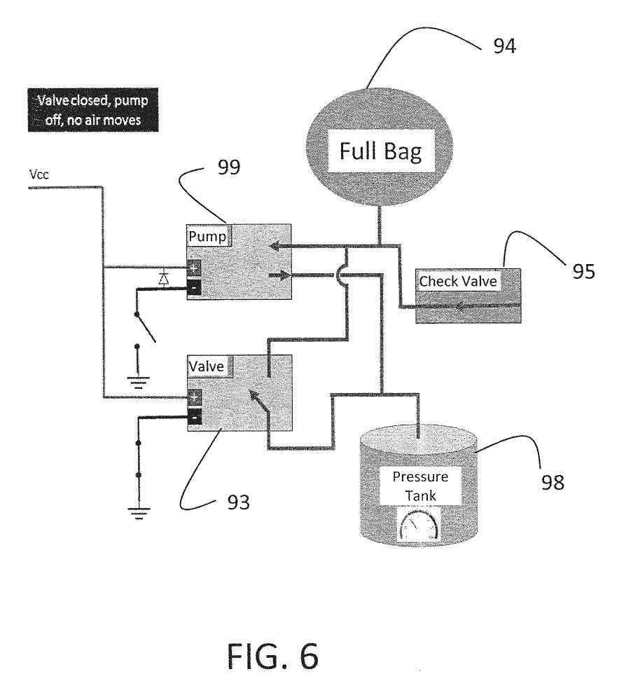

Turning now to FIGS. 6-9, various embodiments and operational modes of the ROV 52 ballast system are described, in which the interconnection of various components are also described. FIGS. 6-8B depict different modes of operation of the ballast system, and of note is the power configuration of each of the pump 99 and valve 93. When the pump 99 is energized, it is structured to draw air in through an inlet that can be connected to the ballast bag 94 and the check valve 95. The valve 93 is configured such that it is in a closed state which discourages fluid to flow from the pressure vessel 98 when power is applied to the valve 93; the valve 93 is configured to be in an open state which permits fluid to flow from the pressure vessel 98 to the ballast bag 94 when power is removed from the valve 93.

FIG. 6 depicts a mode of operation in which power is applied to the valve 93, but removed from the pump 99. In this configuration none of the fluid in the ballast system (in this case air, but other gases can also be used) moves between the components. For example, without aid of the pump 99, no air is moved to the pressure vessel 98. Likewise, since the valve 93 is closed, no fluid is moved to the ballast bag 94.

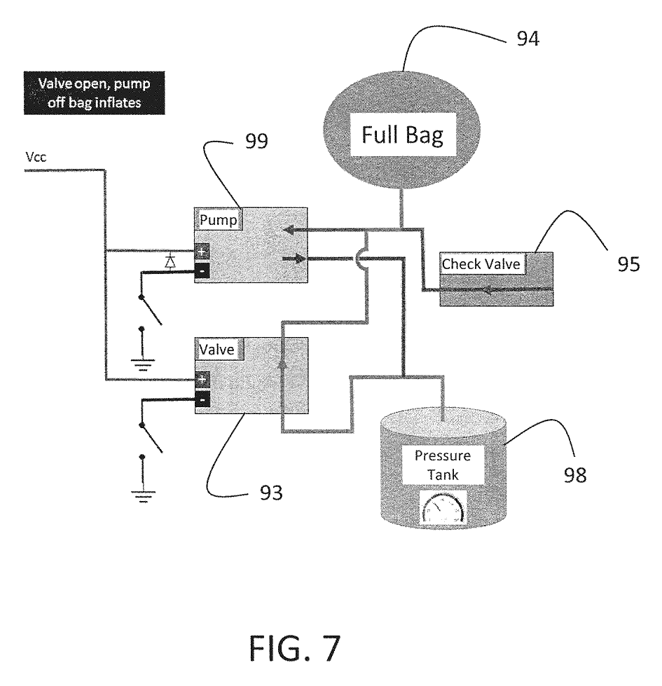

FIG. 7 depicts a mode of operation in which power is off in both the pump 99 and the valve 93. In this configuration fluid is allowed to flow from the pressure vessel 98 to the ballast bag 94 until either pressure is balanced between the bag 94 and vessel 98, or until power is restored to the valve 93 to once again close off the valve. It can be noted in this embodiment that the valve 93 can act as a safety mechanism in case of total power failure in which the ballast bag 94 will become inflated which permits top side recovery of the ROV 52. Also of note in this embodiment, fluid from the pressure vessel 98 (e.g. air) will traverse a portion of conduit in a reverse direction as would be typically when the pump 99 is used to draw air from the ballast bag 94, as will be described immediately below.

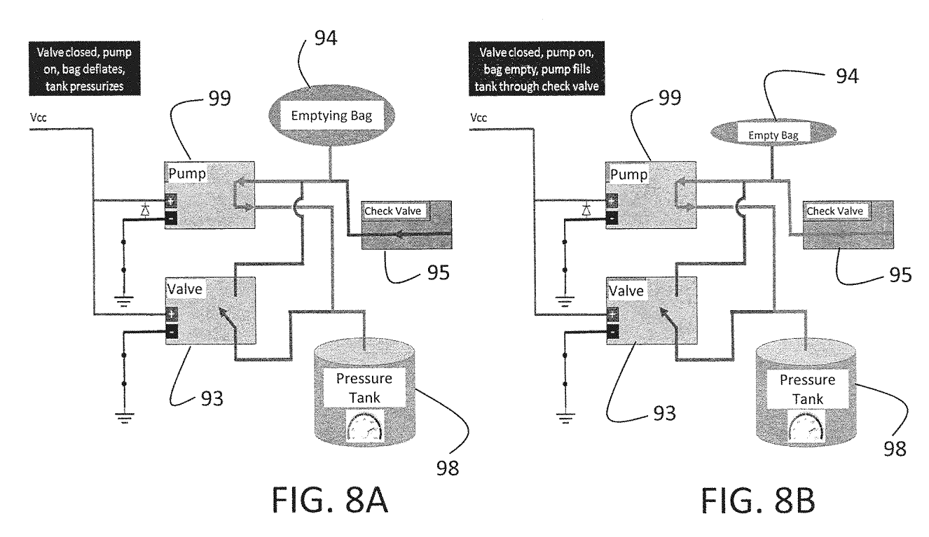

FIGS. 8A and 8B depict a mode of operation in which power is applied to both the pump 99 and valve 93. In this configuration, fluid (e.g. air) is allowed to flow from the pump 99 to the pressure vessel 98. In many embodiments, the pressure vessel 98 is a rigid vessel. The embodiment depicted in FIG. 8A illustrates the draw down of air from the ballast bag 94, through the pump 99, and finally to the pressure vessel 98. The embodiment depicted in FIG. 8B illustrates the situation in which no further air can be delivered from the ballast bag 94 to the pump (e.g. by virtue of an empty bag or a bag that has reached a mechanical limit in its ability to flex any further to expel remaining air) in which case the check valve 95 will open and draw air once the pressure in the pump and bag system drop below the pressure beyond the check valve. The check valve 95 is in fluid communication with the open interior 96 mentioned above which allows air to be pulled in from the open interior 96 and delivered to the pressure vessel 98. In this way, any leakage of air from an interior of the ROV 52 can be addressed by drawing down the air pressure in the open interior 96 to mitigate the effects of air leakage into the transformer tank (or other type of closed vessel sensitive to the presence of a foreign fluid such as air). The air can be drawn down from the open interior 96 for a period of time suitable for the circumstance, at which time the ballast bag 94 can be re-inflated to resume operations or for purposes of recovery.

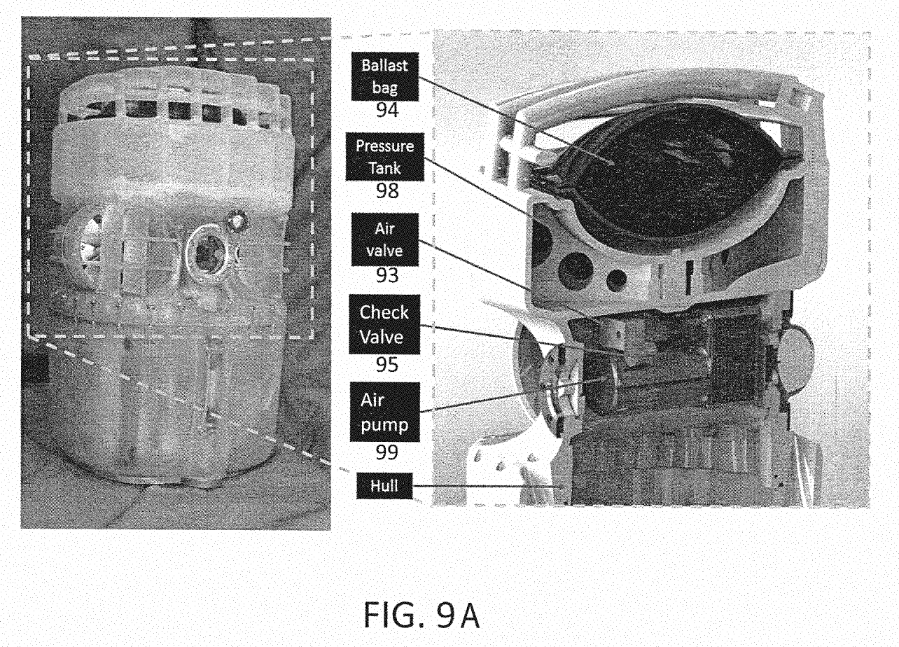

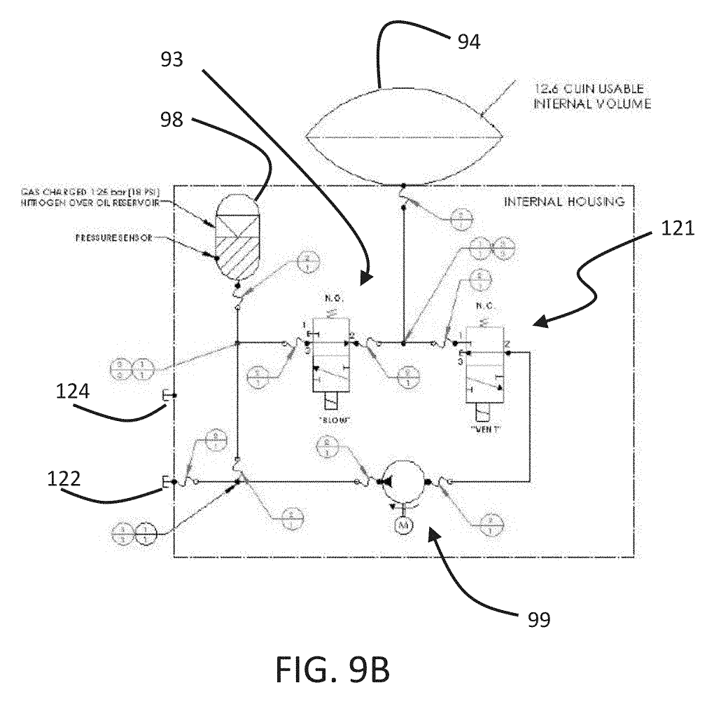

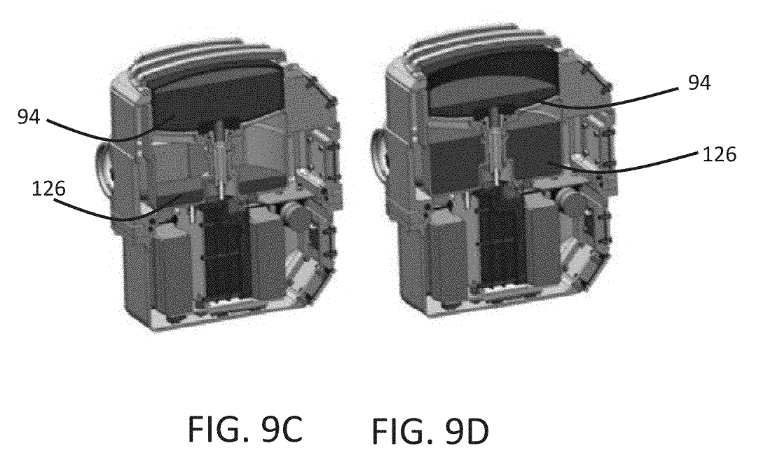

Turning now to FIG. 9A, another embodiment of the ROV 52 is shown having the same components and operating in similar fashion to the embodiments depicted above in FIGS. 6-8B. Illustrated in FIG. 9A is the internal structure of the pressure vessel 98 that includes a number of internal baffling. The baffling can include any number of apertures, and any number of baffles can be used. The pressure vessel 98 is integral with the housing in FIG. 9A. Use of the term “integral” includes separate parts that are integrated together to form the pressure vessel, as well as a construction that is monolithically formed as a single unit. Thus, the pressure vessel 98 can be formed by bringing two halves together (such as might be the case if the top half of the ROV 52 were formed as one piece which is later joined to a bottom half), or any of a number of constituent parts of the submersible (e.g. where the pressure vessel 98 is constructed as a separate component which is fastened into place with the ROV 52. For example, in some embodiments the pressure vessel is separately manufactured and installed in or on the submersible through any suitable attachment technique, such as mechanical fastening (bolt, rivet, etc.), metallurgically (e.g. welding, etc.), and chemically (e.g. bonding, etc.). No limitation is hereby intended as to the type of attachment of the pressure vessel to the submersible.

The ballast bag 94 is also shown in FIG. 9A in which it is permitted to inflate and deflate as necessary to change displacement of the ROV 52, and thus its buoyancy. The ballast bag 94 can be enclosed within a lattice caged construction that consists of a series of elongate cross members that extend in generally the same direction, as seen in one embodiment in FIG. 9A. The lattice cage, however, can have any number of configurations. For example, other embodiments can include a number of additional cross members oriented transverse to the elongate cross members illustrated, such that the lattice cage takes on a more traditional lattice structure. The lattice cage construction is used to protect the ballast bag 94 from foreign objects that can puncture the ballast bag 52.

The ‘hull’ depicted at the bottom of FIG. 9A can be the same as the open interior 96 described above. Thus, any variety of components can be installed within the hull that provide power and control circuitry to operate the ROV 52.

One mode of operation of the system 50 that can be used in whole or in part to various embodiments described above progresses as follows: to ensure reliable communication between the device 52 and the computational device 18, a transceiver 82 can be inserted into the cooling oil tank through the service opening on the top of the transformer. In most embodiments, the transceiver 82 is used to exchange data information from a sensor on the ROV and the camera 77, 90, via a controller to the computational device 18; and motion control or maneuvering signals from the joystick 63 via the computational device 18 to the controller to operate the motors 62 and thrusters. The signal transmitted by the receiver 99 is used by the computational device 18 to provide a separate confirmation to the device's position within the tank.

The computational device 18 receives the position signals and information signals and in conjunction with a virtual image correlates the received signals to the virtual image to allow a technician to monitor and control movement of the inspection device. This allows the technician to inspect the internal components of the transformer and pay particular attention to certain areas within the transformer if needed. By utilizing a virtual image of the internal features of the transformer and the position of the inspection device with respect to those virtual features, the image obtained can be matched with the corresponding site inside the actual transformer tank. Based on the visual representation of the transformer image and a possible virtual inspection device in relation to the image, a technician can manipulate the joystick 24 response. The computational device 18 receives the movement signals from the joystick 24 and transmits those wirelessly to the antenna 92, whereupon the controller implements internally maintained subroutines to control the pump thrusters to generate the desired movement. This movement is monitored in real-time by the technician who can re-adjust the position of the device or ROV 52 as appropriate.

FIG. 9B depicts another embodiment of a ballast system useful with the ROV 52 discussed herein. The ballast system illustrated includes the pump 99 the pressure vessel 98, the inflatable bag 94, and the blow valve 93. The ballast system of FIG. 9B also includes a vent valve 121 and an alternative arrangement of conduits/passageways that connect the various components. The system illustrated in FIG. 9B also includes an external orifice 122 and external orifice 124 useful to convey fluids to/from the internal spaces of the ROV 52. Further details of the orifices 122 and 124 are described further below.

The pressure vessel 98 of FIG. 9B includes a compressible fluid used to drive fluidic motion of an incompressible fluid toward the inflatable bag 94 when the valve 93 is opened. The valve 93 can have a normally open state and that, when energized, can be placed in a closed condition to discourage flow of fluid therethrough. In some forms the pressure vessel 98 can contain the compressible fluid over top of some portion of the incompressible fluid. In some embodiments the compressible fluid can be nitrogen, but any other suitable compressible fluid can also be used. The incompressible fluid can be mineral oil, but other fluids are contemplated. In some forms the incompressible fluid can be matched to the same fluid type in which the ROV 52 is operating. The valve 121 can be configured as a normally closed valve such that the valve 121 when energized can be placed in an open condition to permit fluid to flow therethrough.

When in operation the compressible fluid in the pressure vessel 98 can expand and urge the incompressible fluid toward the inflatable bag 94. Movement of the incompressible fluid can be regulated by operation of the valve 93. The bag can be filled with incompressible fluid at varying levels. In the illustrated embodiment, the inflatable bag 94 can include 12.6 inches of usable internal volume, but any suitable space can also be provided in other embodiments. When incompressible fluid is desired to be removed from the inflatable bag 94, valve 93 can close and valve 121 opened. Pump 99 can be operated to withdraw incompressible fluid from the inflatable bag 94 via the valve 121 and force the incompressible fluid to return to the pressure vessel 98, at which point volumetric compression of the compressible gas in the pressure vessel 98 occurs.

The ballast system illustrated in FIG. 9B can be a closed system with sufficient compressible fluid and incompressible fluid to provide negative, neutral, and/or positive buoyancy to the ROV 52. In some forms the ballast system includes a quantity of compressible fluid and incompressible fluid to provide all three of negative, neutral, and positive buoyancy, but some embodiments many include less than all range of buoyancies. In one form of operation, the ballast system can provide neutral buoyance for maneuvering the ROV 52 by forcing a quantity of incompressible fluid away from the pressure vessel 98 to permit expansion of the compressible. Such expansion lowers the density of the pressure vessel owing to lower mass of the compressible gas, thus raising the buoyancy of the ROV 52. Likewise, when incompressible fluid is forced to return toward the pressure vessel 98, such compression of the compressible gas raises the density of the pressure vessel owing to high mass concentration of the compressible gas, thus lowering buoyancy of the ROV 52. Depending on the quantity of incompressible fluid used in the system, either complete or partial evacuation of incompressible fluid from the pressure vessel 98 can occur.

The ballast system can thus provide a variety of operational capabilities in one or more embodiments. For example, the valve 93 can be opened to force a quantity of incompressible fluid toward the inflatable bladder 94 which can be denoted as a neutral buoyancy quantity, after which the valve 93 can be closed. Such neutral buoyancy quantity can be used during nominal operation of the ROV 52. Some embodiments may be designed such that sufficient pressure remains in the pressure vessel 98 to overcome hydrostatic pressures of the fluid in which the ROV 52 is operating and force additional incompressible fluid to the inflatable bladder 94. If trouble occurs during nominal operation in this embodiment the valve 93 can be opened to permit the additional quantity/pressure of the compressible fluid remaining in the pressure vessel or tank 98 to force additional incompressible fluid toward the inflatable bladder 94 and thus lower the density of the pressure vessel 98, thus providing positive buoyancy. Such troubles may occur, for example, when power is lost to the valves 93 and 121. Such a situation will see the valves revert to their normal state such that valve 93 reverts to normally open and valve 121 reverts to normally closed. Such a situation can also be explicitly provided by an operator wherein the valves are commanded to be placed in their normal mode to provide for an open valve 93 and a closed valve 121.

The orifice 122 can be used to provide additional incompressible and/or compressible fluid to the ballast system. Orifice 124 can be used to communicate with an interior of the ROV 52. The pressure vessel 98 can include a pressure sensor in some embodiments useful to regulate movement of fluid/buoyancy state of the ROV 52.

As will be appreciated, the ROV 52 may be operated in different temperature environments and varying depths. The quantity of compressible fluid and incompressible fluid used in the ROV 52 can be sized to accommodate these large temperature and depth variations without need to onboard or offboard a quantity of either the compressible or incompressible fluid. Such variation may result in the inflatable bag 94 receiving more incompressible fluid in one operational environment than another at a given buoyancy condition. For example, assuming fixed quantities of compressible and incompressible fluid, in one operational environment the inflatable bag 94 may reach 60% of its volumetric capacity to receive incompressible fluid, while in another operational environment (e.g. different operating temperature) the inflatable bag 94 may reach nearly 100% of its volumetric capacity.

FIGS. 9C and 9D illustrate an embodiment of the ROV 52 which can use the ballast system illustrated in FIG. 9B. Shown in FIGS. 9C and 9D are analogous components as illustrated in FIG. 9A, with the additional illustration of the incompressible fluid 126 being withdrawn from the inflatable bladder 94 back to the pressure vessel 98 from FIG. 9C to FIG. 9D.

As discussed below, according to certain embodiments, the system 50 can also include a launching tube for use with a liquid filled tank that can be sized to accommodate dispensing the ROV 52 into the liquid tank or housing 13. As previously discussed, the tank or housing 13 can be an electrical transformer 12 or any other liquid containing tank such as but not limited to a chemical tank. As discussed below, the launching tube can include a valve for insertion into a launching chamber, and a tank side valve for launching of the submersible into the tank. In one form, the launching tube includes an antenna for communication with the submersible or ROV 52 and/or a base station, such as, for example, the computational device 18. The launching tube can also include a sensor such as a camera, as well as an agitator. The agitator can be used to facilitate bubble removal from the inside of the launching tube.

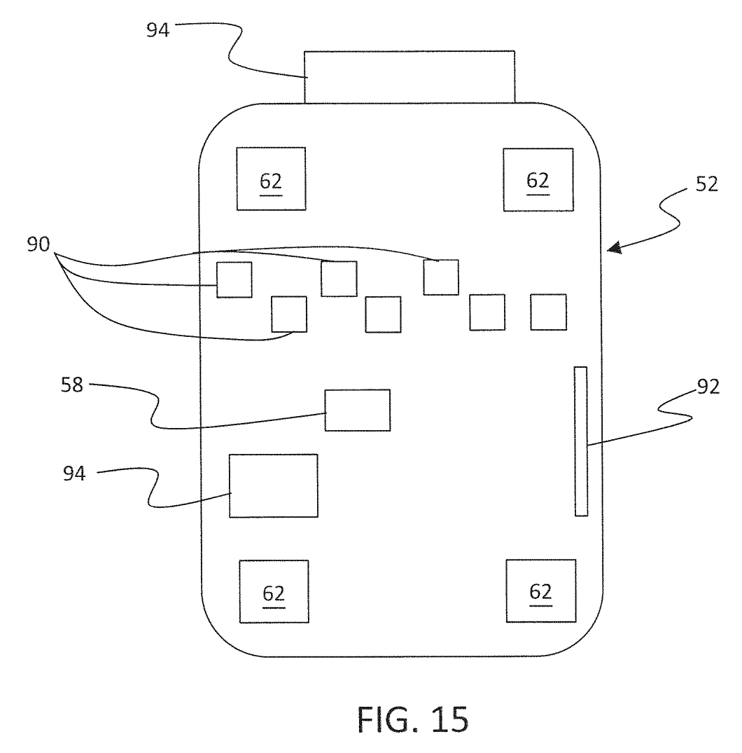

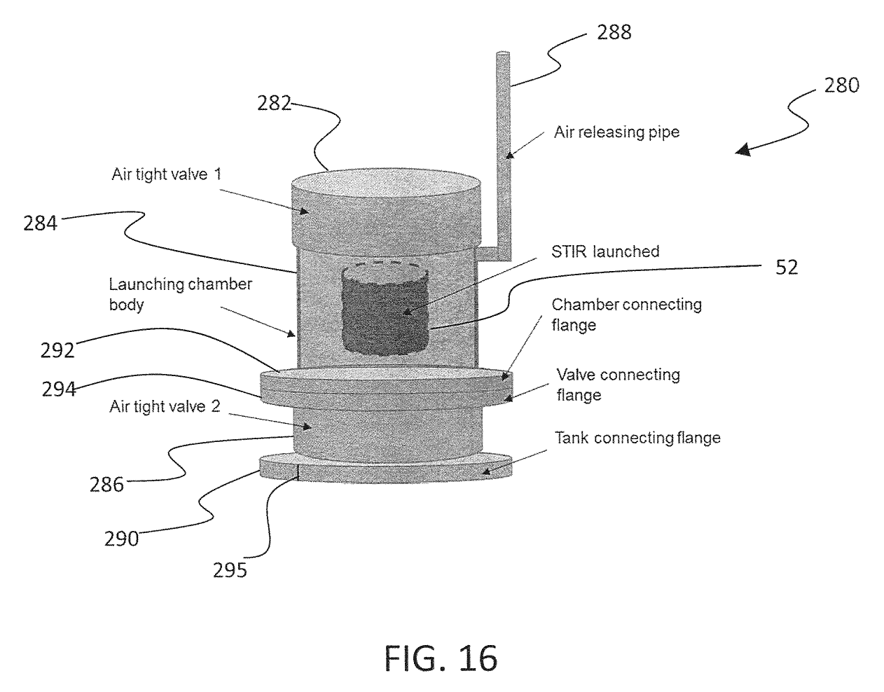

Turning now to FIG. 16, one embodiment of a launcher tube 280 is shown which can be used to introduce the ROV 52, including, but not limited to, the ROV 52 illustrated in FIG. 15, into the tank or housing 13 of a transformer 12. The launcher tube 280 can include an outside valve 282 (described in one non-limiting embodiment as an “air tight valve”), a launching chamber 284, a tank side valve 286 (described in one non-limiting embodiment as an “air tight valve”), and an air release conduit 288 (in one non-limiting embodiment the conduit is a pipe). During operation, the outside valve 282 can be opened to permit insertion of the ROV 52 into the launching chamber 284. After the ROV 52 is received into the chamber 284, the outside valve 282 can be closed and liquid can be filled into the chamber 284. The liquid can be filled from an outside source or can be filled from liquid already present in the tank or housing 13. Such a fill process can occur as a result of partially, or totally, opening the tank side valve 286. Air that is present in the tank or housing 13 can escape during the fill process via the passage 288.

The outside valve 282 can take on any suitable form necessary to permit opening and closing of the launching chamber 284 from the outside. The valve 282 can be secured in place via any number techniques, including mechanical, magnetic, etc. For example, the valve 282 can be secured in place using a number of fasteners, it can be hinged at one side and compressed shut through a lever mechanism, and it can be sealed shut using magnetic and/or electromagnetic principles. In some embodiments, the valve 282 will seal the chamber 284 shut such that liquid is prohibited from escaping.

The launching chamber 284 resides between the outside valve 282 and tank side valve 286 and can take on a variety of shapes and sizes. In one form the launching chamber 284 is made of clear plastic material such that the interior of the chamber 284 can be monitored during a fill or drain activity.

The tank side valve 286 can take on any suitable form necessary to permit opening and closing of the launching chamber 284 to the inside of the tank or housing 13. The valve 286 can be releasably secured to the tank or housing 13 via any number techniques, including mechanical, magnetic, etc. In the illustrated embodiment, the tank side valve 286 includes a flange 290 that permits attachment to the tank or housing 13. Whether through use of the flange 290 or other structure, the launcher tube 280 can be releasably attached to the tank or housing 13 to permit insertion and retrieval of the ROV 52 from the tank or housing 13, and then be removed for a subsequent launch and retrieval evolution in another separate tank or housing 13. In one form, the launcher tube 280 can be attached via a series of fasteners that are inserted into openings of the flange 290. In other forms, the flange 290 can include one or more registration surfaces 295 that are received in complementary registration surfaces of the tank or housing 13. Such registration surfaces can be used to translatingly receive the tube 280 onto the tank or housing 13 at which point the tube 280 could be rotated and compressed into place for the duration of a launch and recovery cycle. In any given embodiment of the connection type used between the launcher tube 280 and tank or housing 13, a sealer such as, but not limited to, a gasket can be used to provide further sealing action against leakage of liquid from the tank or housing 13 to the outside. Such a gasket can be received in a recess formed in either or both of the tube 280 side connection or the tank or housing 13 side connection surface.

The movable component of the valve 286 can include a door that is hinged at one side and compressed shut through a lever mechanism, it can be sealed shut using magnetic and/or electromagnetic principles, etc. In some embodiments, the valve 286 will seal the chamber 284 shut such that liquid is prohibited from escaping.

In one form, the valves 282 and 286 are assembled at the ends of a monolithic continuous construction that includes the chamber 284, but other embodiments such as the illustrated form include constituent components that include connection devices that are attached to form the entire assembly. In the illustrated embodiment, the chamber 284 is connected to a flange 292 that is connected to a corresponding flange 294 of the valve 286. The complementary flanges can be connected using any variety of techniques such as mechanical (e.g. bolts), chemical (e.g. bonding), and metallurgical (e.g. welding), to set forth just a few non-limiting embodiments.

It will be appreciated that although the interior of the launching chamber 284 can be cylindrical in shape, other tube shapes are also contemplated herein. For example, the inside of the launching chamber 284 can have a rectilinear shape such as a square interior tube shape. Any suitable shape can be used on the inside of the tube such that the ROV 52 can be inserted prior to introduction to the tank or housing 13.

Though the air release conduit or passage 288 is shown as a right-angled pipe in the illustrated embodiment, other forms are also contemplated. For example, the air release conduit or passage 288 can take the form of a simple orifice on the outside of the launcher tube 280 that provides a conduit through which air can escape. For that matter, any type of physical device useful to direct air from the inside of the tube can be used, whether the device leads to an elongated passage well away from the tube or is a short opening through which air can escape.

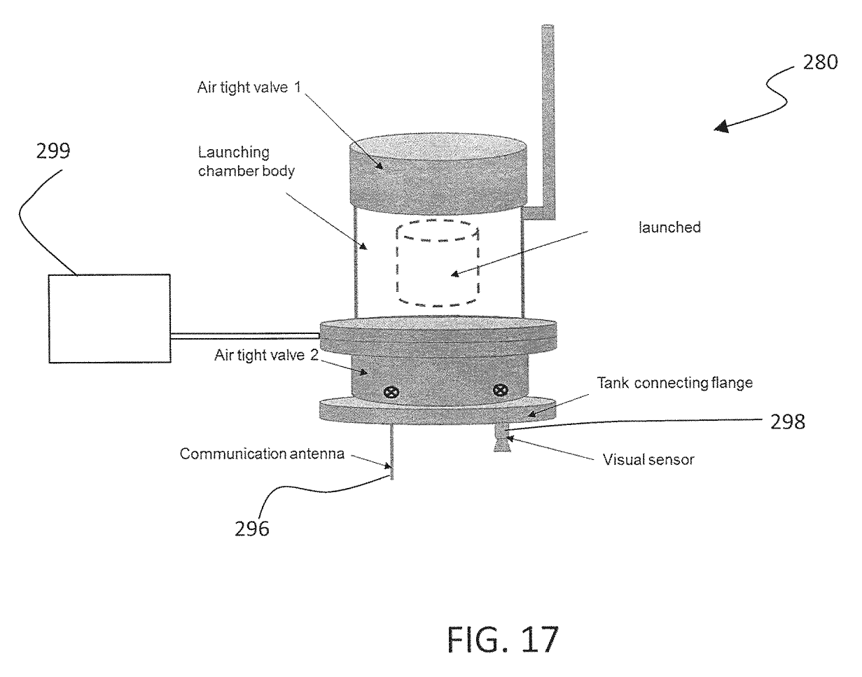

Turning now to an additional and/or alternative embodiment depicted in FIG. 17, the launcher tube 280 can include any one or more additional components than those depicted above in FIG. 16. The illustrated embodiment in FIG. 17 depicts a communication antenna 296, a visual sensor 298, and an agitator 299. The communication antenna 296 can be used to transmit and/or receive information much in the manner of the transmitter and/or receivers 82 and 92 mentioned above, whether the information is to/from the ROV 52 or the base station. The visual sensor 298 can take the form of a camera in one embodiment (whether still or motion video), but can be structured to capture other wavelengths as well. In one form, the visual sensor 298 can be used to dock the ROV 52 back into the launcher tube 280. Connectors can be placed on the body of the launcher tube 280 for connecting to external instruments during the launching, inspection, or recovery operations.

The agitator 299 can be any device suitable to induce motion in the contents of the dispensing or launcher tube 280 to cast off gas bubbles formed within the tube. Such gas bubbles can be formed on the ROV 52, but can also be formed on an inside surface of the launching chamber 284, or the valves 282/286, etc. The agitator 299 can take any number of forms, including a fluid movement device and a vibratory movement device. In one form, the agitator 299 can be a piezoelectric actuated agitator to produce vibrations in any of the launch tube, submersible vehicle, and fluid, but other mechanisms are also contemplated herein. The agitator 299 can also take the form of a fluid moving device such as a bladed screw that induces fluid flow within the launching tube. In still other forms, the vibratory agitator 299 can be combined with the fluid moving agitator.

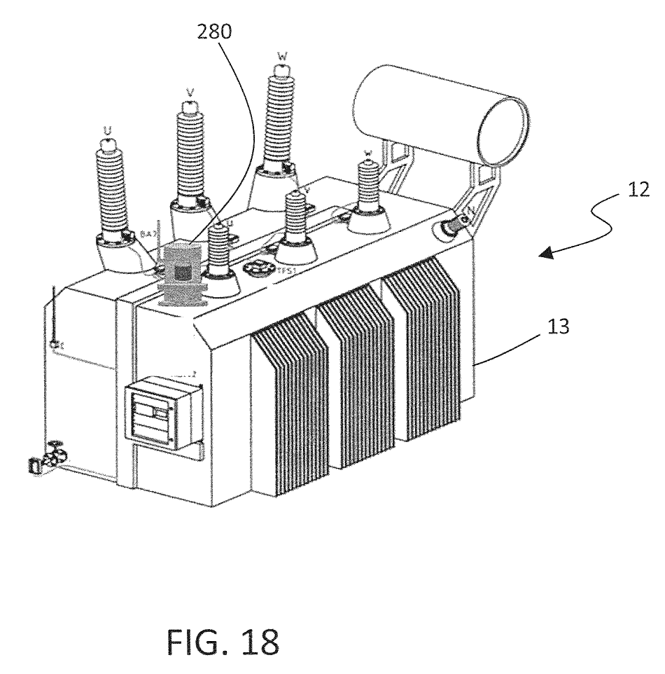

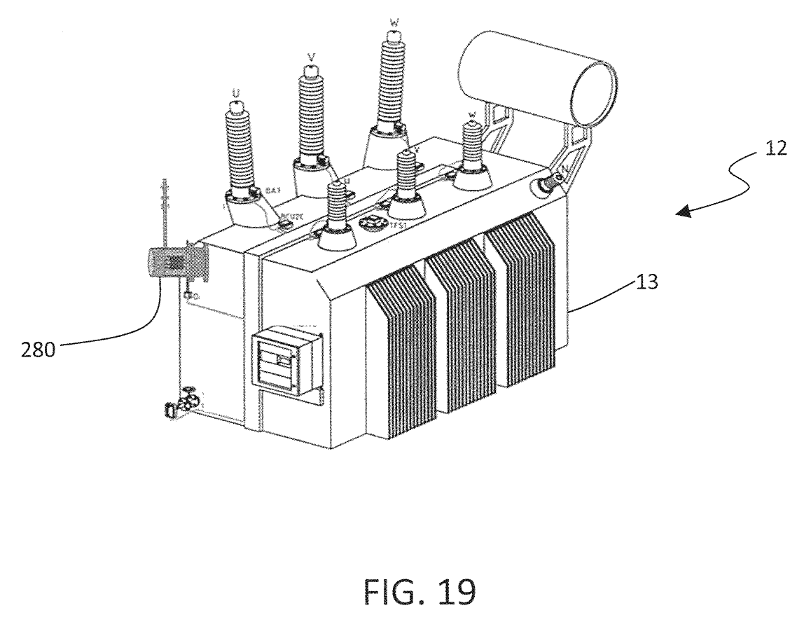

Turning now to FIGS. 18 and 19, alternative embodiments are depicted in which the launcher tube 280 is placed at different locations of the tank or housing 13. FIG. 18 depicts a tank or housing 13. FIG. 19 depicts an embodiment in which the launcher tube 280 is releasably fastened on the side of the tank or housing 13. It will be appreciated herein that although many embodiments described above depict the launcher tube 280 as releasably fastened, some embodiments can include a launcher tube 280 that is permanently fastened and/or integrated into the tank or housing 13. In any event, in those embodiments where the launcher tube 280 is releasably fastened, the launcher tube 280 is constructed that permits portable travel to another tank or housing 13. Such portable travel includes the ability to be handled as a unit and in some forms can include a convenient handle to permit handy removal and transport to another tank or housing 13. The handle could be integrated into the launcher tube 280 at any convenient location, whether on the outside valve 282, launch chamber 284, etc. In some forms one or more components of the launcher tube 280 can be removed (e.g. the embodiment of the pipe or air release conduit 288 as shown illustrated in FIG. 16) to permit safe handling and transport.

The tank or housing 13 can include a removable cover that permits access to the interior of the tank. Such a cover can be removed prior to attachment of the launcher tube 280, but other embodiments envision a tank cover that can remain in place during installation of the launcher tube 280, with a subsequent removal of the cover after installation of the tube 280. The tank cover can be removed and/or set aside by an operation that occurs exterior of the tank, but that the cover nonetheless remains inside the tank during the operation. Such would be the case of a door that is hinged to move into the interior of the tank and out of the way of the ROV 52 when it is inserted into the tank or housing 13. The tank cover can be replaced and secured into place prior to removal of the launcher tube 280.

As discussed below, according to certain embodiments, the system 50 can include a ROV 52 that is configured for wireless communication. Further, according to certain embodiments, the ROV 52 of the system 50 can include a number of separate cameras for imaging the internal structure of the transformer 12. The submersible or ROV 52 can be configured to communicate to a base station, such as, for example, the computational device 18, using a wireless transmitter and receiver. The cameras on the submersible or ROV 52 can be fixed in place and can be either static or motion picture cameras. Further, the submersible or ROV 52 can include an input/output selector capable of switching between the camera images, either through commanded action of a user or through computer based switching. In one form, the input/output selector is a multiplexer. The base station, such as, for example, the computational device 18, can be configured to display images, such as, for example, on the display 19, from the cameras one at a time, or can include a number of separate viewing portals in which real time images are displayed. The base station can include a demultiplexer synchronized to the multiplexer of the submersible.

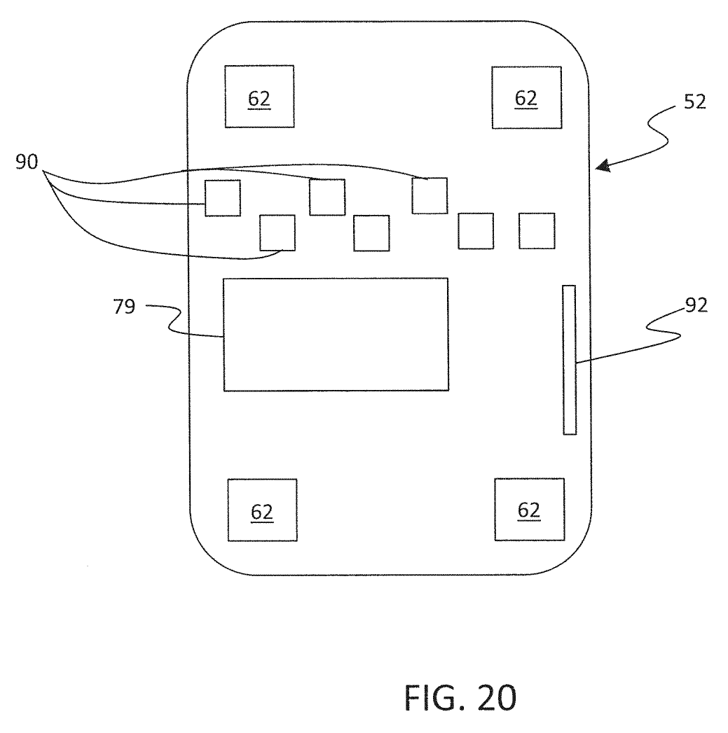

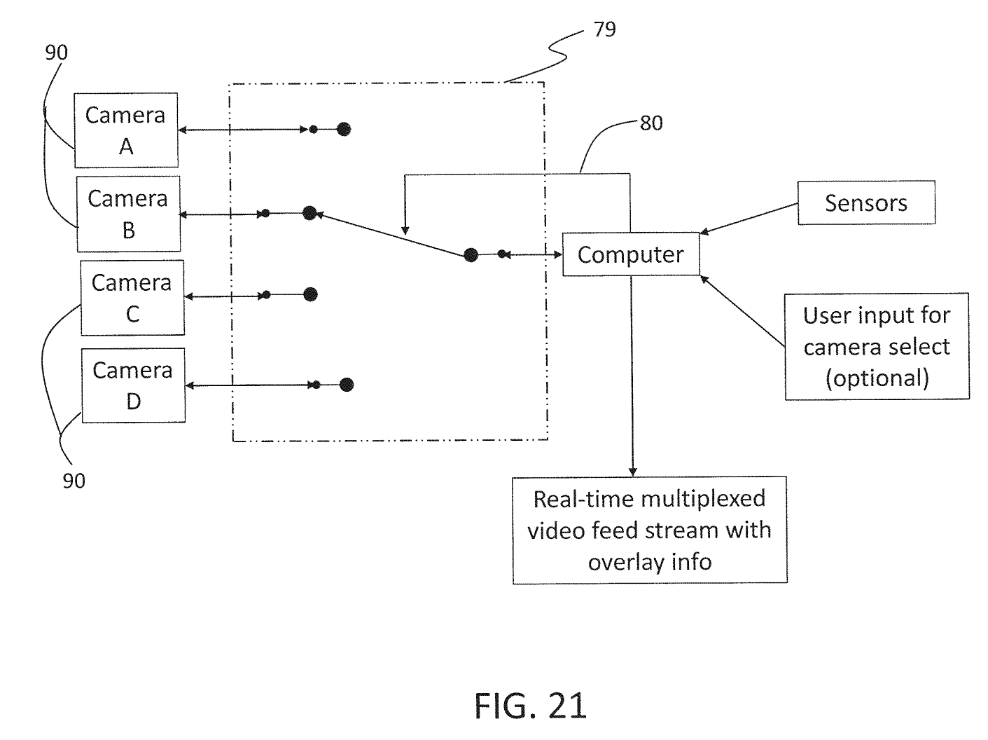

Referencing FIGS. 20 and 21, the ROV 52 can also include an input/output selector 79 useful to switch between any of the cameras 90 for transmission via the device 92, to the device 82 and thence to the display 19. One embodiment of the input/output selector 79 is illustrated in FIG. 21, which shows a switch controlled via 81. Generally, the input/output selector 79 can be any device useful to select from a variety of inputs and provide a single output in one form. The selection can be dictated by a command from an operator (shown as ‘optional’ in the embodiment of FIG. 21), or from a computer based application. In this sense, the selection can be an irregular spaced event separated by any size of time increment. Such an example is the selection of one camera by the technician/expert/operator from a number of potential camera sources on the transmitting end that can be displayed on a single television/computer monitor/etc.

In another embodiment the input/output selector 79 can be switched rapidly by a timer such as through a computer based multiplexer type of device. The input/output selector 79 can be operated in conjunction with (e.g. synchronized with) an input/output selector on a receiving end such as at the base station, such that rapid changes in selection of input source on the transmitting end can be matched with rapid changes in selection of output destination on the receiving end. Such is the case with a MUX/DEMUX configuration in which information from the multiple cameras of the remotely operated submersible can be rapidly switched for transmission to, for example, the base station, where a demultiplexer can rapidly be switched and a signal routed for independent display of the multiple cameras.

The input/output selector (either on the ROV 52 end or the base station end) can either be expressed as a separate piece of hardware independent of a central control processor, or can be a software program that runs within the central control processor (e.g. a controller on board the ROV 52). In one embodiment in which the input/output selector is a separate item of hardware, a serial connection can be made between the input/output device and a computer to which the switched images are relayed, but other connection types are also envisioned. In similar fashion, the cameras can be connected to the input/output device in similar serial communication connection, but other connection types are also contemplated.

A computer can be used to capture camera frames, resize them, overlay the requested information onto the video, encode the video and finally stream it over to the user. In one embodiment, the streaming software of motion images from the cameras can achieve 640×480 video at 20 frames per second with a latency less than 150 ms. The system (e.g. a controller, the input/output selector/etc.) can be developed such that a user such as the technician or expert can change the video parameters at runtime to modify the stream parameters. For example, the resolution of the video can be changed manually or automatically based on the task of the robot. For slow movement inspection task, higher resolution, higher latency video can be selected. For fast steering movement, a lower resolution, lower latency and wider angle of view video can be selected. In some embodiments at runtime, higher resolution (for example 1296×972) video and images can be recorded locally to the ROV as and when directed by the operator, which can be done while the video stream is being transmitted. Much higher resolution (for example 1920×1080) pictures can be also taken but the video transmission may need to be paused.

In addition to switching the signal from any individual camera 90, other signals can be piggybacked on to the transmitted image, whether the image is a still shot or moving image. In one non-limiting embodiment the additional signals piggybacked on to the transmitted image can include any type of sensor data available elsewhere from the ROV 52. Such additional signals can include orientation information of the ROV 52 (e.g. pitch, roll, yaw), battery life remaining, bus voltage, environment temperature and/or pressure, properties of the liquid within which the ROV 52 is operating, etc. The additional signals can be added to the camera image prior to or after the input/output selector has switched to an active image to be broadcast. The embodiment in FIG. 21 is capable of receiving information in this regard from sensors that are overlayed onto the switched camera selection before being transmitted to the base station.

Accordingly, another mode of operation of the system 50 that can be used in whole or in part in various embodiments described above also progresses as follows: The base station can broadcast a control signal to be received by the ROV 52. The control signal can be any signal used to manipulate the remotely operated vehicle. For example, the control signal can be a signal to modulate the liquid propulsor (e.g. turn on, turn off, regulate speed, etc.). The control signal can also be to control the input/output selector. For example, when the system 50 includes a limited receiving capability of a single television/computer monitor/etc. on the receiving end, the control signal can be used by the user/base station to select a single camera for transmission to the base station.

Still other modes of operation that can be used in whole or in part in various embodiments described above include:
1. Recording all camera videos in high resolution in a memory on board the submersible. Uploading the videos to the remote operation station when better quality communication is available.
2. Replaying the videos at remote operation station and stitching multiple cameras to create a seamless panorama video for inspection. Allow engineer to select the ROI to zoom in. This application is for non-real time inspection typically.
3. Onboard computer can automatically switch between two or more cameras. A wide-angle view video stitched from two or more cameras can be displayed to operator during the inspection. It can help the user to steer the robot.
4. Onboard computer can multiplex two or more video feeds in a known pattern interleaving the frames either for local (on craft) recording at high resolution and frame rate, or for transmission at lower resolution and frame rate. This can enable multiscopic or stereoscopic reconstruction and rectification of image data
5. The panorama video stitched from multiple cameras either online or offline (replay) can be displayed on VR device. It can provide immersive first person view to user.
6. The onboard computer or other image processing or manipulation device can multiplex between 2 or more video feeds, then combine the multiple feeds into a split frame image and transmit this as a single video feed. This increases potential frame rate while decreasing maximum resolution.
7. The onboard computer or other image processing or manipulation device can interleave frames of non-video information such as sensor data (e.g. acoustic, microphone, ultrasounds, thermography, rate gyro, magnetometer, etc.), acoustic maps, point clouds etc. This data will need to be subject to handling such that it can be transmitted via the video transmission pipeline while avoiding contamination.
8. The multiplexing unit can be used to switch between static cameras with the same perspective but different image filters and processing capabilities to create a multilayer image stream, such as a video camera feed interleaved with thermal images, or video feed interleaved with depth information to create an RGBD camera stream.

As discussed below, according to certain embodiments, the system 50 can provide wireless communication with a submersible inspection device or ROV 52, including, for example, redundant wireless communication with a submersible inspection drone or ROV 52 used to evaluate the electrical transformer 12. Moreover, as previously discussed, the submersible inspection device or ROV 52 used for inspection of the liquid cooled electrical transformer 12 can include a number of separate cameras 90 for imaging the internal structure of the transformer 12. The submersible or ROV 52 can be configured to communicate to a base station, such as, for example, with the computational device 18, using a number of wireless transmitters and receivers. Signals transmitted to the submersible or ROV 52 can include command signals useful to effect an action on the submersible or ROV 52 but also a heartbeat signal to indicate health of the transmitted signal. A redundant channel selection logic is provided to switch from a channel that no longer receives a heartbeat to another channel that includes a current heartbeat. Multiple signals can be received and evaluated in software, and another signal received via a firmware radio.

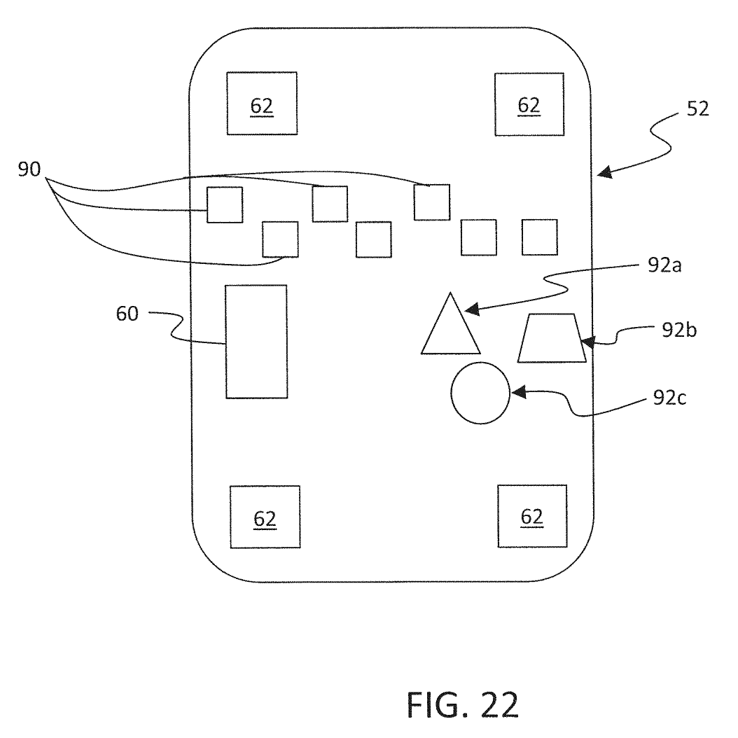

Turning now to FIG. 22, one embodiment of the ROV 52 is depicted as including a number N of cameras 90, motors 62 and transmitter and/or receivers 92a, 92b, and 92c. Although three separate transmitter and/or receivers 92a, 92b, 92c are shown, any number greater than or less than those depicted can be used. Other components can also be included in the ROV 52 but are not illustrated for sake of brevity (e.g. a battery to provide power to the cameras, additional sensors such as rate gyros or magnetometers, etc.). Any one of the transmitter and/or receivers 92a, 92b, and 92c can be connected to a controller on board the ROV 52 for the purpose of transmitting data collected from the cameras 90 and for sending and receiving control signals for controlling the motion and/or direction of the ROV 52 within the transformer. The transmitter and/or receivers 92a, 92b, and 92c are structured to generate a wireless signal that can be detected by the computer or any intermediate device, such as through reception via the transmitters and/or receivers 82 (although only two are depicted in FIG. 1, it will be appreciated that another transmitter and/or receiver 82 is also used to accommodate the three separate transmitters and/or receivers 92a, 92b, and 92c in the embodiment depicted in FIG. 22).

Referring now to FIGS. 1 and 22, transmissions from any of the pairings of transmitters and/or receivers 82 and transmitter and/or receivers 92a, 92b, and 92c can occur over a variety of manners, including various frequencies, powers, and protocols. In some applications, the communication between the ROV 52 and the base station can be supplemented with a repeater or relay station, but not all embodiments need include such devices. The manners of transmission between any of transmitters and/or receivers 82 and transmitter and/or receivers 92a, 92b, and 92c need not be identical in all embodiments. To set forth just a few examples, as previously discussed, the transmitter and/or receiver 82 used for broadcast of signals from the base station can transmit in power that ranges from 1 W to 5 W. The base station can also transmit in frequencies that that range from about 300 MHz to about 5 GHz, and in some forms are at any of 300 MHz, 400 MHz, 433 MHz, 2.4 GHz, and 5 GHz. Transmission can occur using any variety of protocols/formats/modulation/etc. In one example, transmission from the base station can use digital radio communications such as that used for RC model cars/boats/airplanes/helicopters. The transmission can also occur as TCP/IP or UDP, it can occur over WiFi radios, serial communication over Bluetooth radios, etc. In one particular form, video transmissions can occur as streaming for a Wi-Fi camera over 2.4 GHz.

The submersible or ROV 52 illustrated in FIG. 22 includes a controller 60 which can be used to receive a command and provide a control signal to a useful component of the submersible or ROV 52. For example, the controller 60 can be used to activate one or more motors 62, cameras 90, and/or one or more additional sensors. The controller 60 can also be used to activate a ballast system, either of the emergency type or an active ballast system used to control depth under the liquid surface. The controller 60 can be comprised of digital circuitry, analog circuitry, or a hybrid combination of both of these types. Further, the controller 60 can be programmable, an integrated state machine, or a hybrid combination thereof. The controller 60 can include one or more Arithmetic Logic Units (ALUs), Central Processing Units (CPUs), memories, limiters, conditioners, filters, format converters, or the like which are not shown to preserve clarity. In one form, the controller 60 is of a programmable variety that executes algorithms and processes data in accordance with operating logic that is defined by programming instructions (such as software or firmware). Alternatively or additionally, operating logic for the controller 60 can be at least partially defined by hardwired logic or other hardware.

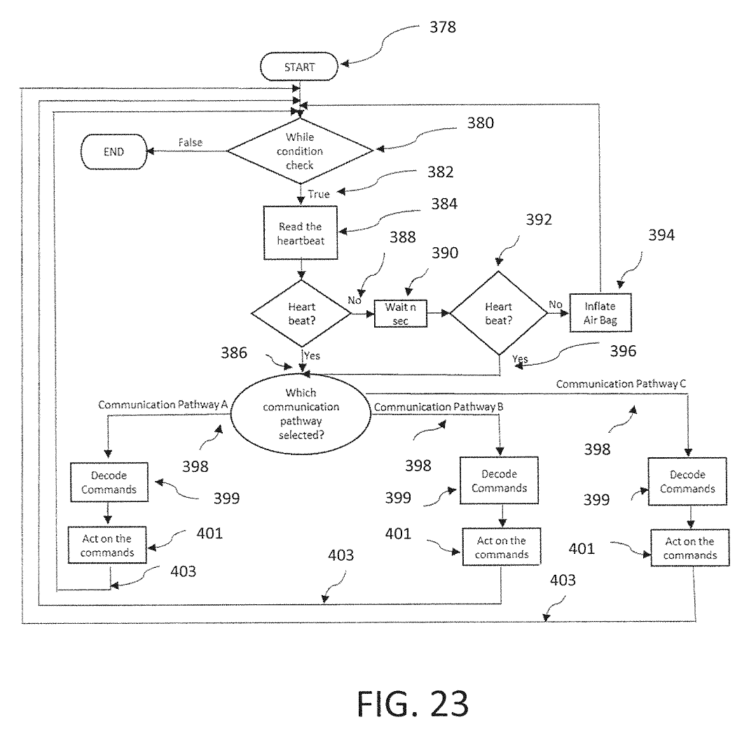

Turning now to FIG. 23, one embodiment of a controller for providing redundant control pathways to the useful components of the submersible or ROV 52 (e.g. the motors, cameras, sensors, ballast system) is illustrated. The redundant control scheme illustrated and described in FIG. 23 also includes a dual purpose of activating an emergency ballast system if the separate control channels are disrupted for some reason (hardware failure, transmission interference, etc.) as will be described further below.

The operating logic starts at 378 at the top of FIG. 23, which receives three separate signals from the receivers 92a, 92b, and 92c (in other embodiments additional signals can also be received and acted upon by the redundancy logic described herein). In one non-limiting embodiment, the three separate signals include redundant control signals for one or more components of the submersible or ROV 52. In addition to the redundant control signals, the separate signals also include a heartbeat or similar signal that indicates the active and ongoing broadcasting of information. As will be appreciated, heartbeat signals or the like are useful to distinguish between fresh and active commands from a base station and those signals that either are stale, dead, or interfered, among other possibilities. A heartbeat can be used to determine the health of the signal, and whether to rely upon the signal or chose another, redundant signal in its stead.

The operating logic of FIG. 23 evaluates a first communication pathway, and if no heartbeat is received in a limited amount of time, switches to evaluating a second communications pathway. If a heartbeat is not received in the second communications pathway, then the logic switches to evaluating the third communications pathway. If no heartbeat is received in the third pathway, then the operating logic activates a ballast (in this case, it is an inflatable bag) for subsequent recovery of the submersible or ROV 52. Each of the communications pathway represents signals received from each of the separate transmitters and/or receivers 92a, 92b, and 92c.

After the start at reference numeral 378, the logic checks that the while condition 380 is true, which is generally the case during operation of the submersible or ROV 52. If true at 382, then at block 384 the operating logic will read the heartbeat of the currently selected channel. The currently selected channel starts at Channel A by default, but if Channel A fails for some reason then the operating logic selects Channel B as the currently selected channel, and so forth. Once the heartbeat is read at 384 the operating logic determines whether the heartbeat is detected at 386 or not detected at 388. A heartbeat can be ‘detected’ using any number of different techniques, one of which is to compare a counter in the heartbeat to a previous counter value in the signal to determine if the signal has changed. Other techniques are also contemplated to detect an ongoing and valid signal. The heartbeat detection technique can be similar across all three channels, but, in some embodiments, the heartbeat detection technique can be different. The operating logic, therefore, can employ a channel specific heartbeat detection approach based upon the current channel being evaluated in the logic.

If the heartbeat is not detected at 388, the operating logic is structured to wait for a set amount of time at 390. The set amount of time can be the same across the different channels, or can be a variable. After the set amount of time at 390 has elapsed, the heartbeat is checked again at 392. As stated previously, if no heartbeat is detected in Channel A then Channel B is selected, and if no heartbeat is detected in Channel B then Channel C is selected (and so on), and thereafter is no heartbeat is detected in Channel C at 392 then a command is given at 394 to activate the emergency ballast (in the illustrated embodiment, the emergency ballast is an inflatable bag). It will be appreciated that the logic progresses through each of the channels (however many channels are used in any given embodiment) and only in the last channel if no heartbeat is received then the emergency system is activated.

However, if the heartbeat is again detected at 396, then, depending on the communication pathway selected at 398, the operating logic begins to decode the command at 399 and act on the command at 401 before restarting the logic again at 403.

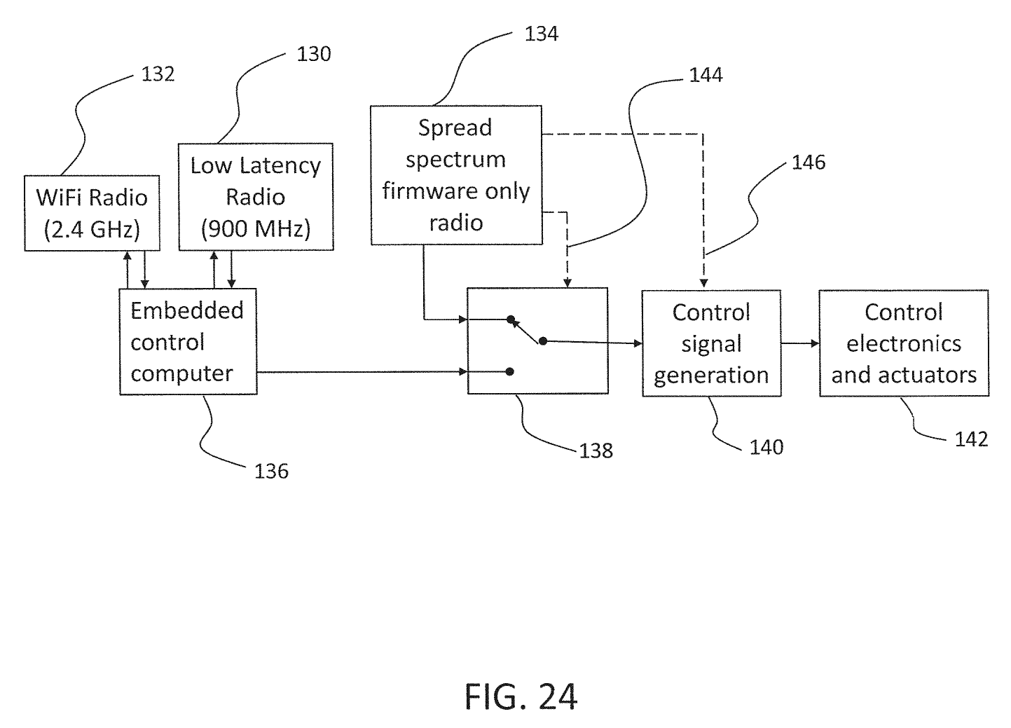

The operating logic of FIG. 23 can be implemented in a number of different manners whether software or hardware or both, and can be contained within a single components or distributed among a number of different components akin to the discussion of the nature of a controller discussed above. To set forth one embodiment of the operating logic of FIG. 23, a schematic of a controller 60 is shown in FIG. 24, which includes several different components all operating together to detect a heartbeat in a relevant signal and select the channel that commands will be derived from.

FIG. 24 depicts an embodiment that includes a low latency radio 130, WiFi radio 132, and spread spectrum radio 134. Each of the radios 130, 132, and 134 represent one of the channels A, B, and C depicted in FIG. 23. In the illustrated embodiment the low latency radio 16 is the preferred Channel A radio, the WiFi radio 132 is the next preferred Channel B radio, and the spreads spectrum radio 134 is the third preferred Channel C radio.

Signals received from the radios 130 and 132 are received and acted upon in the embedded control computer 136. In turn, the embedded control computer 136 can also transmit information back to the base station through the radios 130 and 132.

A switch 138 is used to select between information provided by the embedded control computer 136 and the spread spectrum radio 134. The switch 138 can be a solid state device that is used to provide the selected information to the control signal generation block at 140, which, in one embodiment, is implemented in firmware much like the spread spectrum radio 134. The control signal generation will forward along a control signal to the control electronics and actuators at block 142, which, in some embodiments, can be similar to block 399 on FIG. 23.

Dotted lines 144 and 146 are shown in FIG. 24, and represent a heartbeat signal from the spread spectrum radio 134. The switch 138 can use the heartbeat 144 to alternatively activate the switch to change from sampling the radio 134 or the signal from the embedded computer 136. The heartbeat 146 can be used within the control signal generation as it assesses which channel to use as the current channel.

The heartbeat comparison and signal forwarding of the embodiment set forth in FIG. 24 can be implemented in a number of different manners. For example, the embedded control computer 136 can evaluate the heartbeat from radio 130 and select radio 132 if no heartbeat in 130, and from there provide the signal to the switch 138. The switch 138 can feed the signal selected from either the control computer 136 or the radio 134 to the control signal generation 140 for further assessment whether the hierarchy of channels includes a heartbeat in order from preferred channel to least preferred channel, and if so which one of the hierarchy. In this sense, the control signal generation 140 can be given information about the radio 134 even though the preferred channel 130 includes an active heartbeat.

In another embodiment, the control computer 136 can multiplex the radio signals from 130 and 132 together and provide the multiplexed signal to the solid state switch 138, which provides a mux'ed version to the block 140, which evaluates the heartbeat and selects the current channel based on the heartbeat. Any number of variations are contemplated with the software embedded computer 136, firmware radio 134 and control signal generation 140, and solid state device 138 (and possible solid state devices 142).

As will be appreciated, the reception and evaluation of the heartbeat of the different radios 130, 132, and 134 can occur concurrent or contemporaneous with one another. In one embodiment, each of the radios are configured to always be monitoring for a reception of an incoming wireless signal, and information from the reception can be operated upon and routed according to the various embodiments described herein. As used herein, the terms ‘concurrent’ and/or ‘contemporaneous’ includes simultaneous reception and action upon the various signals, but also includes near simultaneous reception of and action in regards to the signals depending on, for example, the timeline and dynamics of the individual application. For example, a high performance submersible with tight constraints on rise time performance, settling times, etc. may require tighter time intervals of reception and associated action even if the signals are not, strictly speaking, received and operated upon at the exact same time. Likewise, submersibles with relaxed performance requirements can include larger time intervals between the various signals as it relates to reception of signal and action based upon the signal. Each of these uses will be considered to be “concurrent” if various the requirements. Thus, the term “concurrent” includes exact simultaneous and near simultaneous

During operation, the radio 130 is the desired pathway, where the user can operate the craft from the computer or computational device 18 with a standard GUI software and very low latency as the video is streamed back over WiFi radio 132. Should there be a breakdown or interruption of the 900 MHz low latency radio 130, but the WiFi radio signal 132 is still intact, control can be routed through the WiFi radio thought at a significantly increased latency. Should the WiFi radio 132 fail, such that the video stream is no longer available, control can either be routed through the low latency radio 130 with visualization from a wired camera placed on top of the transformer tank, or control can be routed through the spread spectrum radio 134 which, in one form, can be held by a person on top of the transformer.

As previously discussed, according to certain embodiments, the system 50 can provide an inspection system for inspecting a machine, such as, for example, a transformer 12, and includes an inspection vehicle or ROV 52 that is constructed for wireless operation while submersed in a dielectric liquid medium. Additionally, as previously discussed, the inspection vehicle or ROV 52 can be self-propelled, and a controller can be operative to direct the activities of the inspection vehicle or ROV 52. Additionally, as discussed below, the system 50 can also include, according to certain embodiments, a plurality of status interrogation systems that can be disposed on the inspection vehicle or ROV 52. The status interrogation systems can be operative to capture inspection data regarding a plurality of inspection procedures performed on the machine, such as, for example, the transformer 12.

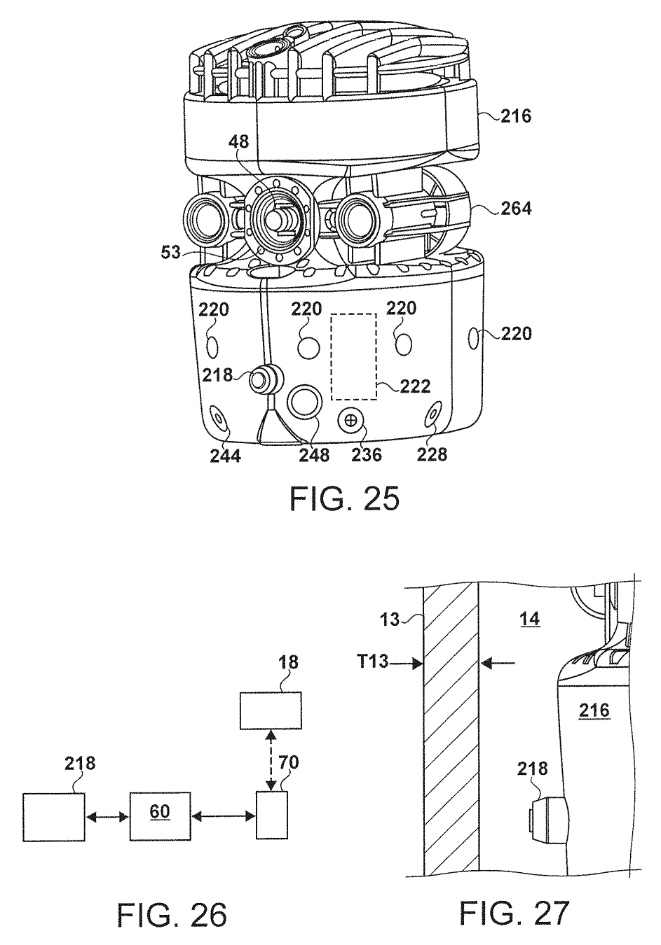

Referring to FIG. 25, some aspects of a non-limiting example of an inspection vehicle or ROV 216 in accordance with an embodiment of the present invention are illustrated. Inspection vehicle or ROV 216 can be used in conjunction with in-situ inspection system 50 in addition to or in place of inspection vehicle or ROV 52. Inspection vehicle or ROV 216 includes a status interrogation system in the form of an ultrasound sensor 218. A status interrogation system is a system operative to capture data for contemporaneously or subsequently determining the status of a component, feature, system, subsystem or other aspect of the machine being inspected, e.g., of transformer 12, tank or housing 13, cooling liquid or fluid 14 and/or related components or features. Inspection vehicle or ROV 216 also includes many or most features described above with respect to inspection vehicle or ROV 52 in order to perform inspections, and performs most or all of the same functions as described above with respect to inspection vehicle or ROV 52. For example, the features include but not limited to sensor 48, e.g., a camera; light sources 53; battery pack 54; controller 60; storage device 68; antenna 70 and other components and features for transmitting and receiving wireless signals, e.g., signals 72 and other wireless signals, to and from computer or computational device 18 through dielectric coolant liquid or fluid 14, and other components and features for wirelessly self-propelling around transformer 12, and performing inspection, data transmittal and/or maintenance of transformer 12 immersed in dielectric cooling liquid inside tank or housing 13. Computer or computational device 18 serves as a base station for wirelessly transmitting data, e.g., commands, to the inspection vehicle, e.g., for directing the actions of the inspection vehicle while immersed within dielectric cooling liquid or fluid 14, including propulsion and inspection activities; and for wirelessly receiving data transmitted from the inspection vehicle, e.g., position data, and sensor and status interrogation system data. Although the present embodiment is wireless, it will be understood that other embodiments can employ wired connections in addition to or in place of some or all wireless connections. In place of pumps 64, inspection vehicle or ROV 216 employs shrouded propellers 264, which provide, at least in part, propulsion for inspection vehicle or ROV 216 while immersed within cooling liquid or fluid 14.

Referring to FIG. 26, ultrasound sensor 218 is communicatively coupled to controller 60, and wirelessly to computer or computational device 18 via controller 60, e.g., and antenna 70. Ultrasound sensor 218 is operative to generate and detect ultrasound pulses, e.g., through a couplant, such as dielectric cooling liquid or fluid 14 in transformer tank or housing 13, and to record the echo time of each transmitted ultrasound pulse to determine wall thickness of structures associated with transformer 12 and/or tank or housing 13, e.g., when directed by controller 60, for example, in response to commands received from computer or computational device 18 via antenna 70. In addition to determining metallic wall thickness, ultrasound sensor 218 is also operative to determine thicknesses of other materials and structures, including paint or other protective coating thickness, insulation thickness for one or more insulated structures or devices, and the thickness of any sediment build-up, e.g., at the bottom of tank or housing 13. In some embodiments, ultrasound sensor 218 is a smart sensor operative to determine thickness based on echo time, and to transmit the thickness data to controller 60. In other embodiments, controller 60 and/or computer or computational device 18 can be operative to determine the wall thickness of structures, features and sediment based on echo return time, e.g., based on the time between the sending of each ultrasound pulse and the receipt of the ultrasound pulse as reported by ultrasound sensor 218. In the illustration of FIG. 27, in order to measure the local thickness T13 of the tank or housing 13 wall, inspection vehicle or ROV 216 propels itself toward the wall until ultrasound sensor 218 is touching the wall, after which time it emits the ultrasound pulses, detects the echoes and determines pulse return time to determine thickness. Likewise when measuring the thickness of other structures or features: inspection vehicle or ROV 216 propels itself toward the feature until ultrasound sensor 218 is touching the feature, at which time the interrogative pulses are sent and their echoes subsequently received in order to determine thickness based on the echo time. In some embodiments, ultrasound sensor 218 and/or controller 60 and/or computer or computational device 18 can include and employ or access lookup tables, equations or other reference materials in order to determine thickness based on echo return time. The raw sensor data and/or thickness data can be wirelessly transmitted from inspection vehicle or ROV 216 to computer or computational device 18 via antenna 70. Sensor 48, such as a camera, and light sources 53 can be employed to further investigate regions found using ultrasound sensor 218 to have an undesirable thickness, e.g., a reduced insulation thickness, a reduced wall thickness or an undesirable concentration of sediment.

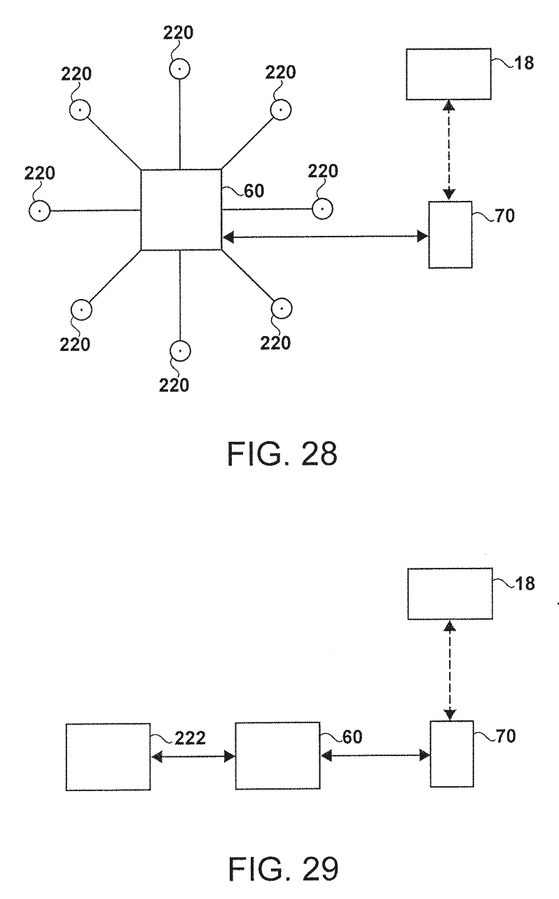

Referring to FIGS. 25 and 28, in some embodiments, inspection vehicle or ROV 216 includes a status interrogation system in the form of microphones 220 constructed to detect partial discharge and potential breakdown of insulation within transformer 12. Microphones 220 are communicatively coupled to controller 60 and hence to base station or computer or computational device 18 via antenna 70. Partial discharge, e.g., a partial discharge event, is a localized dielectric breakdown of a solid or fluid electrical insulation that may not, at least in the initial stages of failure, be visible. The partial discharge may be intermittent or may be continuous. The continued or repeated occurrence of partial discharge(s) over some duration typically leads to visibly apparent breakdown of insulation and damage to other structures, conductive or otherwise. If caught in the early stages, partial discharge can be addressed by remedial action prior to significant or substantial damage being done to the transformer.

Partial discharge has been found to generate sound, including ultrasonic waves through a solid or liquid filled electrical components, e.g., inside tank or housing 13 filled with dielectric liquid or fluid 14. Microphones 220 are constructed to be sensitive in the ultrasonic region associated with partial discharge. In one form, inspection vehicle or ROV 216 includes eight (8) microphones 220 disposed about the surface of inspection vehicle or ROV 216, equally spaced apart circumferentially from each other. In other embodiments, other orientations and/or numbers of microphones can be employed. Preferably, at least three (3) microphones are employed, although some embodiments can have fewer than three microphones, and as few as one. More preferably, approximately seven (7) to eight (8) microphones are employed, although the number of microphones can vary with the needs of the particular application. In some embodiments, one or more acoustic cameras can be employed in addition to or in place of microphones 220.

System 50 is constructed to triangulate the location of the partial discharge. For example, in order to inspect transformer 12 for the occurrence of partial discharge event, a high voltage can be supplied to transformer 12, such as a normal or a peak operating voltage, but at low current, while inspection vehicle or ROV 216 is deployed within tank or housing 13, with microphones 220 immersed within dielectric liquid or fluid 14. The high voltage is selected to be representative of actual operating voltage so as to simulate normal operating conditions and to stimulate partial discharge at sites which would otherwise experience the partial discharge during normal operating conditions, whereas the reduced current reduces the damage caused by the partial discharges, and reduces the likelihood of damage to inspection vehicle or ROV 216. While the voltage is supplied to transformer 12, inspection vehicle or ROV 216 is directed past various portions of transformer 12, while “listening” for partial discharges using microphones 220. In some embodiments, the “listening” can be performed while inspection vehicle or ROV 216 is in transit, whereas in other embodiments, inspection vehicle or ROV 216 can be paused at desired locations to listen for partial discharges. Once heard, the location of the partial discharge is triangulated, e.g., based on the timing of the partial discharge induced sound waves reaching the locations of the different microphones 220 spaced apart around the circumference of inspection vehicle or ROV 216 (phase offset of the received signal as between the different microphones 220), as well as based on the amplitude difference as between the different microphones. In one form, the triangulation calculations are performed by controller 60. In other embodiments, some or all of the microphone data can be wirelessly transmitted to computer or computational device 18, and the triangulation calculations can be performed by computer or computational device 18 in addition to or in place of controller 60. In some embodiments, only the triangulation results can be transmitted wirelessly to computer or computational device 18. Once the location of the partial discharge(s) have been determined, inspection vehicle or ROV 216 can be maneuvered adjacent to the location of the partial discharge, and a single microphone 220 can be employed to confirm the exact location of the partial discharge if desired. Once adjacent the partial discharge camera 48 and or one or more other status interrogation systems described herein can be employed to more closely observe or inspect the site for any damage or other physical signs of the partial discharge, e.g., in order to help decide upon remedial action. The power supplied to transformer 12 can be terminated, and then ultrasound sensor 218 can be employed to verify the thickness of insulation at the partial discharge site, or confirm other structural thickness parameters, or the presence and thickness of sediment that can be a contributing cause for the partial discharge.

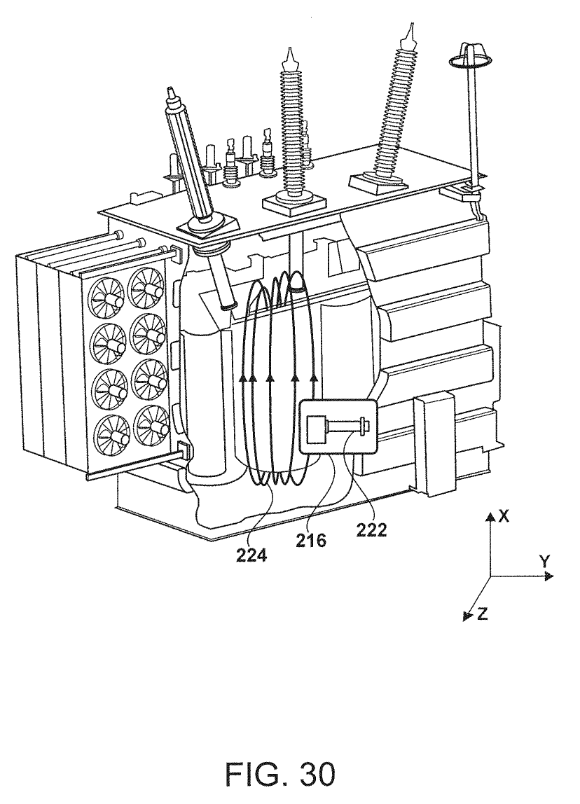

Referring to FIGS. 25, 29 and 30, in some embodiments, inspection vehicle or ROV 216 includes a status interrogation system in the form a magnetometer 222 (illustrated schematically). Magnetometer 222 is disposed inside of the nonmetallic inspection vehicle or ROV 216. In one form, magnetometer 222 is a multiaxis magnetometer. In other embodiments, magnetometer 222 may take other forms. In one form, magnetometer 222 is operative to sense magnetic field lines 224 along X, Y and Z-axes, e.g., the X, Y and Z-axes illustrated in FIG. 30, and to detect variations in the magnetic field generated by transformer 12. In one form, magnetometer 222 is an orientation independent magnetometer, operative to obtain orientation independent measurement of magnetic fields within tank or housing 13, e.g., emanating from transformer 12. The sampling rate of magnetometer 222 can vary with the needs of the application. Measurement of the magnetic field, coupled with location information provided by inspection vehicle or ROV 216 can allow users to form a spatial map of the magnetic field profile within tank or housing 13 and transformer 12, e.g., by wirelessly transmitting the sensed magnetic field data to computer or computational device 18 and combining the data with a computer-aided design model of transformer 12 to form the spatial map. Any anomalous magnetic field measurements can be used to trigger an alert, potentially preventing damage or further damage within transformer 12. Magnetometer 222 is coupled to controller 60 and to base station computer or computational device 18 via antenna 70. Controller 60 is operative to direct magnetometer 222 to obtain magnetic field data at a desired sample rate. In some embodiments, controller 60 is operative to wirelessly transmit via antenna 70 the magnetic field information to computer or computational device 18, which in some embodiments creates a spatial map of the magnetic field profile for visual comparison against a standard or baseline map. In other embodiments, analysis of the magnetic flux lines measured by magnetometer can be performed in other manners.

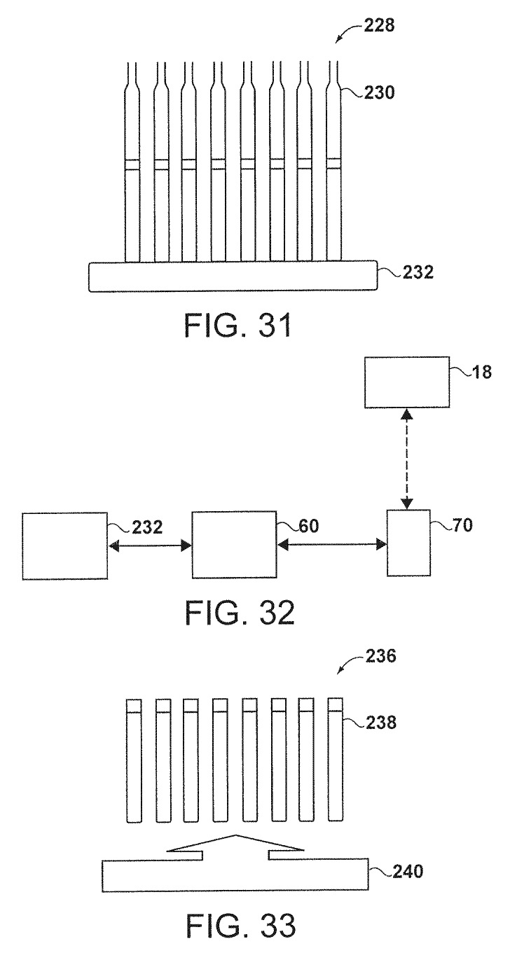

Referring to FIGS. 25, 31 and 32, in some embodiments inspection vehicle or ROV 216 includes a status interrogation system in the form an aliquot collection system 228. Aliquot collection system 228 includes a compartmentalized bank of aliquot collection syringes 230 and a syringe plunger drive mechanism 232. Plunger drive mechanism 232 is communicatively coupled to controller 60, and hence to base station computer or computational device 18 via antenna 70. Plunger drive mechanism is operative to operate the aliquot collection syringes to obtain aliquot samples at desired locations, e.g., at the direction of controller 60 and/or computer or computational device 18. Aliquot collection system 228 allows inspection vehicle or ROV 216 to collect aliquots from different locations around transformer 12 in tank or housing 13, e.g., samples of dielectric cooling liquid or fluid 14. The aliquot samples obtained can be analyzed subsequently after removal of the aliquot collection syringes from inspection vehicle or ROV 216, allowing the use of sophisticated lab and analysis equipment that, for example, may not be locally available.

In some embodiments, sampling at different heights within tank or housing 13 and transformer 12 can aid in the analysis of particulate/sludge sedimentation. Guidance of inspection vehicle to obtain the aliquot samples can be performed manually or in conjunction with a computer aided design model of tank or housing 13 and transformer 12, allowing collection at desired locations. In one form, aliquot collection syringes 230 are clean, gas-tight and moisture-free syringes, which may prevent contamination of samples once taken. In some embodiments, aliquot collection syringes 230 can be disposable. The type and nature of aliquot collection syringes 230 can vary with the needs of the application. Different forms or types of analytics can be employed, e.g., at an external laboratory, which can aid in assessing transformer health and in assessing the severity of various problems. For example, paper (cellulose) insulation deterioration can be locally assessed in different locations around tank or housing 13 based on the use of the aliquot samples. In addition, liquid insulation overheating problems can be examined, and the level of severity can be estimated based on the use of the aliquot samples. As another example, suspected corona detection can be linked to its location of discharge, for example, if one or more aliquot samples indicates unusually elevated hydrogen levels. Dielectric breakdown tests, interfacial tension and neutralization numbers tests, among others, can be performed on the aliquot samples to indicated the presence of water, cellulose fibers or other particulate contaminants, e.g., which are known to vary at different depths. Further, localized aliquot collection can aid in locating arcing problems when used in conjunction with metals-in-oil analysis.

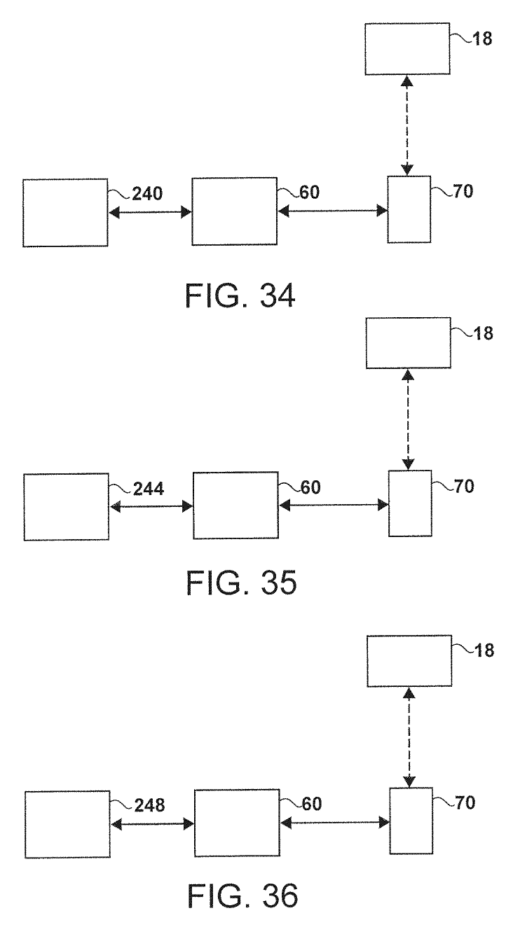

Referring to FIGS. 25, 33 and 34, in some embodiments, inspection vehicle or ROV 216 includes a status interrogation system in the form a mechanical sampling system 236. Mechanical sampling system 236 is operative to extract mechanical samples from desired locations within tank or housing 13 and around transformer 12, and store the samples within sample collection bottles 238. Mechanical sampling system 236 includes a sample collection mechanism 240 schematically illustrated in FIG. 33, which is operative to obtain samples, e.g., scrapings or scooping, from desired locations or features of transformer 12 or otherwise within tank or housing 13, for example, grit and sediment samples from the bottom of tank or housing 13, portions of insulation material, carbonization, coking, corrosion or other materials that can warrant further investigation. Sample collection mechanism 240 is communicatively coupled to controller 60, and hence to base station computer or computational device 18 via antenna 70. In one form, sample collection mechanism 240 is operative to perform mechanical sampling under the direction of computer or computational device 18, e.g., based on user input. In other embodiments, sample collection mechanism 240 is operative to perform mechanical sampling under the direction of controller 60 in addition to the direction of computer or computational device 18.

Referring to FIGS. 25 and 35, in some embodiments, inspection vehicle or ROV 216 includes a status interrogation system in the form a high sample rate chemical sensor 244. Chemical sensor 244 is operative to chemically analyze dielectric cooling liquid or fluid 14. In one form, chemical sensor 244 is operative to sense dissolved gaseous species, for example and without limitation, hydrogen, carbon dioxide and/or carbon monoxide. In other embodiments, chemical sensor 244 can be operative to sense other dissolved gas species. In some embodiments, chemical sensor 244 is also or alternatively operative to test for moisture level or other contaminant levels. In some embodiments, a plurality of chemical sensors 244 can be employed, e.g., to test for different contaminant species. Chemical sensor 244 can be, for example, an optical sensor, an optical fiber sensor, or any other chemical sensor type.

Chemical sensor 244 is communicatively coupled to controller 60, and hence to base station computer or computational device 18 via antenna 70. Inspection vehicle or ROV 216 is operative to wirelessly transmit chemical sensor 244 output to computer or computational device 18 via antenna 70. In one form, chemical sensor 244 is operative to test or sense for contaminants in cooling liquid or fluid 14 under the direction of computer or computational device 18, e.g., based on user input. In some embodiments, chemical sensor 244 can also or alternatively be operative to test or sense for contaminants automatically based on the location of inspection vehicle or ROV 216, e.g., under the direction of controller 60 and/or computer or computational device 18 with the aid of a computer-aided design model of transformer 12 and tank or housing 13. If a significant deviation from an expected sensor reading is obtained at a particular location, inspection vehicle or ROV 216 can be operated to perform more minute inspections around this location using chemical sensor 244 to “home in” on the source of the contamination, after which additional inspection procedures can be performed using camera 48 and/or other status interrogation systems, e.g., such as those disclosed herein. In addition, subsequent inspections using chemical sensor 244 can be performed, e.g., over the course of time. The sensor readings for each inspection can be stored in a memory, e.g., storage device 68 or within computer or computational device 18 to record the changes in sensor readings over time. In some embodiments, controller 60 and/or computer or computational device 18 may send system alerts indicating abnormal readings, which in some embodiments can include the locations at which the abnormal readings were found. In some embodiments, a location-based mapping of regions within tank or housing 13 that have shown abnormal sensor reading can be generated, which can provide valuable information for use in determining the timing for the next transformer maintenance.

Referring to FIGS. 25 and 36, in some embodiments, inspection vehicle or ROV 216 includes a status interrogation system in the form an infrared sensor 248, e.g., an infrared thermometry sensor. Infrared sensor 248 is operative to sense the temperature within tank or housing 13, e.g., the temperature of transformer 12 and/or dielectric cooling liquid or fluid 14, at desired locations within tank or housing 13. Infrared sensor 248 is communicatively coupled to controller 60, and hence to base station computer or computational device 18 via antenna 70. Inspection vehicle or ROV 216 is operative to wirelessly transmit infrared sensor 248 data to computer or computational device 18 via antenna 70. In one form, infrared sensor 248 is operative to sense temperature, e.g., of cooling liquid or fluid 14, under the direction of computer or computational device 18, e.g., based on user input. In some embodiments, infrared sensor 248 can also or alternatively be operative to sense temperature automatically based on the location of inspection vehicle or ROV 216, e.g., under the direction of controller 60 and/or computer or computational device 18 with the aid of a computer-aided design model of transformer 12 and tank or housing 13.

In a particular form of operation, inspection vehicle or ROV 216 is operative to perform infrared thermometry mapping within tank or housing 13 using infrared sensor 248. For example, inspection vehicle or ROV 216 can be maneuvered to desired locations, and the temperature sensed using infrared sensor 248. The sensor readings for each inspection can be stored in a memory, e.g., storage device 68 or within computer or computational device 18, and in some embodiments can be used to generate a heat profile within transformer 12 and tank or housing 13, allowing monitoring of excessive heating and fluctuations in heat profile that can lead to oil decomposition or degradation of paper insulation. Storage device 68 and/or computer or computational device 18 can record the changes in sensor readings over time. A heat map can thus be generated in some embodiments. Variation in the heat map over time can be used to provide an informative analysis of transformer health, particularly when used in conjunction with data from other status interrogation systems, e.g., described herein, such as aliquot collection system 228, mechanical sampling system 238 and chemical sensor 244.

Although embodiments have been described wherein computer or computational device 18 functions as a base station controller and remotely and wirelessly directs the movement and actions of inspection vehicle or ROV 216 in some embodiments, and/or directs the actions of the status interrogation systems in some embodiments, it will be understood that in other embodiments, inspection vehicle or ROV 216 is autonomously guided using controller 60, for example, based on waypoints or other data stored in storage device 68, e.g., a computer-aided design model of transformer 12 and tank or housing 13, and/or that the actions of the status interrogation systems are autonomously operated and controlled by controller 60, e.g., based on the waypoint or other data stored in storage device 68.

The present disclosure also provides, among other features, a system and method for rapid categorization, organization, charting and comparison of inspection data to ideal data and/or data from previous inspections of the component. In this manner, component downtime and thus cost related to the downtime, inspection and repair can be minimized. The system and method includes dynamic chart generation and an inspection management process to allow an operator to focus on inspection tasks and streamline analysis of such inspection tasks. Multiple modes of data entry allow for an operator to collect, categorize and annotate information collected from one or more sensors including video data while maintaining full control of the inspection vehicle. Further, methods are disclosed to register and correlate inspection information from previous inspections with information from the current inspection event.

Moreover, as discussed below, according to certain embodiments, the system 50 can include a method and system for acquiring, manipulating and displaying inspection data obtained by sensors 48 associated with submersible inspection vehicle or ROV 52 within a tank or housing 13 having a liquid medium, such as, for example, a cooling fluid 14. A control system including an electronic controller 60 can be operably coupled with the inspection vehicle or ROV 52 and be configured to display, such as, for example, on the display 19 of the computational device 18, data transmitted from the sensor 48 and overlay input data from an operator on the display 19 to facilitate real time analysis during the inspection event.

Referring generally to FIGS. 37-40, inspection methods are disclosed for acquiring, handling, displaying and annotating inspection data obtained by one or more sensors associated with an inspection vehicle, such as, for example, the previously discussed ROV 52. By providing an operator with the ability to categorize and attach voice recording on the fly, a detailed inspection report can be generated in real time at each inspection event. The methods include registering and displaying previous inspection results so that trends in equipment change can be readily identified.

Once the inspection vehicle has been moved to the inspection area and is ready to start the inspection with onboard sensors, a voice assisted and controller assisted inspection chart generation system can automatically generate an inspection chart, record the inspection sensor data, auto-populate the fields listed in the chart, efficiently record the inspection results and provide organized data output including inspection time, inspection task, inspection location and inspection results.

Input from an operator's voice, location of the inspection vehicle, or other manual input selection can be tied to a charting system that includes an inspection task list and automatic generation of an inspection chart, for example, windings, cables, support members, or the like in a transformer. After the operator confirms the inspection chart, the control system will start to record the inspection data and can populate the field of the next inspection item in the chart. The location of the inspection vehicle, the time of inspection, the type of sensor (2D video, 3D sensor, thermal camera, microphone, etc.) are examples of some of the potential fields in an inspection chart. The operator can then enter an inspection result, such as, for example, a certainty level of the inspection by voice entry or typing entry. After the operator completes all the inspection items in the chart, the control system will end the inspection data recording and guide the operator to move the inspection vehicle to the next inspection area. After all the inspection tasks are completed, the system can organize the recorded inspection data with the inspection time, task, location and results and prepare for offline review on the inspection results.

The system permits an operator to “voice over” data recordings and other annotation in real time during inspection. This annotation capability allows the operator to tie annotation to visual information. The system can prepare and display an inspection checklist in a user interface and allow the operator to review maintenance history of a particular component. The system can suggest certain inspection items based on the analysis of previous inspection and repair history.

The system can also display inspection images and data from previous inspections during a current inspection event. Based on the location of the inspection vehicle and the camera viewpoint, inspection task or operator voice input, the system can search the previous inspections data for related images and data. The operator can then compare the images and data from previous inspection with the images and data from the current inspection.

During the online inspection, the system can enhance the visual data (video and image), such as, for example, adjusting the brightness and contrast filtering out noise to improve video quality and provide improvement in visual presentation of the inspection data. Further, the system can apply an image analysis algorithm for a specified inspection task to help the operator determine potential problems with the inspection components. The system can overlay a rough scene reconstruction via a 3D Red, Green, Blue, Depth (RGBD) cloud model from the inspection event to a computer generated CAD model of a known component to compare, analyze and suggest movement of the inspection vehicle and record inspection data from a different vantage point. In off-line inspection, the system can reconstruct the 3D scene from the visual data and allow the operator to rotate, pan, or zoom, etc., the inspection scene to thoroughly inspect the components from different views.

The system can automatically upload inspection data as soon as a viable internet pathway is available. Based on the Quality of Service (QoS) of the network connection, the system can upload inspection data based on bandwidth requirement and priority of inspection data. The inspection chart with operator input (voice/typing) can be uploaded and then a high-resolution image and video can be uploaded later. This feature enables the cloud inspection for remote operation and analysis. The inspection data can be sent to an expert analyst for monitoring the inspection process. The inspection data can be transmitted to a server with more computational power to analyze the current inspection data with the previous inspection data, health and repair history of the component. A computer server can provide a real-time inspection conclusion or suggestions for new inspection tasks.

Referring now specifically to FIG. 37, a first method 100 for acquiring, handling and displaying inspection data obtained by the ROV 52 is illustrated. Beginning at step 102, one or more operator inputs, such as, for example, a voice input, a location input or other manual input can be transmitted to the control system. At step 104, the control system can generate an inspection task list that defines a feature and location for the inspection vehicle to obtain visual or other sensor data. At step 106, the control system can automatically generate an inspection chart of items to inspect. By way of example and not limitation, such items can include windings, cables, support structure and various types of connectors. At step 108, the control system will confirm that an item defined in the inspection chart has been identified and located. If the inspection vehicle fails to identify an item on the inspection chart, then at step 108 the method 100 will return back to step 102 and the operator can provide additional input into the system, such as, for example, voice input, location input or other manual input. After confirmation of the listed inspection item in the inspection chart, the method 100 proceeds to step 110 and the control system will start recording inspection data related to that inspection item. The method 100 then moves to step 112 where the control system can then populate field details for the next inspection item in the inspection chart. Such field details can include the location of the item, time or duration required for the sensing process, sensor type, as well as other similar inspection details. At step 114, the operator can enter further input data either by voice input or typing input to include information regarding a certainty level of the inspection result or the like. At step 116, the control system determines whether all of the items on the inspection list have been sufficiently inspected. If all items have been inspected then the inspection data recording is ended for the current inspection chart at step 118. If the list of inspection items has not been completed at step 116, then the method loops back to step 112 and populates the field for the next inspection item in the inspection chart. Continuing from step 118, if additional inspection is required, the inspection vehicle is moved to the next inspection area at step 120 and then the method starts over at step 102.

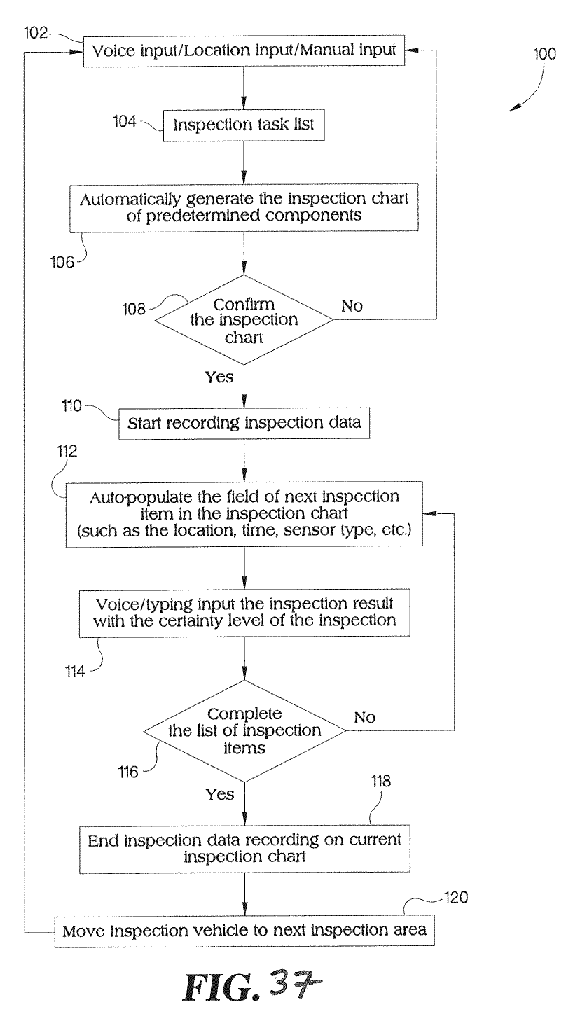

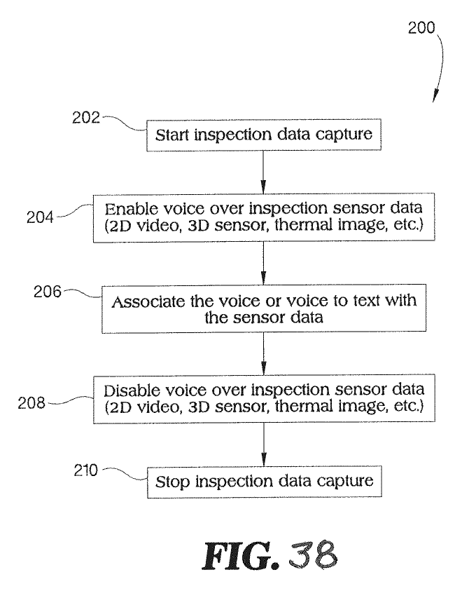

Referring now to FIG. 38, a flowchart illustrating a second exemplary method 200 is described. Beginning at step 202 the inspection vehicle initiates a data capture and recording process for one or more sensor outputs operable for inspecting selected items in an inspection task list. At step 204, the controller enables voice over input provided by an operator so that the voice over data can be recorded in real time as the inspection vehicle is performing an inspection process. The voice over data can be combined with various sensor data, such non-limiting examples can include 2D video, 3D sensors, thermal images, etc., so that the data can be reviewed with contemporaneous analysis from the operator. At step 206, the controller will associate the voice or text input from the operator with the sensor data so that the inspection recordings can be reviewed any time during or after the inspection. At step 208, the controller will disable recording for voice over and sensor data after completion of the inspection event. At step 210, the inspection vehicle will stop recording inspection data.

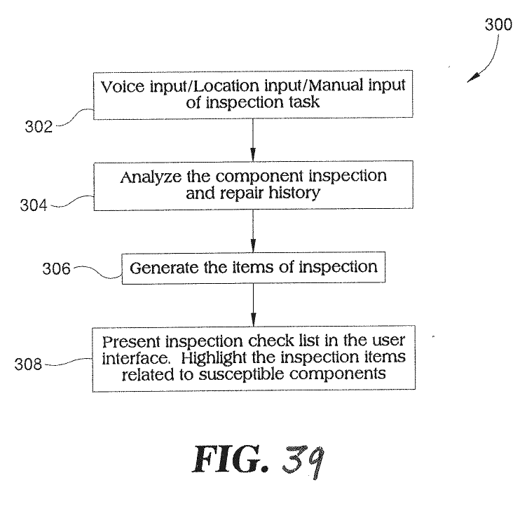

Referring now to FIG. 39 a flowchart illustrating a third exemplary method 300 is described. Beginning at step 302, the method 300 permits voice input, location input and or manual input of an inspection task for the inspection vehicle. At step 304, the controller analyzes component inspection and repair history, and then based in part on the repair history of a certain component(s), the controller can generate an item task list for inspection at step 306. At step 308, the controller generates and displays an inspection checklist that can be displayed on an operator interface. The controller can also highlight inspection items related to susceptible components on the item task list.

Referring now to FIG. 40, a flowchart illustrating a fourth exemplary method 400 is described. At step 402 the controller receives input, such as, for example, inspection vehicle location, operator voice input and inspection tasks. At step 404, the controller can search and retrieve the previous inspection data related to the current inspection task list. At step 406, the controller can display the inspection images and data from previous inspections during the current inspection event, so that real time analysis between present inspection data and past data can be performed.

As discussed below, according to certain embodiments, the system 50 can include a submersible vehicle or ROV 52 that includes a plurality of cameras 90 can be used to collect visual images of an object of interest submerged in a liquid environment, such as in the transformer tank or housing 13. Image information from the submersible or ROV 52 along with inertial measurements in some embodiments can be used with a vision based modelling system to form a model of an internal object of interest in the tank or housing 13. The vision based modelling system can include a number of processes to form the model such as but not limited to tracking, sparse and dense reconstruction, model generation, and rectification.

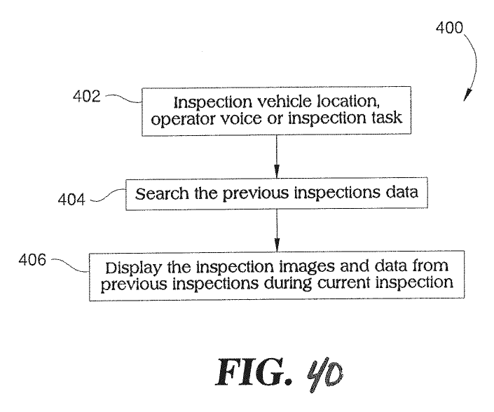

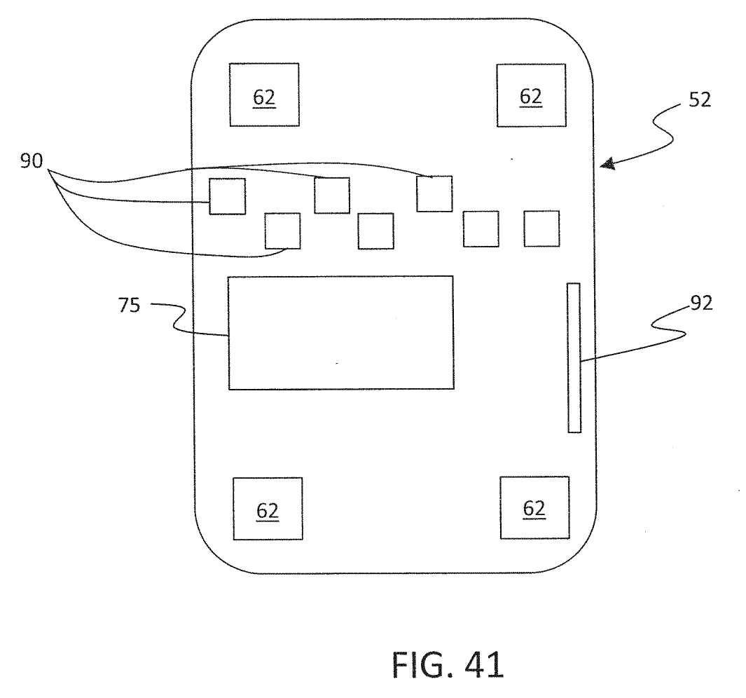

Referencing FIGS. 41-43, the ROV 52 can include an onboard computer 75 that can be used either in conjunction with, or in place of, the computer or computational device 18 at the base station for operating upon images from the cameras 90 to inspect the tank, build a model of components in the tank, etc. Either or both of computer or computational device 18 and 75 can include a processing device 83, an input/output device 87, memory 89, and operating logic 97. Furthermore, computer 75 communicates with one or more external devices 66.

The input/output device 87 can be any type of device that allows the computer 75 to communicate with the external device 66, whether through wired or wireless connection (e.g. via transmitter and/or receivers). To set forth just one non-limiting example, the input/output device can be a firmware radio receiver, network adapter, network card, or a port (e.g., a USB port, serial port, parallel port, VGA, DVI, HDMI, FireWire, CAT 5, or any other type of port). The input/output device 87 can be comprised of hardware, software, and/or firmware. It is contemplated that the input/output device 87 can include more than one of these adapters, cards, or ports.

The external device 66 can be any type of device that allows data to be sent to, inputted or outputted, communicated from, etc. the computer 75. For example, the external device 66 can be another computer, a server, a printer, a display, an alarm, an illuminated indicator, a keyboard, a mouse, mouse button, or a touch screen display. The external device can also include any number of separate components such as a computer working in conjunction with a transmitter. It is further contemplated that there can be more than one external device in communication with the computer 75.

Processing device 83 can be of a programmable type, a dedicated, hardwired state machine, or a combination of these; and can further include multiple processors, Arithmetic-Logic Units (ALUs), Central Processing Units (CPUs), or the like. For forms of processing device 83 with multiple processing units, distributed, pipelined, and/or parallel processing can be utilized as appropriate. Processing device 83 can be dedicated to performance of just the operations described herein or can be utilized in one or more additional applications. In the depicted form, processing device 83 is of a programmable variety that executes algorithms and processes data in accordance with operating logic 97 as defined by programming instructions (such as software or firmware) stored in memory 89. Alternatively or additionally, operating logic 97 for processing device 83 is at least partially defined by hardwired logic or other hardware. Processing device 83 can be comprised of one or more components of any type suitable to process the signals received from input/output device 87 or elsewhere, and provide desired output signals. Such components can include digital circuitry, analog circuitry, or a combination of both.

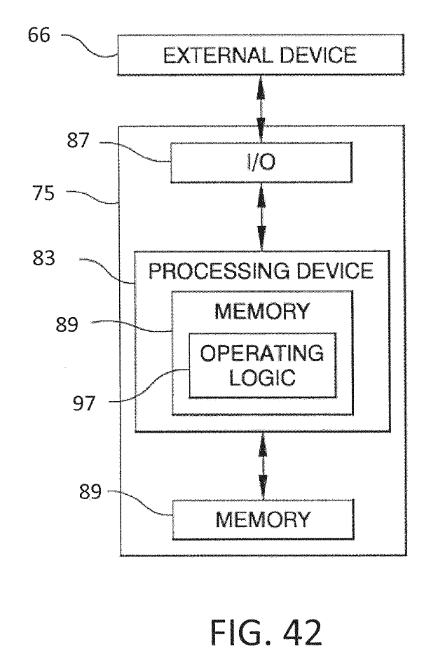

Memory 89 can be of one or more types, such as a solid-state variety, electromagnetic variety, optical variety, or a combination of these forms. Furthermore, memory 89 can be volatile, nonvolatile, or a mixture of these types, and some or all of memory 89 can be of a portable variety, such as a disk, tape, memory stick, cartridge, or the like. In addition, memory 89 can store data that is manipulated by the operating logic 97 of processing device 83, such as data representative of signals received from and/or sent to input/output device 87 in addition to or in lieu of storing programming instructions defining operating logic 97, just to name one example. As shown in FIG. 42, memory 89 can be included with processing device 83 and/or coupled to the processing device 83.

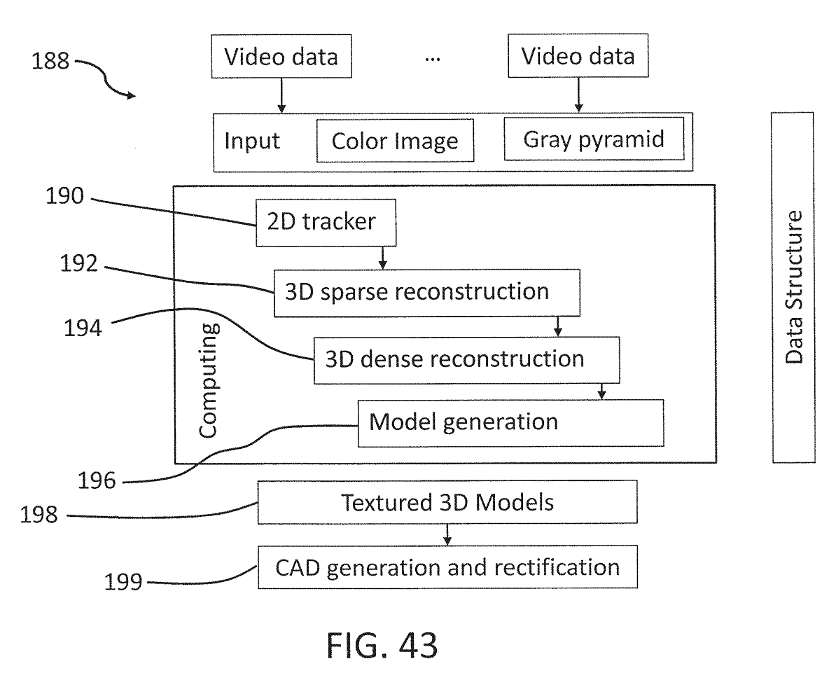

Information from the ROV 52 such as camera images, inertial sensor data onboard the ROV 52 (e.g. from accelerometers and/or an IMU package) can be used in a vision based modelling system useful to create a model of the interior of the tank or housing 13 for further inspection. A vision based modelling system 188 is shown in FIG. 43 and is described further below. The vision based modelling system includes modules such as algorithmic modules useful to produce high-quality vison-based dense 3D transformer modelling and 3D transformer model rectification if available.

The array of N-cameras 90 (described above) can be used to browse inside of the tank or housing 13, which in some cases can include interactively browsing. The cameras 90 can be fixed in some embodiments as will be appreciated. As a result of the browsing, a dense texture-mapped scene model can be generated in real-time using the techniques described herein. Each respective 3D model that corresponds to each camera can be composed of depth maps built from bundles of frames by dense and sub-pixel accurate multi-view stereo reconstruction.

Photometric information can be collected sequentially and separately for each camera in a form of cost volume, and incrementally solved for regularized depth maps via a non-convex optimization and Newton method to achieve fine accuracy.

A correspondent cost volume of each camera can be fused in a single voxel. This process can require the use of the onboard telemetry of the ROV 52 and the information of the camera location with respect of each other in order to compute a global alignment into the voxel so the optimized contribution from each cost volume can be connected in a global coordinate system. This process is useful when rectifying the anomalies coming from the oil environment.

By using the onboard telemetry, the 3D model has a real scale, and can be registered to a CAD model if one exists in order to increase the accuracy of the reconstruction. This registration requires the use of the CAD or analogous model as a generator of a point cloud. Since CAD models have very few 3D points compared with dense point clouds, the techniques described herein utilize a ray tracing algorithm with an average of 300 virtual cameras in order to generate a point cloud from the CAD model.

The 3D modelling approach (FIG. 43) takes advantage of the slow motion of the 6 degree of freedom (DOF) inspection robot due to the oil environment in which is submerged, where thousands of narrow-baseline video frames from multiple cameras are the input to each depth map and then a global 3D reconstruction is constructed.

The approach described herein uses multi-video and telemetry data that is coming from the ROV 52 (e.g. a 6 DOF tank inspection robot such as a transformer inspection robot) and it is able to reconstruct the transformer in quasi-real-time and keeps updating and optimizing the interior of the transformer while the robot is navigating. Described herein are: (1) a distributed reconstruction pipeline which exploits the individual capabilities and requirements of the system components; obtainment of dense reconstructions on-the-fly, with real time processing; and (3) an interface that allows the operator to interact with the reconstruction process and create annotations.

Turning now to the 2D tracker module 190 depicted in FIG. 43, images are transmitted uncompressed and in full-resolution from the ROV 52 (e.g. submergible inspection robot). Transmitting images in this fashion can allow detection of the same features as the 2D tracker and the sparse reconstruction later in the dense reconstruction. New map points can be added by triangulation with neighboring views and refined by local bundle adjustment algorithm per camera.

The tracking part of the vision based modelling system can run on the ground station and has two important tasks: it delivers pose estimates for the input frames (every input frame in some embodiments) and it selects image frames based on the scene coverage of the map.

A 3D sparse reconstruction module 192 is also depicted in FIG. 43 in which global bundle adjustment with telemetry integration is applied whenever the reconstruction is idle or active. Bundle adjustment (BA) can be applied in a distributed manner in each camera in order to generate sparse maps from each source.

The system 188 described herein can employ a very simple inter-frame rotation estimator to aid tracking when the camera is panning (either by virtue of movement of the ROV 52 or movement of the camera, in which case measurement of the camera position can be taken); generating an image re-localization approach supported by accelerometers and IMU data (if available) for under-oil usage. The accelerometers/IMU pose of the ROV 52 can be stored and inserted into related image frames (e.g. all further image frames) relative to that in order to reduce uncertainties. As a result, the approach disclosed herein can re-localize in complex tank scenes with repetitive features and, therefore, generate a reliable 3D sparse reconstruction.

A 3D dense reconstruction module 194 is depicted in FIG. 43 and utilizes information from the 3D sparse reconstruction module 192 generated in the previous step to help in the generation of a live dense volumetric reconstructions based on several camera inputs from the ROV 52. The distributed reconstruction is based on variational depth map fusion.

Quasi-dense depth-maps can be computed based on the image frames stored by the sparse reconstruction using a GPGPU-accelerated multi-view whole image registration algorithm. Image frames might exhibit different lighting conditions, therefore normalized cross correlation can be used as robust similarity measure for photometrical information and to avoid coarse-to-fine warping.

A volumetric representation of geometry using a truncated signed distance function can be employed herein. In contrast to mesh based representations, volumetric approaches allow solving for arbitrary 3D geometry. After individual depth maps are fused together, a globally optimal primal-dual approach for regularization applied in the point cloud instead of the mesh can be used.

A model generation module 196 is also depicted in the process of FIG. 43. A transformer model (e.g. CAD) can be generated by converting the point cloud produced from the 3D dense reconstruction module 194 into a mesh. The process works by maintaining a list of points from which the mesh can be grown and extending it until all possible points are connected. The process can deal with unorganized points, coming from one or multiple scans, and having multiple connected parts. The process can work best if the surface is locally smooth and there are smooth transitions between areas with different point densities. The smooth surfaces are achieved in the previous step by regularizing the point cloud before converting to a mesh.

Triangulation can be performed locally, by projecting the local neighborhood of a point along the point's normal, and connecting unconnected points. Results can be visualized in real-time on a ground station interface, which gives the user the opportunity to interact.

Turning now to the textured-annotated 3D transformer modelling module 198, as also depicted in FIG. 43. This module includes an interactive process where textures and annotation can be introduced in to the model in order to introduce augmented information to the model. Information from the model generation module 196 is provided to this step with a high-quality transformer model, and then information about relevant features can be added on-the-fly while the ROV 52 is performing an inspection task, highlighting anomalies or elements that require additional off-line analysis.

A CAD generation and rectification module 199 is depicted in FIG. 43. In some cases, objects within the tank or housing 13, such as but not limited to transformer components, have associated CAD models from manufacture. In these cases, the system 188 can the original CAD models as a ground truth to rectify the transformer model generated on-the-fly. This process can be performed in real-time and iteratively optimized while the inspection is performed. The same rectification is performed if a valid transformer model is available from a previous inspection using this method. Such rectification techniques can compare common points between the stored version (e.g. CAD model) and the mesh version (determined using the techniques herein).

If the model generation was performed without telemetry the model is up to scale factor, then the previous model is used for global alignment and rectification bringing the generated model to real-scale.

Any one or more of the modules described herein can be performed on a single computer, but some embodiments of the system 188 can be distributed over many separate computers.

As discussed below, according to certain embodiments, the system 50 can include a submersible remotely operable vehicle or ROV 52 used for inspection of liquid cooled electrical transformers 12 that can include a number of separate cameras 90 and sensors 48 for mapping and navigating the internal structure of the transformer 12 with liquid coolant 14 remaining in the transformer 12. The remotely operable vehicle or ROV 52 can be wirelessly controlled to perform various inspection functions while the number of cameras 90 provide video streams for processing to produce a three dimensional field of view based on an observation position of the remotely operable vehicle or ROV 52. Moreover, according to certain embodiments, the system 50 can be configured to use vision-telemetry based autonomous navigation and mapping with a submersible remotely operable vehicle or ROV 52 to internally inspect electrical transformers 12.

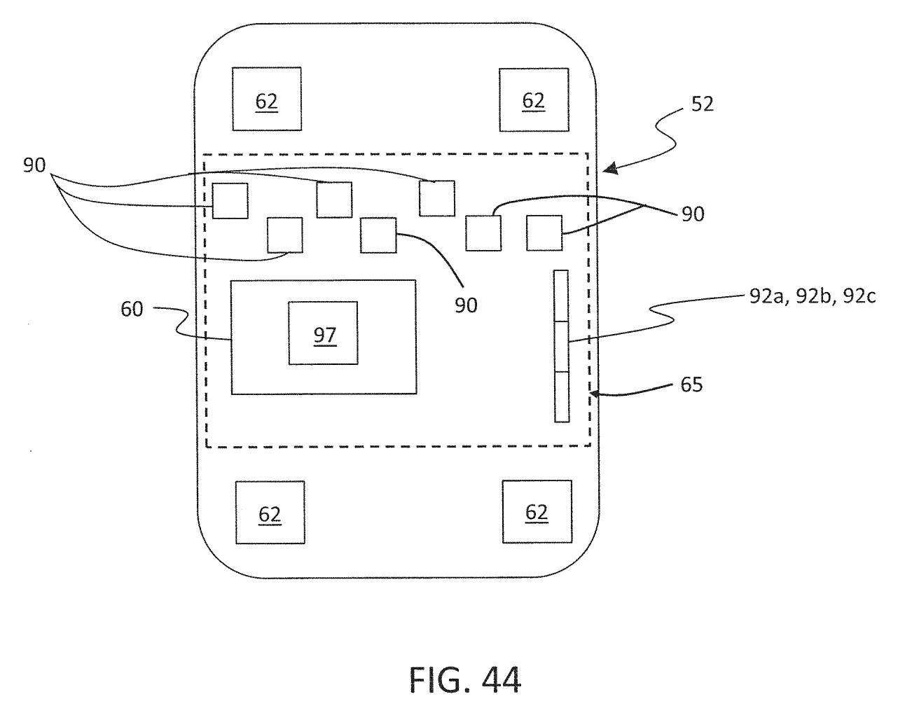

Turning now to FIG. 44, one embodiment of the ROV 52 is depicted as including a number N of cameras 90, motors 62 and transmitter and/or receivers 92a, 92b, and 92c. Other components can also be included in the ROV 52 but are not illustrated for sake of brevity (e.g. a battery to provide power to the cameras, additional sensors such as rate gyros or magnetometers, extendable arm(s) with fiber optic camera(s) for inspection in tight locations, etc.). The cameras 90 are utilized to capture video streams that image the internal components of the transformer as ROV 52 navigates the transformer 12.

In one embodiment of the ROV 52, a number N of cameras 90 are provided that are fixed in orientation and fixed relative to one another, and do not have separate mechanisms (e.g. a servo) to change their point or field of view. In other embodiments, all cameras 90 of the ROV 52 have a fixed field of view and are not otherwise capable of being moved. The cameras 90 can be arranged in different directions to provide overlapping fixed fields of view. The cameras 90 provide video to allow technicians to monitor and inspect various components within the transformer 12. The cameras 90 can take on any suitable form for moving picture cameras (e.g. video camera). Any number and distribution of the cameras 90 are contemplated. In one form, the ROV 52 can have an array of cameras 90 distributed in one region, but in other forms, the cameras 90 can be located on all sides of the ROV 52. In another form, one or more cameras 90 is a fiber-optic camera provided on a remotely controlled arm that is guided to provide a detailed inspection of transformer windings, such as a borescope.

In some embodiments, the ROV 52 is provided with lights that facilitate illumination of the area surrounding the ROV 52. In some embodiments, the lights are light emitting diodes, but it will be appreciated that other illumination devices could be used. The illumination devices are oriented to illuminate the viewing area of one or more of the cameras 90. In some embodiments, the user can control the intensity and wavelength of the light.

The ROV 52 illustrated in FIG. 44 also includes a controller 60 that can be used to receive a command and provide a control signal to a useful component of the ROV 52. For example, the controller 60 can be used to activate one or more motors 62, cameras 90, and/or one or more additional sensors. The controller 60 can also be used to activate a ballast system, either of the emergency type or an active ballast system used to control depth under the liquid surface. The controller 60 can be comprised of digital circuitry, analog circuitry, or a hybrid combination of both of these types. Further, the controller 60 can be programmable, an integrated state machine, or a hybrid combination thereof. The controller 60 can include one or more Arithmetic Logic Units (ALUs), Central Processing Units (CPUs), memories, limiters, conditioners, filters, format converters, or the like which are not shown to preserve clarity. In one form, the controller 60 is of a programmable variety that executes algorithms and processes data in accordance with operating logic 97 that is defined by programming instructions on a non-transient computer readable medium. Alternatively or additionally, operating logic 97 for the controller 60 can be at least partially defined by hardwired logic or other hardware.

In one form, cameras 90, controller 60 with operating logic 97, and transmitters and/or receivers 92a/92b/92c, form a local positioning system 65 that provides visual and telemetry data to determine the location and orientation of the ROV 52 and, when combined with the use of a model (such as a CAD model) of the transformer 12 stored in a memory of controller 60 and/or in computer processor or computational device 18, local positioning system 65 is operable to determine an observation position of ROV 52 inside of the tank of transformer 12.

The local positioning system 65 and computer processor or computational device 18 provide robust vision-telemetry based autonomous navigation and mapping for a submersible transformer inspection robot such as ROV 52 using multi-sensory input. The navigation and mapping based on the known observation position of ROV 52 enable an effective and complete internal inspection of a transformer and generate information for a database to track transformer conditions over time. By simultaneously mapping and navigating, the user can easily track which internal portions of the transformer have been inspected and return to identified areas of concern for further investigation.

A processor of local positioning system 65 and/or computer processor or computational device 18 employs individually aligned and calibrated monocular reconstructions of video streams from a moving, rigidly linked array of N cameras 90 with overlapping FOV's in order to generate a dense global three-dimensional map of the transformer 12. This map helps to generate an accurate single dynamic camera pose per frame, and to rigidly connect the relative camera poses. These camera poses and the rigid distribution of the cameras are processed to compute the observation position, such as a centroid, of the ROV 52 and therefore its global pose within transformer 12. This information is computed and updated in real-time in order to provide a real-time autonomous navigation for ROV 52 inside the transformer 12.

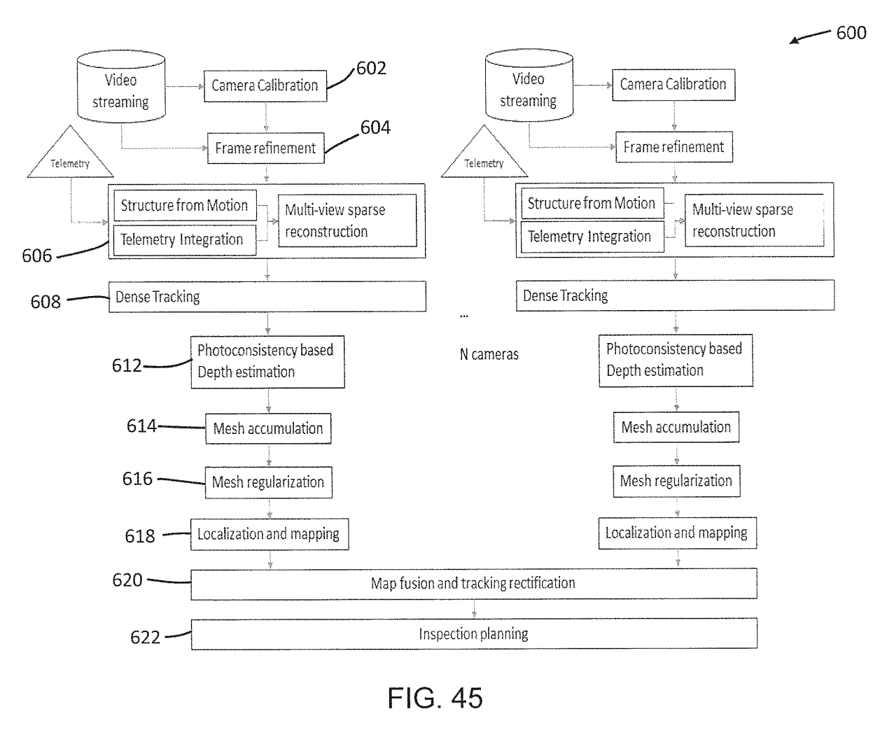

Turning now to FIG. 45, one embodiment of a flow diagram of a procedure 600 for operation by a processing system of local positioning system 65 such as controller 60 and/or computer processor or computational device 18 is provided. Procedure 100 obtains information from video streams from each of the N cameras 90 mounted in the ROV 52 and telemetry data from one or more sensor in ROV 52. These video streams are broadcast to a ground station such as computer processor or computational device 18 that performs a camera calibration at operation 602. For each frame of the video stream coming from the respective camera 90, the procedure 600 also includes refining the frame by applying several filters at operation 604. Procedure 600 then includes an integration operation 606. Operation 606 includes building or obtaining a structural model of the transformer and refining the structural model by integrating telemetry data from ROV 52 to reduce the uncertainties associated with rotation and translation of the ROV 52 during navigation.

Procedure 600 continues at operation 606 by creating or updating the multi-view sparse reconstruction of the frames from the filtered frames, and then at operation 608 by using the previous information to generate a dense reconstruction and localization of the frames for dense tracking. Procedure 600 further includes an operation 612 for using photo-consistency based depth estimation to clean-up the estimated depths of the images in the frames, and an operation 614 for keeping mesh accumulation for the point clouds and an operation 616 for converting to mesh in order to regularize the structure. The regularized mesh is then used for localization and mapping of the transformer at operation 618.

These steps of procedure 600 are performed in real-time for each camera N present in the system. Moreover, in order to create a global map, the maps obtained per camera are fused and rectified in real-time at operation 620 to provide a three-dimensional field of view based on the observation position of the ROV 52. After processing the frames from several of the cameras 90, the ROV 52 is ready to compute collisions and plan the motions for the transformer 12 for inspection planning at operation 622.

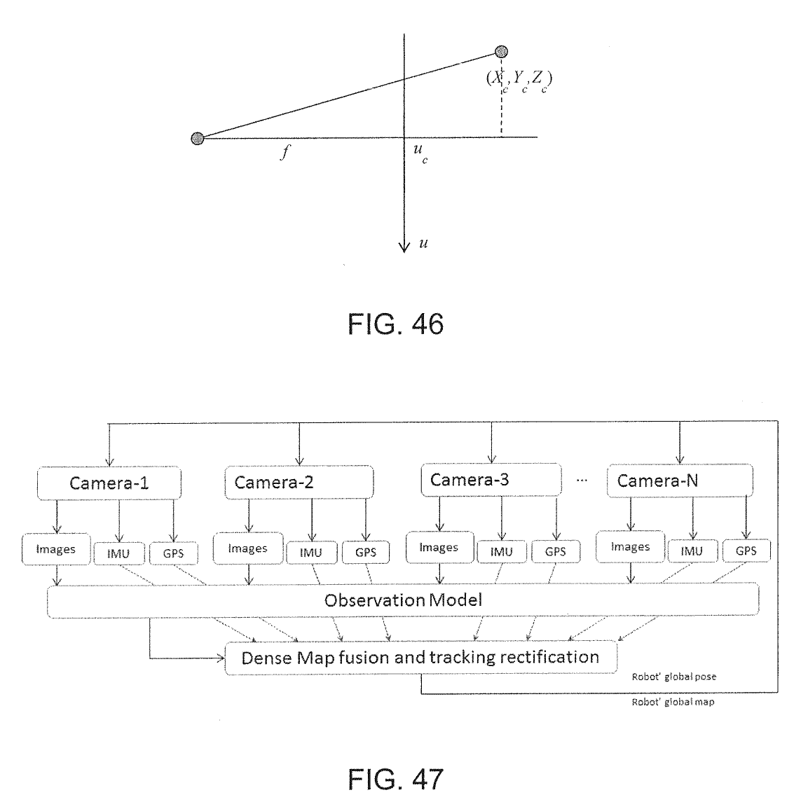

With respect to camera calibration operation 602 of procedure 600, multiple planar patterns and subsequently a non-linear optimization algorithm can be used to refine intrinsic parameters in order to get the global minima. For example, FIG. 46 depicts a projection of a 3D point (X_{c}, Y_{c}, Z_{c}) to the camera plane (u, v) to find the camera parameters from known 3D points or calibration object(s). These camera parameters can be internal or intrinsic parameters such as focal length, optical center, aspect ratio and external or extrinsic (pose) parameters described by the following equations:

$$\begin{matrix}[ \begin{matrix}Xc \\ Yc \\ Zc\end{matrix} ] = {[ R ]}_{3 \times 3} [ \begin{matrix}X \\ Y \\ Z\end{matrix} ] + t \\ [ \begin{matrix}u \\ v \\ 1\end{matrix} ] \text{∼} [ \begin{matrix}U \\ V \\ W\end{matrix} ] = [ \begin{matrix}f & 0 & {u}_{c} \\ 0 & f & {v}_{c} \\ 0 & 0 & 1\end{matrix} ] [ \begin{matrix}Xc \\ Yc \\ Zc\end{matrix} ] & Equations 1 and 2 \\ K = [ \begin{matrix}fa & s & {u}_{c} \\ 0 & f & {v}_{c} \\ 0 & 0 & 1\end{matrix} ] & Equation 3\end{matrix}$$

where R and t are the extrinsic parameters that describe the locations of the cameras, and K is the intrinsic calibration matrix that encloses focal length, radial distortion, non-square pixels, skew and principal point.

A calibration operation is required for the extraction of the three dimensional metric measurements from a set of frames for each camera 90 present in the ROV 52. The calibration of an under-oil optical device must take into account the effect of refraction at the air-acrylic and acrylic-oil interfaces, which are present when cameras are mounted in their housing of the ROV 52.

In one form, the refraction effect is incorporated into camera calibration parameters through implicit modelling. In this approach, the cameras 90 are calibrated in air, and then calibrated in oil to derive the geometry of the refractive interfaces, since the principal component of both refractive effect and image distortion is radial.

The intrinsic and extrinsic parameters of each camera 90 are obtained by correlating the coordinates of known points located on a calibration sample (checkerboard) with the corresponding coordinates on the image plane in both environments. The next step is to compute the extrinsic parameters of the system, relating each camera frame to a unique global coordinate system. In this way, a relationship between the global coordinate system and the N-array of cameras coordinate systems is established.

Once measurements are taken in both environments, the points all together are undistorted for given projection distortion maps, and solved for xᵤ given x_{d} and D (generally non-invertible) as follows:

$${arg min}_{{x}_{u}} [ {( {\hat{x}}_{d} - D ( {x}_{u} ) )}^{2} ] \qquad Equation 4$$

Linearizing for Lavenberg-Marquard:

$$\begin{matrix}{r}_{u} = \sqrt{{u}^{2} + {v}^{2}} & Equation 5 \\ {s}_{d} = ( 1 + {k}_{1} {r}_{u}^{2} + {k}_{2} {r}_{u}^{4} ) & Equation 6 \\ D ( {x}_{u} ) \approx [ \begin{matrix}u * {s}_{d} \\ v * {s}_{d}\end{matrix} ] & Equation 7\end{matrix}$$

Solving for derivatives:

$$\begin{matrix}J = [ \begin{matrix}\frac{\partial ( u * {s}_{d} )}{\partial u} & \frac{\partial ( u * {s}_{d} )}{\partial v} \\ \frac{\partial ( v * {s}_{d} )}{\partial u} & \frac{\partial ( v * {s}_{d} )}{\partial v}\end{matrix} ] & Equation 8 \\ \frac{\partial ( u * {s}_{d} )}{\partial u} = 1 + {k}_{1} ( {u}^{2} + {v}^{2} ) + {k}_{2} ( {u}^{2} + {v}^{2} ) + u * ( {k}_{1} 2 u + {k}_{2} 4 u ( {u}^{2} + {v}^{2} ) ) & Equation 9\end{matrix}$$

The calibration operation 602 allows the calibration model to use as dominant parameters the parameters from the air environment, under the assumption that these parameters have less distortion than the parameters from the oil environment. This assumption is generally true because the extrinsic parameters do not change in the calibration process (camera position related to the checkerboard) and the distortion parameters can be used to rectify the photometric variation due to lighting conditions.

Procedure 600 further includes filtering at operation 604. In one form, the filtering includes homomorphic filtering. Since the view captured in the interior of the transformer is homogeneous in color, the detection of features and shapes is difficult without filtering. Non-uniform lighting can be corrected and edges can be sharpened at the same time by enhancing the quality of each video frame through homomorphic filtering. Since an image or video frame can be considered as a function of the product of the illumination and the reflectance, a homomorphic filter can be used to correct non-uniform illumination to improve contrasts in the image.

Since the homomorphic filter amplifies the noise present in the video frame, the noise can be suppressed by applying a wavelet de-noising technique at operation 604. Multi-resolution decompositions have shown significant advantages in image or video de-noising. In one form, this de-noising filter uses nearly symmetric orthogonal wavelet bases with a bivariate shrinkage exploiting inter-scale dependency. Wavelet de-noising does not assume that the coefficients are independent, which increases the quality of the output.

Operation 604 can further include applying an anisotropic filter to the video frames. This filter is applied to smooth the image frame in a homogeneous area, and preserve and enhance edges. It is used to smooth textures and reduce artifacts by deleting small edges amplified by the homomorphic filter use in the previous steps. It also removes or attenuates unwanted artifacts and remaining noise.

Operation 606 includes telemetry integration and determining structure from motion. The ROV 52 has a full six degree of freedom (DOF) pose, x=[x, y, z, φ, θ, ψ]^{T}, where the pose is defined in a local-level Cartesian frame referenced with respect to the interior faces of the transformer. A pose-graph parallel localization and mapping approach can be used for state representation where the state vector, X, is comprised of a collection of historical poses.

Each node in the graph, xᵢ, corresponds to a video frame that is included in a view-based map, and these graph nodes are linked by either telemetry or camera constraints. For each node, measurements of gravity-based roll/pitch and yaw (IMU, accelerometers, etc.) are added as absolute constraints since absolute heading measurements can be unavailable due to inability to obtain a magnetically-derived compass heading near ferrous transformer walls.

Operation 606 allows the ROV 52 to localize itself with respect to the transformer environment to determine an observation position, generating at the same time a near optima sparse map. Operation 608 of procedure 600 includes dense tracking and map regularization. In order to get more complete, accurate and robust results in mapping and localizing, each element of the graph can be post-processed. The graph increases gradually while the ROV 52 navigates in the fluid environment, and post-processing of each graph element occurs for each node after is added to the graph. This post-processing can use an estimated global-robot frame transformation and the whole frame information (every pixel from the image) to perform a full dense camera tracking via whole image registration. This operation is performed for each frame in real-time, and provides a high quality texture-mapped model via mesh accumulation and mesh regularization. Moreover, accurate camera localization at frame-rate is obtained by using a whole image map alignment.

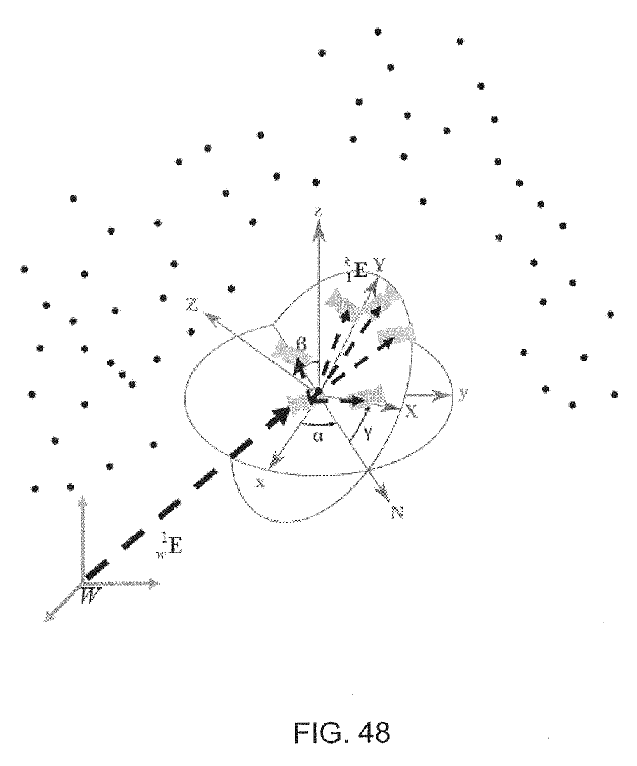

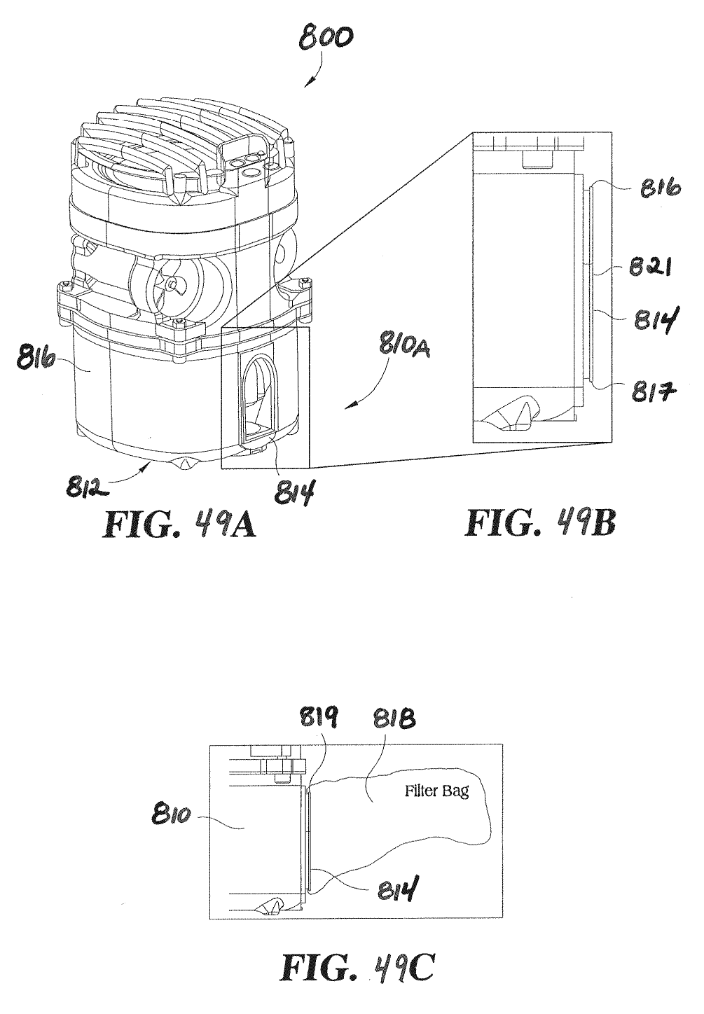

Operation 620 of procedure 600 involves map fusion and tracking rectification. The previous operations are applied to the video streams coming from each camera 90. Therefore, N dense maps and N camera graph poses are available. Since the relative camera positions are known to respect to each other due to the fixed housing for each camera inside the ROV 52, a global pose or observation position for the ROV 52 can be computed and use to globally rectify and fuse the N maps into a single map, as depicted in FIG. 47. The updates to the global map are also performed in real-time.

The multi-camera real-time dense mapping and localization allows the ROV 52 to have a rectified three-dimensional map in real-time. In addition, by using N cameras that face different views, the robot has a quasi-spherical FOV, such as depicted in FIG. 48, which provides advantages. For example, a very large FOV increases the size of the map per time stamp. In addition, a quasi-spherical FOV provide instantaneous information about the scene inside the transformer, reducing the need for several robot motions that commonly are required to obtain multiple views in order to have an initial estimation of the scene. Further, the quasi-spherical FOV video can be displayed on a video receiver device such as display 19 to provide an immersive first person view to the user for better steering, inspection and replay experience. Moreover, the real-time dense mapping procedure 600 provides the ROV 52 the ability to detect almost instantaneously collisions in any kind of operation mode such as tele-operated or autonomous operation.

An accurate pose estimation for the observation position of the ROV 52 and a robust estimation of the surroundings inside the transformer 12 improve navigation of ROV 52. The map is used to detect collisions in the known and growing three dimensional environment, and a motion planning algorithm can be employed to assist ROV 52 in navigating between a set of given viewpoints. After the map is created, the user can define restriction zones, define the inspection locations/viewpoints, etc. to simplify the inspection process. Eventually, the user can automate the inspection. Further, multiple inspection robots can be allowed to work at the same time in different zones to improve the inspection speed.

ROV 52 can be used as a supporting technology for robotic inspection of large size transformers in order to maintain and service them. By mapping the internal structure of a transformer during each inspection, new insight into the changes of the transformer and optical properties of its oil over time can be developed. For example, changes in oil properties from the camera calibration can be observed and recorded to indicate a condition of the oil. This type of data will produce insights into transformer condition previously not possible to realize.

One mode of operation of the system 50 that can be used in whole or in part with the various embodiments described above progresses as follows: to ensure reliable communication between the ROV 52 and the computer processor or computational device 18, a transceiver 82 can be inserted into the cooling oil tank through the service opening on the top of the transformer. In certain embodiments, the transceiver 82 is used to exchange data information from a sensor(s) on the ROV 52 and the cameras 90, via a controller to the computer processor or computational device 18; and motion control or maneuvering signals from the joystick 24 via the computer processor or computational device 18 to the controller so as to operate the motors 62 and thrusters. The video and telemetry signals transmitted by the ROV 52 are used by the computer processor or computational device 18 to determine the ROV position and orientation within the tank of transformer 12.

The computer processor or computational device 18 receives the telemetry and video signals to collect data and produce a three dimensional image or video from the observation position of the ROV 52 that correlates the received signals to the model of the tank to allow a technician to monitor and control movement of the ROV 52 while oil or other fluid remains inside the transformer tank. The disclosed embodiments calibrate the multiple cameras 90 that are to be used in a transformer cooling fluid environment, and reduce the effects of noise dominant measurements, limited FOV's, and light distortion due to the in-fluid environment.

The disclosed system 50 allows the technician to inspect the internal components of the transformer and pay particular attention to certain areas within the transformer if needed. The ROV 52 position and route through the tank is mapped, navigated and recorded so that when used in conjunction with a model of the internal parts of the transformer 12, the ROV 52 location and orientation can be determined to define the observation position of ROV 52 inside the tank.

By utilizing a model of the internal features of the transformer and the position and orientation of the ROV 52 with respect to those internal features, the video image obtained can be matched with the corresponding observation position inside the actual transformer tank. Based on the observation position and expanded FOV provided by the processing of the multiple video images from cameras 90, a technician can manipulate the joystick 24 in response to navigate through transformer 12. The computer or computational device 18 receives the movement signals from the joystick and transmits those wirelessly to the antenna 92, whereupon the controller implements internally maintained subroutines to control the pump thrusters to generate the desired movement. This movement is monitored in real-time by the technician who can re-adjust the position of the ROV 52 as appropriate.

As discussed below, according to certain embodiments, the system 50 can include an inspection vehicle or ROV 52 that is operable for performing one or more maintenance and repair operations in a tank or housing 13 filled at least partially with a liquid medium, such as, for example, a cooling fluid 14. Moreover, as discussed below, one or more maintenance tools operable with the inspection vehicle or ROV 52 are configured to perform maintenance, including, for example, vacuum and/or repair procedures or operations, within the liquid filled tank or housing 13.

Referring now to FIGS. 49A, 49B and 49C, an inspection vehicle or ROV 800 can be configured to perform maintenance and/or repair procedures. The inspection vehicle or ROV 800 can include one or more tools for performing maintenance and/or repairs within a tank or housing 13 (see FIG. 1) while remaining filled at least partially with a liquid. In one form, one of the maintenance tools can include a vacuum system 810A. The vacuum system 810A can include an inlet port 812 for receiving entrained solid particle sediment or other foreign objects that become dislodged within the tank or housing 13. Any type of foreign object could be drawn into the inlet port of the inspection vehicle or ROV 800 as long as the object has a size or shape suitable for moving through rotatable machinery and internal passageways of the inspection vehicle or ROV 800.

In some forms an internal design of the vacuum system 810A can include a system of passageways that provide solid particle separation upstream of any rotating machinery such the solid particles will bypass the rotating pump machinery. In this manner, solid particles can be removed without causing surface wear or other structural damage to the rotating pump machinery. An outlet port 814 is formed in a wall of the inspection vehicle or ROV 800. The outlet port 814 is in fluid communication with inlet port 812 via one or more internal passageways (not shown) as one skilled in the art would understand. In the exemplary embodiment, a filter system can include a filter attachment bracket 816 shown best in FIG. 49B is formed adjacent the outlet port 814. The attachment bracket 816 can include a bracket rim 817 formed about or segmented intermittently about the attachment bracket 816 to facilitate secure attachment means thereto.

In some forms a door (not shown) can be operably connected adjacent the outlet port 814. The door can be opened when the vacuum system 810A is operating and closed at other times as determined by the control system. The filter system can include a filter bag 818 that operably connected to the filter attachment bracket 816 in any number of ways. The filter bag 818 can include a bag rim 819 configured to securely hold the bag 818 with respect to attachment bracket 816. By way of example and not limitation, attachment means used to connect the bag rim 819 to the bracket rim 817 can include threaded fasteners, clips, interference fit, chord/twine, string or other means as one skilled in the art would understand. In one form, the filter bag 818 can be initially positioned internal to an outer perimeter wall 821 of the inspection vehicle or ROV 800 until the vacuum system becomes operational in order to promote movement of the inspection vehicle or ROV 800 without interference. Upon initiation of the vacuum, the filter bag 818 can protrude outward of the outlet port 814 as illustrated in FIG. 49C. In some embodiments, the filter bag 818 protrudes outward from the vehicle housing in all operating conditions. In other embodiments, the vacuum system 810A can include a filter that remains partially or completely within the boundary of the outer perimeter wall 821 of the outlet port 814 during operation of the vacuum system 810.

While not shown in the exemplary embodiment, other forms of filtering or otherwise removing and retaining solid particle objects are contemplated by the present application. For example, a separate container or compartment can be formed within the housing 816 of the inspection vehicle or ROV 800. The solid particles can be separated from the liquid flow and become trapped in the container by way of screen or mesh material located adjacent to the container or by way of centripetal vortex fluid action as a skilled artisan would understand.

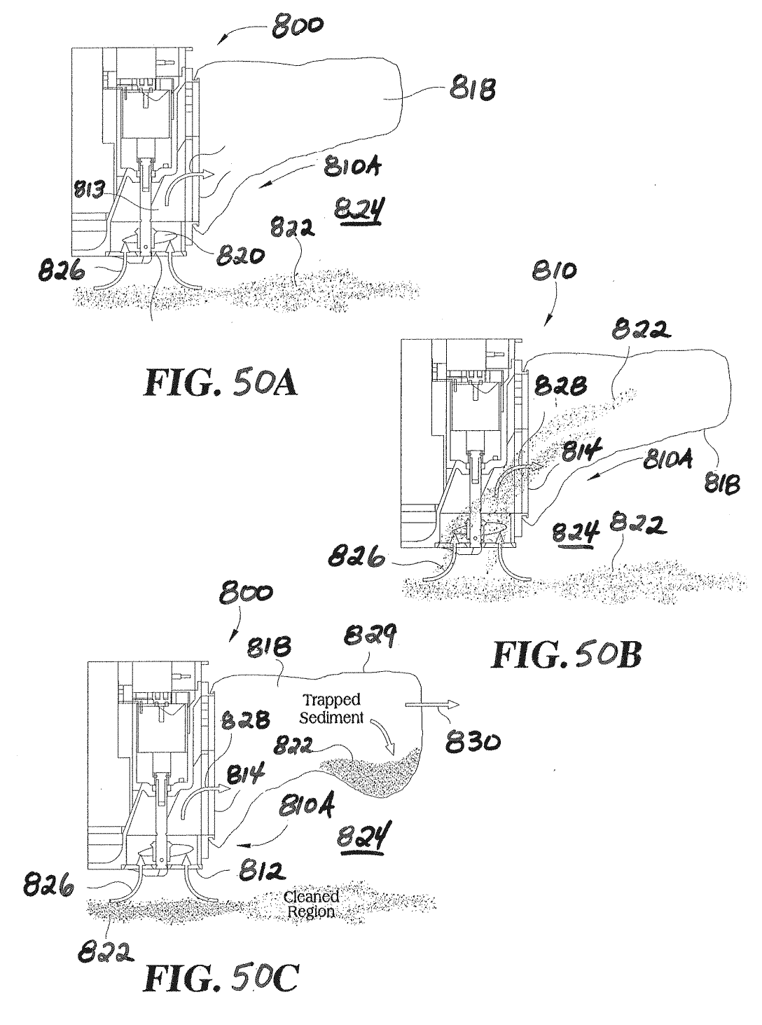

Referring now to FIGS. 50A, 50B and 50C, operation of the vacuum system 810A of the inspection vehicle or ROV 800 is illustrated. In FIG. 50A, the inspection vehicle or ROV 800 includes a pump 820 operable for providing suction of a liquid medium 824 and causing solid particle sediment 822 to be entrained in an inlet flow stream 826. The pump 820 can also act as a thruster for the inspection vehicle or ROV 800 in some embodiments. In other embodiments, the pump 820 is separate from the thrusters or other vehicle propelling means. It should also be understood that while a single pump 820 is illustrated in the exemplary embodiment, additional pumps with additional flow passageways are contemplated by this disclosure. The inlet flow stream 826 of liquid 824 and solid particle sediment 822 enters into the inspection vehicle or ROV 800 through the inlet port 812, traverses through one or more internal fluid flow paths 813 and exits via an outlet flow stream 828 through the outlet port 814 prior to being discharged into the filter bag 818.

FIG. 50B illustrates solid particles 822 being entrained with the inlet flow stream 826, passing through an internal region of the inspection vehicle or ROV 800, exiting through the outlet port 814 and entering into the filter bag 818. FIG. 50C illustrates a portion of the solid particles 822 becoming trapped in the filter bag 818 and that the liquid medium 824 passes through a mesh wall 829 as illustrated by arrow 830. In this manner, solid particle sediment 822 can be trapped in the filter thereby creating a cleaned region within the liquid filled tank or housing 13.

Referring now to FIGS. 51, 52A, 52B, 52C, and 52D, the inspection vehicle or ROV 800 can be used to repair components within a liquid filled housing (not shown). FIG. 51 depicts a non-limiting example of a component with damaged portions that can be repaired by the inspection vehicle or ROV 800. In the illustrative embodiment, the component 830 is an electrical coil 830 having insulation 831 surrounding high-tension electrical conductors as is known. An enlarged view 834 of a damaged portion 833 of the coil 830 is shown below an undamaged illustration 832. An enlarged cross sectional view 838 schematically depicts the damaged portion 833 of insulation 831.

Referring now to FIG. 52A, the inspection vehicle or ROV 800 can include maintenance repair tools such as one or more injection nozzles 810B. In the illustrative embodiment, the inspection vehicle includes a first injection nozzle 850 and a second injection nozzle 852. Although two injection nozzles are shown in the exemplary embodiment, it should be understood that a single injection nozzle or more than two injection nozzles can be utilized in other embodiments. The injection nozzles 810B can be used to make repairs to surface layers or material coatings, as well as load bearing structure repair. Such repairs can include without limitation insulation repair, crack repair or complete structural repair. The repair methods can include any forms that are viable when the vehicle or ROV 800 is submerged in a liquid filled container. The specific formulation of the repair compounds or repair techniques can vary to be compatible the liquid. As described previously, in one form the liquid can be a mineral oil, however other liquids are contemplated. The nozzles 810B can be operable to inject repair epoxy, a two-part acrylate paste, a UV light hardened epoxy, a pre-impregnated fiberglass patch, or other forms as would be known to those skilled in the art. An additional light source such as UV light 860 can be coupled to the inspection vehicle or ROV 800 and used for some repair processes. Further, while not shown, the repair vehicle or ROV 800 can include other maintenance tools, such as cutting tools, grinding tools, welding tools, soldering tools, drilling tools as well as other types of tools.

Referring now specifically to 13B the inspection vehicle or ROV 800 is shown approaching a damaged cross-sectional area 838 of a component 830. The injection nozzles 850, 852 are positioned at a location adjacent the damaged portion 838 of the component 830. After the inspection vehicle or ROV 800 is in position as shown in FIG. 52C, the injection nozzles 850, 852 can inject or otherwise discharge a liquid repair compound 842 on to the damaged portion 838 of the component 830.

FIG. 52D illustrates a surface repair such as an insulation layer replacement or the like. The damaged component 838 is repaired after the liquid repair compound 842 becomes a hardened compound 844. As explained above, the exemplary embodiment described herein is only one repair method out the many possible methods that can be contemplated by one skilled in the art.

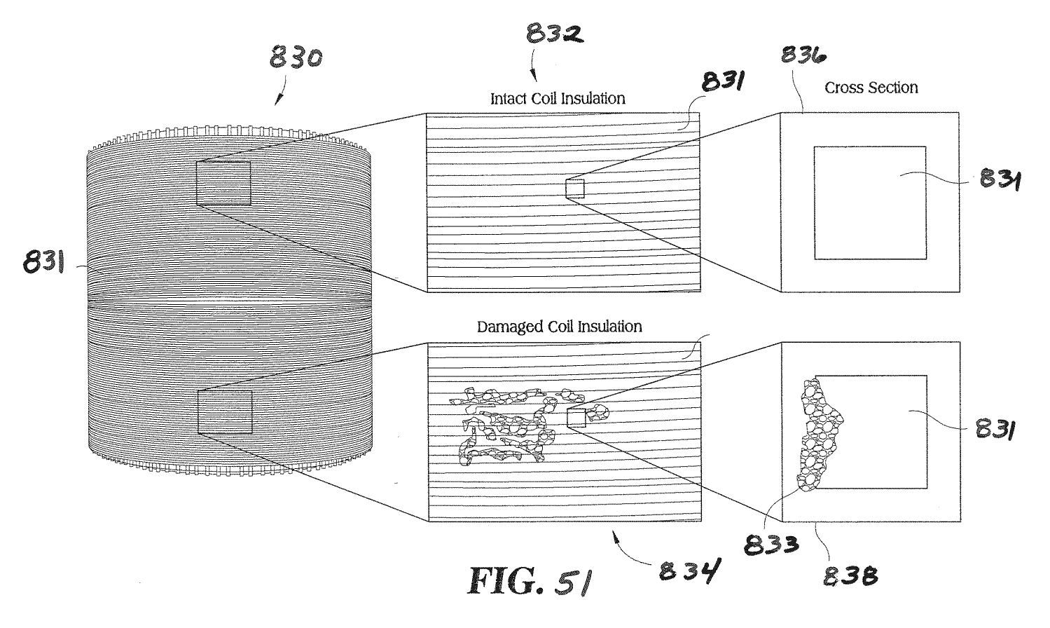

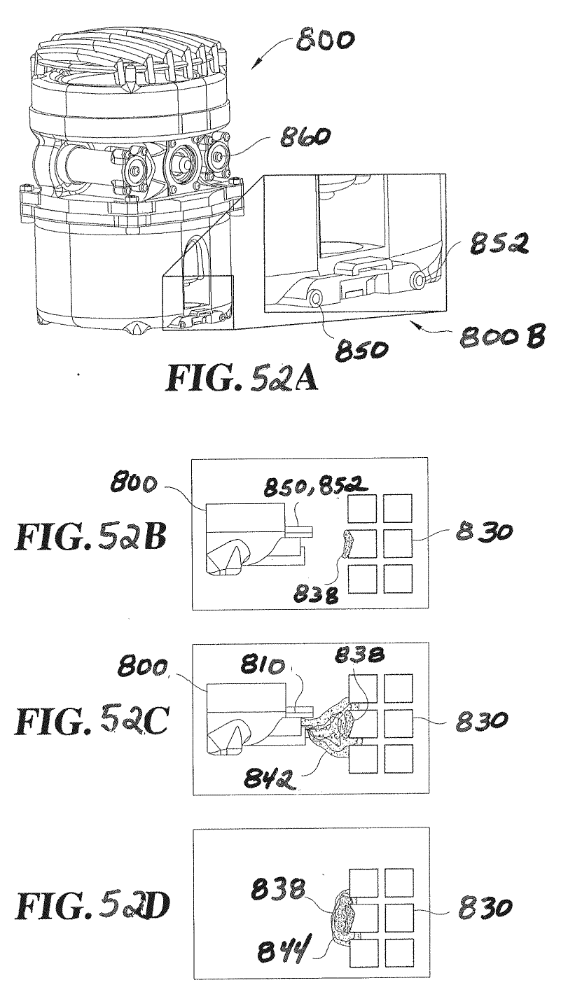

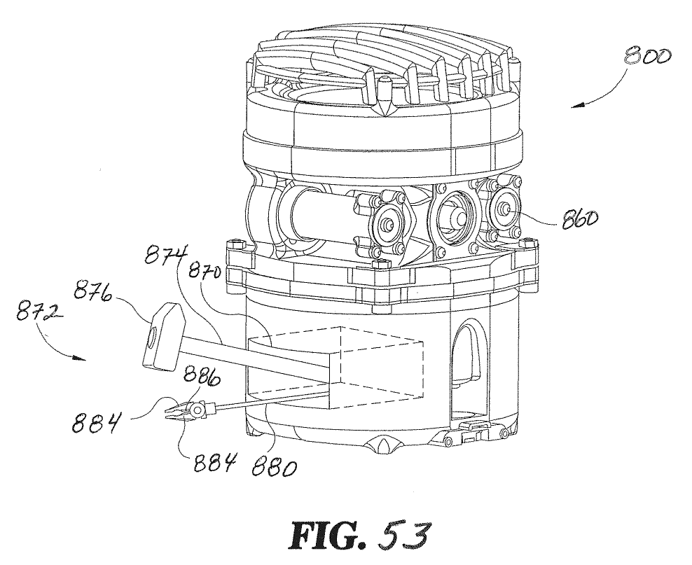

Referring now to FIG. 53, another embodiment of the inspection vehicle 800 is illustrated with additional examples of maintenance tools that can be operably used in some applications. A tool bay 870 can be formed within a portion of the inspection vehicle 800 for storing one or more maintenance tools therein. In some forms the tool bay 870 can partially reside externally to the inspection vehicle 800. In other forms the tool bay 870 can reside entirely externally to an outer housing of the inspection vehicle 800.

One or more tools 872 can be operably coupled with the inspection vehicle 800. When not in use, the tools can be stored in the tool bay 870. The tool bay 870 can have a door (not shown) configured to close an opening when the tools 872 are stored and not in use. In some embodiments a separate tool bay 870 may not be formed with the inspection vehicle 800 and the tools can be coupled to other portions of the inspection vehicle 800. The tools 872 can be deployed from the tool bay 870 when a task identified by the inspection vehicle 800 or an operator is identified.

One or more arms 874, 880 can connect to one or more tools 872. The arms 874, 880 can have telescopic elements and hinge elements so as to provide means for positioning the tools 872 in a desired location and orientation. In non-limiting examples, the tools 870 can include an impact device 876 such as a hammer, gripping jaws 884 and cutting devices 886 as well as other tools that are not illustrated, but would be understood by one skilled in the art. Such tools can include, but are not limited to rotary tools for installing or removing threaded fasteners, magnetic tools and welding tools or the like. In some forms a magnetic device to can be used to magnetically couple the inspection vehicle 800 to a magnetic material within an inspection region or to pick up a magnetic object within the inspection region. The tools 872 can be used to collect debris, pick up and transport objects such as tools or the like, remove and replace parts or components within the liquid filled apparatus, cut objects and perform other maintenance operations as would be known to those skilled in the art.

As discussed below, according to certain embodiments, the system 50 can include a tether control system for an inspection vehicle or ROV 52 operable in a tank or housing 13 having a liquid medium, such as, for example, a cooling fluid 14. The tether system can include a tether connected between the inspection vehicle or ROV 52 and an electronic controller. A controllable buoyancy system associated with the tether can be operable for moving the tether in a desired location. The controllable buoyancy system can include one or more floating bodies having a propulsion system and one or more buoyant elements having variable buoyancy capabilities.

Referring now to FIG. 54, another embodiment of the present application is shown wherein a tank or housing 702 with internal components 739 can be inspected by an inspection vehicle or ROV 52. The housing 702 can include a cooling fluid 704 such as mineral oil or the like that at least partially fills an internal portion of the housing 702. The housing 702 can include a top wall 706 with an access port 708 formed therein. An enclosure 710, such as a lid or the like can be opened or closed as desired to permit or restrict access to internal regions of the housing 702. The inspection vehicle or ROV 52 can be attached to and controlled with a tether 712, when inserted through the access port 708 for operation in the housing 702. A tether system 713 can include a reel or spool 714 in some embodiments. A controller 716 can be connected to the tether 712, to provide electrical communication between the inspection vehicle or ROV 52 and the controller 716. The tether 712 can include one or more buoyant elements 718 and one or more floating bodies 720 operably connected thereto. The buoyant elements 718 and the floating bodies 720 provide position control of the tether 712 at various locations along a length thereof.

FIG. 55 illustrates a schematic view of a buoyant element 718. The tether 712 can include mechanical, electrical and pneumatic conduits and connections to provide operational control of the buoyant elements 718. The buoyant element 718 includes an inlet valve 722 and an outlet valve 724 connected to an inlet portion of the tether 712a and an outlet portion of the tether 712b, respectively. A discharge exchange valve 726 can be operably coupled to the buoyant element 718 to control a volume of gas and a volume of liquid within the buoyant element and thereby controlling the buoyancy or floating height of the buoyant element 718. The discharge exchange valve 726 can include multiple valve functions and passages to control the volume of gas and the volume of liquid within the buoyant element 718. The discharge exchange valve 726 can include two way liquid flow and/or gas flow such that the liquid and/or gas can pass between the buoyant element 718 and the housing 102 as required. The inlet valve 722 can permit a flow of gas conducted through a conduit associated with the tether 712 to enter the buoyant element 718 and the outlet valve 724 can permit a portion of the gas to egress through the outlet portion of the tether 712b such that the gas can be transmitted to another buoyant element 718 or to a floating body 720 downstream thereof. A flow of pressurized gas such as air or the like can be supplied by a compressor system 745 (see FIG. 54) as one skilled in the art would readily understand. A bypass portion 712c of the tether 712 can provide mechanical, electrical and pneumatic connections that bypass a buoyant element 718 and provide a direct connection to another buoyant element 718, to a floating body 720 or to the inspection vehicle or ROV 52. It should be understood that the valve system with valves 722, 724 and 726 are exemplary in nature and that other valving, gas flow and liquid control can be used and are contemplated under the teachings of the present disclosure.

FIG. 56 illustrates a schematic view of a floating body 720. In one form, the floating body 720 can be permanently sealed without valves or variable buoyancy capability such that the floating body remains floating at the top of the liquid medium. In another form, the floating body 720 can have variable buoyancy capabilities. In this form, the floating body 720 can include an inlet valve 732 connected to an inlet portion 712a of the tether 712 and outlet valve 734 connected to an outlet portion 712b. A discharge exchange valve 736 is operable for controlling an amount of gas and liquid within the floating body 720. A bypass portion 712c of the tether 712 can provide mechanical, electrical and pneumatic connections that bypass the floating body 720 and provide a direction connection to another floating body 720, to a buoyant element 718 or to the inspection vehicle or ROV 52. The operation of the floating body 720 can be similar to the operation of the buoyant element 718. However, the floating body 720 also includes a propulsion system 738 that permits directional control of the floating body 720. The propulsion system 738 can include a propeller or a fluid pump, or the like, and can be rotatably connected to the floating body 720 to control directional movement thereof. The propulsion system 738 is operable for propelling the floating body 720 in a desired direction to maneuver the tether 712 around certain components within the housing 102 such as a component 739 illustrated in FIG. 54. In one form the component 739 can be an electrical component such as a coil for a transformer or the like. However, other components are contemplated herein.

Referring to FIG. 57, a tether control support 740 can be coupled to the housing 102 during an inspection or maintenance operation of the inspection vehicle or ROV 52. The control support 740 is operable to push or pull the tether 712 into or out of the housing 102. In some forms, the control support 740 can include a cleaning device 741 as part of a single device. In other forms, the control support 740 can be separate from the cleaning device 741. The tether cleaning device 741 can include sponge or brush type wipers 742 operable to clean a portion of the fluid 104 from the tether 712 as the tether 712 is retracted from the housing 102. The oil can drain back into the tank or housing 102 in a manner known to those skilled in the art. The tether cleaning device 740 can also include a detergent tank 744 to further clean and remove fluid from the tether 712 prior to rewinding on the reel or spool 714 or otherwise storing for future use. In one form, the tether can be pulled through a detergent bath, in other forms a detergent solution can be sprayed onto the tether 712 through a nozzle, as one skilled in the art would understand.

As discussed below, according to certain embodiments, the system 50 can include a deployment system includes a mount connectable to the housing or tank through an aperture formed in a wall thereof. An extendable arm can be connected to the mount and positioned within the housing or tank. A tether can be slidably coupled to the extendable arm and adapted to connect with the inspection vehicle or ROV 52. A control mechanism is operable to control deployment of the tether and the position of the extendable arm.

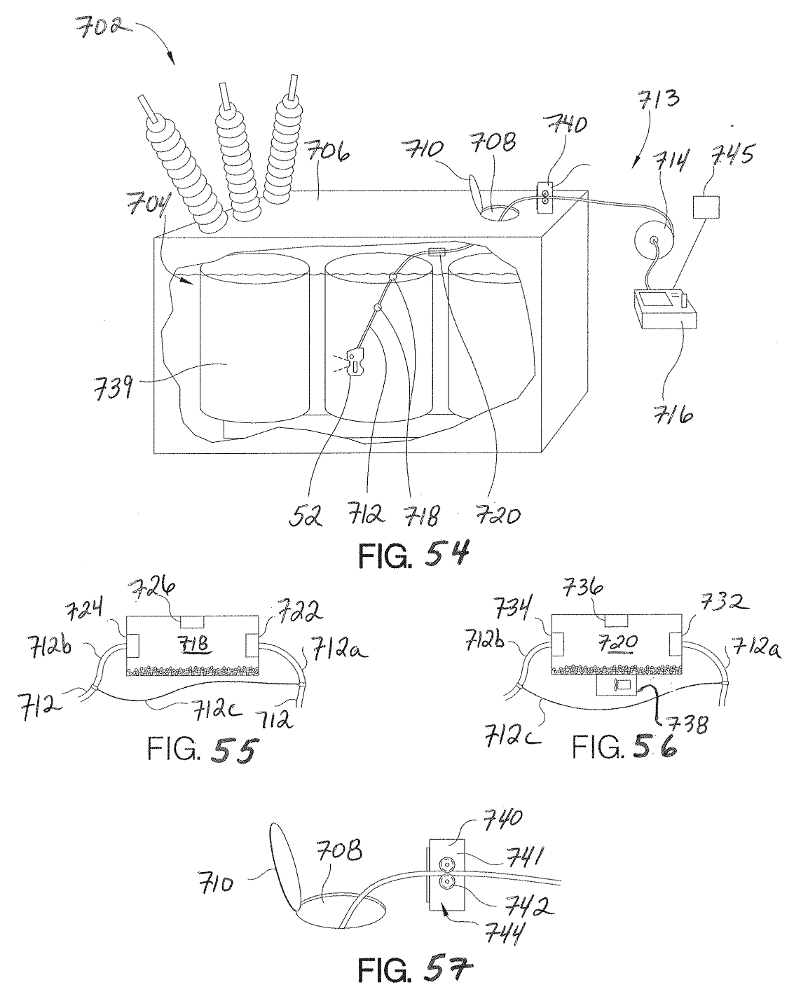

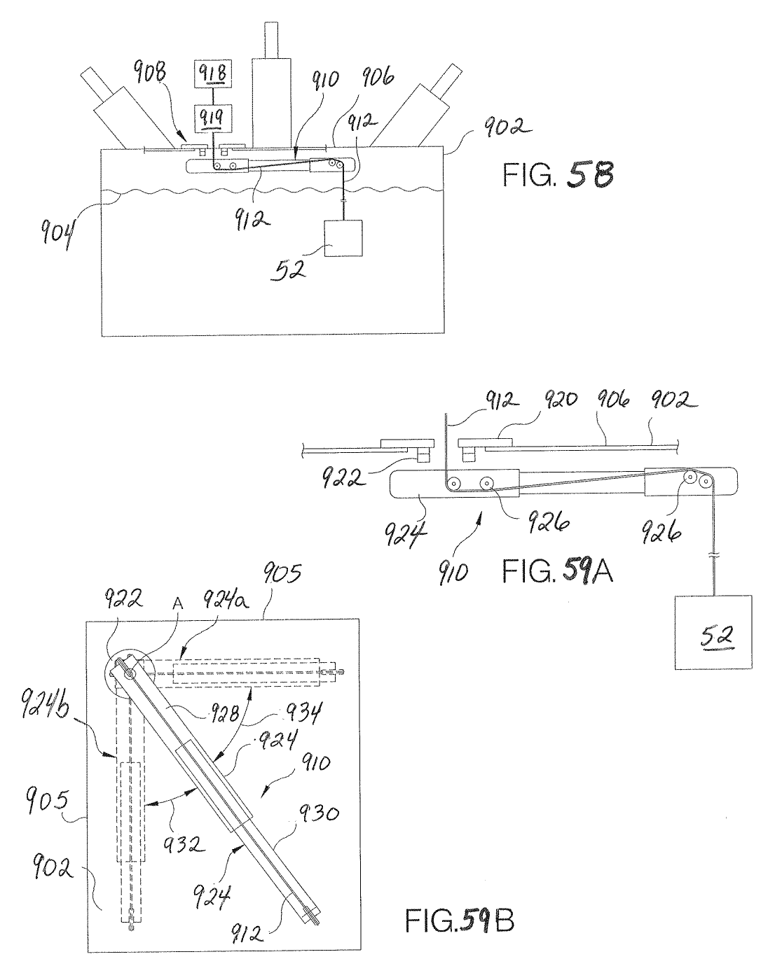

Referring now to FIG. 58, a tank or housing 902 having liquid 904 disposed therein can be inspected with the inspection vehicle or ROV 52. The liquid 904 can include any type of liquid and in some embodiments can provide properties for cooling, or dielectric insulation for certain electrical components (not shown). In one form, the liquid 904 can be mineral oil or the like. The housing 902 includes a top wall 906 with an access port 908 for ingress and egress of a deployment apparatus 910 and the inspection vehicle or ROV 52. The deployment apparatus 910 includes a tether 912 that is operable for deploying the inspection vehicle or ROV 52 into the housing 902 and for and retracting the inspection vehicle or ROV 52 out of the housing 902 after an inspection and/or a maintenance procedure has been completed. In one form, a control system 918 can be operably coupled with a reel system 919 to control a position of the deployment apparatus 910, and control the inspection vehicle or ROV 52 with the tether 912.

Referring now to FIG. 59A, an embodiment of a deployment apparatus 910 is shown in cross-sectional form. The deployment apparatus 910 can include a resting fixture 920 configured to engage the top wall 906 of the housing 902. The mount 922, in any of the disclosed embodiments, can be permanently attached or removably coupled to the housing 902 via any number of known mechanical fastening methods or means. A mount 922 extends from the resting fixture 920 and connects with an extendable telescopic arm 924 to provide rotation capability to the arm 924. In some forms, the mount 922 is rotatable relative to the housing 902. The tether 912 extends and retracts from the reel system 919 (see FIG. 58) under electronic control through the control system 918, or in an alternate form through manual control means such as a hand crank system (not shown). The tether 912 passes through the access port 908 and slidably engages with the extendable telescopic arm 924 along one or more guide pulleys 926 or similar structure in which the tether 912 can slidingly engage. The tether 912 is operable to provide electrical, mechanical, and/or pneumatic connections with the inspection vehicle or ROV 52 to provide control and communication capability between the control system 918 and the inspection vehicle or ROV 52.

Referring now to FIG. 59B, the extendable telescopic arm 924 can include a plurality of leg segments and in one exemplary embodiment, the telescopic arm 924 includes two leg segments. The telescopic arm 924 can include a first leg segment 928 and a second leg segment 930; however, it should be understood that more than two telescopic leg segments can be utilized in other embodiments. As one skilled in the art would understand, while not shown, the telescopic arm 924, as well as other extendable arms described herein, can include actuators, motors, cables, pulleys, biasing members such as springs or the like and other mechanical and electrical apparatus to facilitate movement and positioning of the extendable deployment arm. The rotatable mount 922 is operable for rotating the extendable telescopic arm 924 about an axis A relative to housing 902. Operation of the rotatable mount 927 can be through electrical actuation or through manual actuation, as one skilled in the art would readily understand.

The extendable telescopic arm 924 is shown in phantom at first and second alternate locations labeled 924a and 924b on either side thereof. The angles of rotation denoted by doubles arrows 932 and 934 can be varied as desired anywhere from up to 360° depending on location of the rotatable mount 922 relative to the sidewalls 905 of the housing 902. The extendable telescopic arm 924 can be extended and retracted as required to locate the tether 912 and the inspection vehicle or ROV 52 in a desired position during deployment, retraction and operation of the inspection vehicle or ROV 52 during inspection or maintenance procedures.

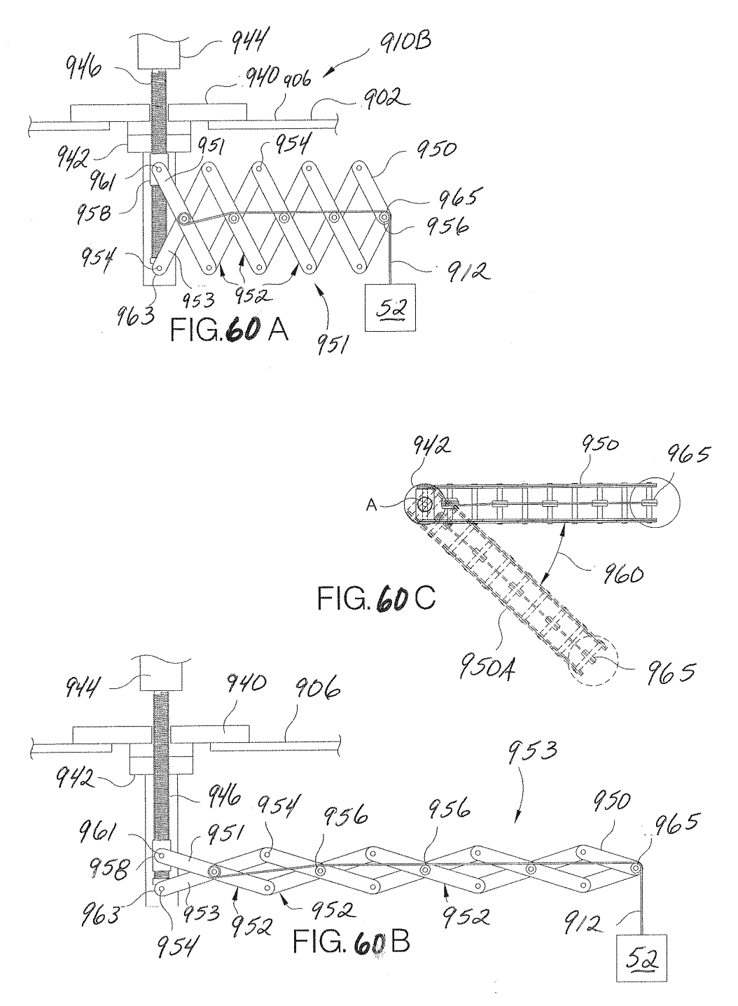

Referring now to FIG. 60A, another embodiment of a deployment apparatus 910B is illustrated in a side cross-sectional view. The deployment apparatus 910B can include a resting fixture 940 configured to engage with the top wall 906 of the housing 902 with a mount 942 extending therefrom. In some forms, the mount 942 is rotatable relative to the housing 902. An actuator 944 such as a linear actuator or a rotatable actuator having an electric power source can be engaged with an actuator rod 946 at one end thereof. The actuator rod 946 can be a linear sliding rod or a rotatable threaded rod (lead screw) depending on the type of actuator control.

An extendable scissor jack arm 950 is operably connected to the actuator rod or lead screw 946 at the other end, opposite of the actuator 944. The actuator 944 is configured to extend or retract the scissor jack arm 950 between first and second positions defined as fully retracted and fully extended. In one form the actuator 944 can slide an actuator rod 946 up and down in a vertical direction, and in another form the actuator in the form of an electric motor 944 can rotate a lead screw 946 so as to move first and second ends 961, 963 of pivot links relative to one another, which cause the extendable scissor jack arm 950 to extend or retract. While the exemplary embodiment depicts the actuator rod 946 in a vertical orientation, it should be understood that the actuator rod 946 can be positioned in any orientation and in fact is not limited to a single unitary section, but can include multiple sections with gears, joints or other mechanical apparatus connected therebetween.

The extendable scissor jack arm 950 includes a plurality of pivot links 952 connected together by pivot joints 954 so that each of the links 952 are pivotable with respect to adjacent links 952. The extendable scissor jack arm 950 can also include one or more guide pulleys 956. In some forms, the guide pulleys 956 can include portions that act as a pivot joint between adjacent links 952. The tether 912 can slidingly engage with the one or more guide pulleys 956 while deploying or retracting the inspection vehicle or ROV 52 to and from the housing 902.

A prismatic joint 958 can be operably employed by threaded connection with the lead screw 946 at an end of one of the pivot links 952. The prismatic joint 958 causes a first end 961 of a first pivot link 951 of the plurality of pivot links 952 and a first end 963 of a second pivot link 953 of the plurality of pivot links 952 to move together or apart when commanded so as to cause the extendable scissor jack arm 950 to extend and retract in response to the actuator movement. A distal end 965 of the extendable scissor jack arm 950 is shown in a retracted state as illustrated by arrow 951 in FIG. 60A.

Now referring to FIG. 60B the extendable scissor jack arm 950 is extended in a second fully extended position as illustrated by arrow 953. The prismatic joint 958 at the first end 961 of the first pivot link 951 is moved closer to the first end 963 of the second pivot link 953. The ends 961, 963 of the pivot links 951 and 953 are moved from the first distance shown in FIG. 60A to a second closer distance shown in FIG. 60B such that each of the pivot links 952 pivot in a manner to cause the distal end 965 of extendable scissor jack arm 950 to extend a further distance away from the actuator rod 946. The distal end 965 of the scissor jack arm 950 can be moved to any discrete location between the fully retracted position and the fully extended position.

Referring now to FIG. 60C the extendable scissor jack arm is shown in a first angular location in solid line 950 in a second angular location in phantom line at 950A. The scissor jack arm 950 can be rotatably moved about axis A as defined by angle 960. The rotatable mount 942 is operable for rotating the extendable scissor jack arm 950 about axis A to position the distal end 965 at a desired angular position relative to the housing 902. The rotation angle 960 of the extendable arm 950 can be any angle up to 360°.

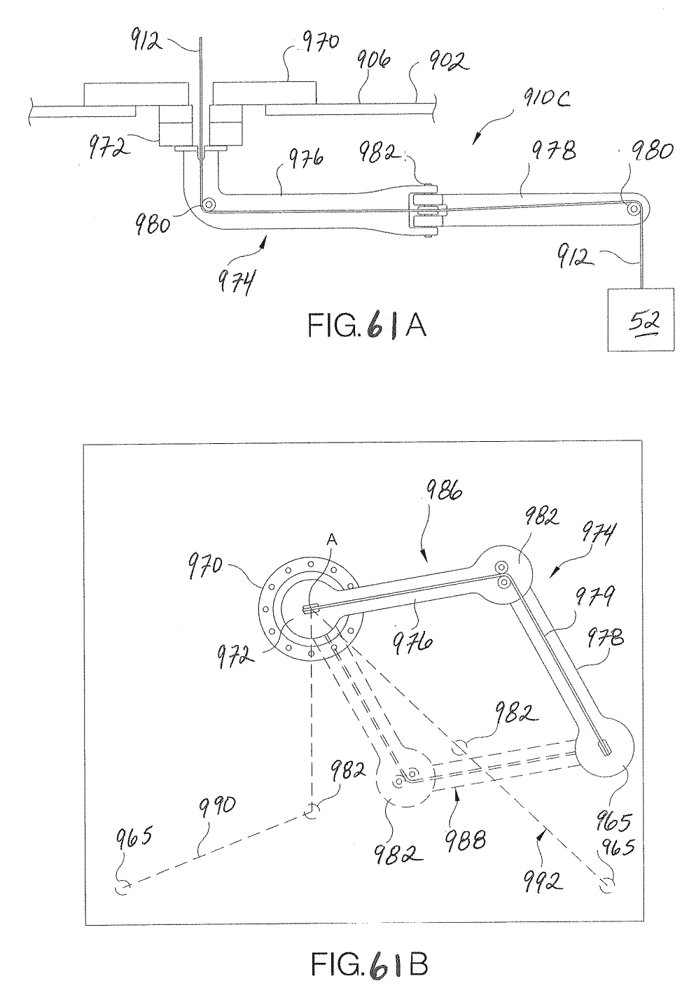

Referring now to FIG. 61A another embodiment of a deployment apparatus 910C is shown cross-sectional form. The deployment apparatus 910C includes a resting fixture 970 operable for engaging a wall 906 of a housing 902 at least partially filled with liquid (not shown). A mount such as a rotatable mount 972 extends from the resting fixture 970 and can rotatably connect to an extendable articulated arm 974. The extendable articulated arm 974 includes a first leg segment 976 and a second leg segment 978 in the disclosed exemplary embodiment. However, as with previously described embodiments it should be understood that more than two leg segments are contemplated by the present disclosure and in fact can be used without deviating from the teachings herein. The tether 912 can be engaged with one or more guide pulleys 980 to slide relative thereto when deploying and retracting the inspection vehicle or ROV 52 into and out of liquid filled housing (not shown). The extendable articulated arm 974 can include a pivot joint 982 such that the first and second leg segments 976, 978 can be pivoted relative to each other. In one form, the pivot joint 982 is a two dimensional pivot joint, however in other forms the pivot joint can include a three dimensional or spherical joint which permits adjacent leg segments to move in any angular direction relative to one another. It should be understood that although not shown, electric motors, actuators, cables, gears and other mechanical and electrical apparatus can be employed to cause movement of the leg segments 976, 978.

Referring now to FIG. 61B the extendable articulated arm 974 is shown in various orientations to illustrate some of the possible arm positions. The rotatable mount 972 is movable relative to the resting fixture 970 such that the first leg segment 976 is pivotable about axis A within the housing 902. The second leg segment 978 can be rotated or pivoted relative to the first leg segment 976 either via a cable system 979 as one skilled in the art would readily understand, or separate actuators (not shown) operably coupled to one or more pivot joints 982. The first orientation 986 of the extendable articulated arm 974 is shown in solid line. A second orientation 988 of the extendable articulated arm 974 is shown in a dashed outline and illustrates that the distal end 965 of the extendable articulated arm 974 can be located in the same position even when the first and second leg segments 976 and 978 are positioned in different locations. A third orientation 990 is illustrated in dash lines and a fourth orientation 992 is shown in a fully extended configuration wherein the distal end 965 is furthest away from the pivotable mount 972. In this manner, the arms 976, 978 can be manipulated to maneuver around objects within the housing 902 and ensure that the inspection vehicle or ROV 52 can be deployed at a desired location.

One aspect of the present application includes an apparatus comprising a remotely operated submersible including an enclosed hull and having: an active ballast system having a pump, a pressure vessel reservoir, and an inflatable bladder, the pressure vessel reservoir in fluid communication with the inflatable bladder, the active ballast system further including a check valve fluidically disposed between the pressure vessel reservoir and the inflatable bladder, the check valve structured to permit egress of air from the enclosed hull and into the pressure vessel reservoir by action of the pump when the inflatable bladder is empty.

One feature of the present application further includes a liquid thruster used to propel and orient the remotely operated submersible, a control circuit structured to receive a command transmitted to the signal receiver, the control circuit operable to control a fluid flow of the liquid thruster.

A feature of the present application includes wherein the enclosed hull is a reclosable hull capable of being opened and closed.

Another feature of the present application includes wherein the reclosable hull includes a cover member that can be removed to permit ingress of outside air into the enclosed hull, and that can be replaced to discourage ingress of air into the enclosed hull, and which further includes a signal receiver structured to receive a command through a liquid environment from a remote control station, and wherein the remotely operated submersible is configured to inflate the inflatable bladder when the signal receiver fails to receive the command.

Still another feature of the present application further includes a valve fluidically disposed between the pressure vessel reservoir and the pump, the valve configured to be closed and discourage flow of fluid a when power is applied, and configured to be open and allow fluid to flow when power is not applied.

Yet another feature of the present application includes wherein the pump is configured to activate in an ON state when power is applied, and wherein when power is ON both the valve and the pump air is moved from the inflatable bladder to the pressure vessel reservoir.

Still yet another feature of the present application includes wherein power is OFF in both the valve and the pump air is moved via differential pressure from the pressure vessel reservoir to the inflatable bladder.

Yet still another feature of the present application includes wherein the pressure vessel reservoir is integral with a housing of the remotely operated submersible.

A further feature of the present application includes wherein the pressure vessel reservoir includes a plurality of internal baffles.

Another aspect of the present application includes an apparatus comprising a robotic drone structured to be operated beneath the surface and within a body of liquid, the robotic drone including a liquid propulsor for providing motive force to the drone, a recirculating air ballast system that includes an inflatable bladder structured to display fluid and act as a ballast for the robotic drone, and a lattice cage covering within which is situated the inflatable bladder, the cage including a plurality of cross members structured to permit the inflow and outflow of fluid displaced by inflation and deflation of the inflatable bladder.

A feature of the present application includes wherein the cross members of the lattice cage covering having a plurality of openings through which fluid flows during inflation and deflation of the inflatable bladder, the openings having a cross sectional area larger than the cross sectional air occupied by the plurality of cross members, such that blockage defined by the cross sectional area of the plurality of cross members divided by the cross sectional area of the openings is less than 1.

Another feature of the present application further includes a plurality of secondary cross members arranged transverse to the plurality of cross members.

Still another feature of the present application includes wherein the openings are rectilinear in shape, and which further includes a radio transmitter attached to the robotic drone and structured to broadcast a radiofrequency signal while the robotic drone is submerged in a liquid, and which further includes a plurality of cameras structured to capture images from the robotic drone.

Yet another feature of the present application includes wherein the robotic drone includes a reclosable hull that includes a gaseous filled interior and is structured to be hermetically sealed when closed.

Still yet another feature of the present application includes wherein the reclosable hull includes a removable cover which, when removed, exposes an interior of the reclosable hull to an outside air.

Yet still another feature of the present application further includes a pump in fluid communication with the inflatable bladder and a check valve placed between and in fluid communication with both the pump and inflatable bladder.

A further feature of the present application includes wherein the check valve draws air from the gaseous filled interior when the pump can no longer pull air from the inflatable bladder.

Still another aspect of the present application provides a method comprising propelling a submersible robotic drone through a liquid medium, the submersible robotic drone having an having an air filled interior compartment as well as a flexible ballast bladder in fluid communication via a conduit with a fluid reservoir, regulating a height of the submersible drone by inflating and deflating the flexible ballast bladder, operating a pump to remove air from the flexible ballast bladder and deliver the removed air to a pressure vessel, and while continuing to operate the pump and at a minimal amount of air in the flexible ballast bladder, opening a check valve via pressure action of the pump to draw air from the air filled interior compartment to reduce air pressure in the interior compartment.

A feature of the present application further includes opening the air filled interior compartment to an outside air source to service a component of the submersible robotic drone.

Another feature of the present application includes wherein the propelling includes moving the submersible robotic drone within a fluid of an electrical transformer tank, and which further includes transmitting a command signal from a base station to the submersible robotic drone to draw the air from the air filled interior compartment to the pressure vessel.

Still another feature of the present application further includes activating the pump to draw air from the air filled interior compartment.

Yet still another feature of the present application further includes removing a cover of the air filled interior compartment to expose the compartment to outside air, and wherein the air filled interior compartment is exposed to air drawn from the air filled compartment from action of the pump is correspondingly drawn from the outside air through an opening exposed by removal of the cover.

Still yet another feature of the present application includes wherein the submersible robotic drone further includes a check valve fluidically between the flexible ballast bladder and the fluid reservoir.

A further feature of the present application includes wherein the flexible ballast bladder and fluid reservoir are part of a recirculating air ballast system.

One aspect of the present application includes an apparatus comprising a liquid tank structured to enclose a working liquid within an interior of the tank, the tank including a port through which a robotic submersible can be inserted into the tank from an exterior position, the port coupled with a launching tube attached opposite the interior of the liquid tank, the launching container having an outside valve configured to be opened and closed, a launching chamber sized to receive the robotic submersible through the outside valve, and a tank-side valve placed opposite the launching chamber from the outside valve and structured to be open to permit ingress of the robotic submersible into the interior of the tank.

A feature of the present application further includes an air release passage in fluid communication with the launching chamber.

Another feature of the present application further includes an agitator structured to cause the release of air bubbles in a liquid medium within the launching chamber.

Still feature of the present application includes wherein in the launching tube is attached to the top of the tank, and which further includes a communication antenna.

Yet another feature of the present application includes wherein the launching tube is attached to a side of the tank, and which further includes a visual sensor.

Still yet another feature of the present application includes wherein the tank is an electrical transformer and the liquid is a transformer coolant.

Yet still another feature of the present application includes wherein the launching tube is portable and is releasably attached to the liquid tank such that it can be moved to another liquid tank for inspection.

A further feature of the present application includes wherein the port further includes a cover that can be moved out of the way during launch operations and can be replaced to permit disengagement of the launching container from the tank.

Another aspect of the present application includes an apparatus comprising a modular dispensing tube having a top side valve, a launching chamber sized to accommodate a robotic drone inserted through the top side valve, and a bottom side valve structured to release the remotely operated vehicle from the launching chamber, the modular dispensing tube also including an air release passageway in fluid communication with the launching chamber and having a purge valve structured to have an open position in which the air release passage allows air to escape from the launching chamber during a pre-launch liquid fill event, the purge valve also structured to have a closed position to discourage the escape of liquid from the launching chamber, wherein the modular dispensing tube is configured as a portable dispensing tube having a connection surface structured to releasably engage with a liquid fluid tank to insert the robotic drone into the liquid fluid tank, and to be disengaged to permit portable movement of the dispensing tube to be used on another liquid fluid tank.

A feature of the present application further includes an agitator structured to remove bubbles from the contents of the launching chamber.

Another feature of the present application includes wherein the agitator is a vibrator structured to induce vibrations in the contents of the launching chamber.

Still another feature of the present application includes wherein the agitator is a fluid moving device structured to induce a flow of fluid within the launching chamber.

Yet another feature of the present application includes wherein the connection surface includes a plurality of registration surfaces.

Still yet another feature of the present application includes wherein the connection surface includes a plurality of apertures though which a plurality of fasteners are inserted.

Yet still another feature of the present application includes wherein the connection surface is complementary to a connection pad of a liquid tank to which the connection surface is mated.

A further feature of the present application further includes the liquid tank, wherein the liquid tank is an electrical transformer tank, and which a mating connection between the connection surface of the modular dispensing tube and the connection pad of the transformer tank includes a provision for the receipt of a gasket.

Yet a further feature of the present application includes wherein the modular dispensing tube further includes at least one of a communication antenna and a visual sensor.

Still another aspect of the present application includes a method comprising attaching a portable launching tube to a surface of a liquid tank, inserting a submersible vehicle into the portable launching tube, closing an outside valve to isolate the submersible within the launching tube, venting air through an air release passage as liquid from the liquid tank fills into the portable launching tube, opening a launch valve to place the liquid inside the launching tube in communication with liquid inside the liquid tank, launching the submersible vehicle, and removing the portable launching tube from the liquid tank.

A feature of the present application further includes recovering the submersible vehicle into the launching tube.

Another feature of the present application further includes draining liquid from within the launching tube before removing the portable launching tube from the liquid tank.

Still another feature of the present application further includes agitating the contents of the launching tube before opening the launch valve to remove air bubbles.

Yet still another feature of the present application further includes venting the agitated air bubbles through the air release passage.

Still yet another feature of the present application includes wherein the liquid tank is an electrical transformer, and which further includes communicating with a remote device via an antenna attached to the launching tube.

Yet still another feature of the present application further includes capturing target information via a visual sensor.

One aspect of the present application provides an apparatus comprising a remotely operated submersible having: a liquid thruster used to propel and orient the remotely operated submersible, a signal receiver structured to receive commands through a liquid environment from a remote control station, a control circuit structured to receive a command transmitted to the signal receiver, the control circuit operable to control a fluid flow of the liquid thruster, a plurality of cameras each structured to capture a scene of electromagnetic energy, an input/output selector circuit for selecting the scenes of electromagnetic energy and composing a signal to be transmitted; and a signal transmitter structured to transmit the signal composed by the input/output selector circuit related to the scene of electromagnetic energy, the signal transmitter adapted to transmit information through a liquid environment while the remotely operated submersible is submerged with enough power to permit satisfactory reception at a receiving antenna.

A further aspect of the present application includes an apparatus comprising: a remotely operated submersible having a signal receiver structured to receive a command through a liquid environment from a remote control station, a plurality of cameras or sensors each structured to capture a target, an input/output selector circuit for selecting the captured targets and composing a signal to be transmitted, and a signal transmitter structured to transmit the signal composed by the input/output selector circuit related to the captured targets, the signal transmitter adapted to transmit information through a liquid environment while the remotely operated submersible is submerged with enough power to permit satisfactory reception at a receiving antenna.

A still further aspect of the present application includes an apparatus comprising a remotely operated submersible having: a signal receiver structured to receive a command through a liquid environment from a remote control station, a plurality of cameras each structured to capture a target, an input/output selector circuit for selecting the captured targets and composing a signal to be transmitted, and a signal transmitter structured to transmit the signal composed by the input/output selector circuit related to the captured targets, the signal transmitter adapted to transmit information through a liquid environment while the remotely operated submersible is submerged with enough power to permit satisfactory reception at a receiving antenna.

A feature of the present application provides wherein the signal receiver is a radio receiver, and wherein the signal transmitter is structured to provide radiofrequency transmissions.

Another feature of the present application provides wherein the radio receiver is structured to receive radio-frequency transmissions in a band between 300 MHz and 5 GHz.

Yet another feature of the present application provides wherein the signal receiver and the signal transmitter are included in a transceiver.

A further feature of the present application includes wherein the signal receiver and the signal transmitter are included in a transceiver, and which further includes a liquid thruster used to propel and orient the remotely operated submersible as well as a control circuit structured to receive a command transmitted to the signal receiver, the control circuit operable to control a fluid flow of the liquid thruster.

Still another feature of the present application provides wherein the liquid environment in which the signal transmitter is structured to transmit is an organic polymer liquid.

Yet still another feature of the present application provides wherein the input/output selector circuit is a signal switch structured to select an individual one of the plurality of cameras to form the signal to be transmitted.

Still yet another feature of the present application provides wherein the remotely operated submersible further includes a sensor capable of detecting a state of the remotely operated submersible.

A further feature of the present application provides wherein the signal to be transmitted includes information from the sensor and information related to the captured target in its transmission by the signal transmitter.

A still further feature of the present application includes a base station having a signal receiver complementary to the signal transmitter of the remotely operated submersible, and a signal transmitter complementary to the signal receiver of the remotely operated submersible, and wherein the remotely operated submersible is structured to operate in a tank that includes an electrical transformer submerged in the organic polymer liquid.

Yet a still further feature of the present application includes where the tank includes an electrical transformer submerged in the organic polymer liquid.

Another aspect of the present application provides an apparatus comprising a robotic drone structured to be operated beneath the surface and within a body of liquid, the robotic drone including a liquid propulsor for providing motive force to the drone, a radio transceiver structured to operate within the liquid for receiving commands and broadcasting data, a radio transmitter structured to broadcast a radiofrequency signal while the robotic drone is submerged in a liquid, a plurality of cameras structured to capture images from the robotic drone, an input/output selector circuit that can select which of the plurality of cameras to capture and broadcast via the radio transmitter.

A still further aspect of the present application includes an apparatus comprising a robotic drone structured to be operated beneath the surface and within a body of liquid, a radio transceiver structured to operate within the liquid for receiving commands and broadcasting data, a radio transmitter structured to broadcast a radiofrequency signal while the robotic drone is submerged in a liquid, a plurality of cameras structured to capture images from the robotic drone, an input/output selector circuit that can select which of the plurality of cameras to capture and broadcast via the radio transmitter.

A feature of the present application provides wherein the liquid is a dielectric liquid, and wherein the liquid propulsor is structure to operate in an electrical transformer coolant in the form of the dielectric liquid.

An additional feature of the present application provides wherein the liquid is a dielectric liquid, and wherein the liquid propulsor is structure to operate in tank filled with the dielectric liquid.

A further additional feature of the present application provides wherein the dielectric liquid is an electrical transformer coolant, and wherein the tank is an electrical transformer.

Another feature of the present application provides wherein the liquid propulsor is structured to provide propulsive power to the robotic drone by accelerating the dielectric liquid.

Still another feature of the present application provides wherein the radio transmitter is structured to provide a digital transmission formatted according to an internet protocol (IP) standard.

Yet another feature of the present application provides wherein the digital transmission is WiFi/WLAN.

Still yet another feature of the present application provides wherein the robotic drone is structured to broadcast a moving image with an overlay of drone data, and wherein the drone data overlay can include any one of a system parameter and sensor measurement.

Yet still another feature of the present application provides wherein the input/output selector circuit is a multiplexer structured to combine the images from the plurality of cameras for transmission to form the signal to be transmitted, and which further includes a liquid propulsor for providing motive force to the drone.

A further feature of the present application includes a base station configured to include a base station receiver, the base station receiver structured to receive the radiofrequency signal broadcast from the radio transmitter.

A still further feature of the present application provides wherein the base station displays video from one of the plurality of cameras without the need of a demultiplexer.

Still another aspect of the present application includes a method comprising: opening a transformer tank which includes an electrical transformer submerged in a transformer liquid coolant within the tank, inserting a submersible robotic drone into the interior of the transformer tank, propelling the submersible robotic drone through a transformer liquid coolant in the transformer tank to inspect the electrical transformer, operating a plurality of cameras situated within the transformer tank as a result of placement by the submersible robotic drone, selecting a target camera from the plurality of cameras for transmission to a base station, the selecting accomplished via an input/output signal selector, and wirelessly transmitting information of the target camera provided via the input/output signal selector.

Yet still another aspect of the present application includes a method comprising: opening a tank which includes an object of inspection submerged in a liquid within the tank, inserting a submersible robotic drone into the interior of the tank, propelling the submersible robotic drone through a liquid in the tank to inspect the object of inspection, operating a plurality of cameras situated within the tank as a result of placement by the submersible robotic drone, selecting a target camera from the plurality of cameras for transmission to a base station, the selecting accomplished via an input/output signal selector, and wirelessly transmitting information of the target camera provided via the input/output signal selector.

One feature of the present application includes wherein the tank is a transformer tank, the object of inspection is an electrical transformer, and the liquid is a transformer liquid coolant.

A feature of the present application provides wherein the input/output selector is a switch, and which further includes switching between the plurality of cameras for transmission by a wireless transmitter.

Another feature of the present application provides wherein the switching is controlled by an operator at a base station.

Still another feature of the present application provides wherein the switching is accomplished by a multiplexer.

Yet another feature of the present application provides wherein the wirelessly transmitting includes broadcasting a radiofrequency signal from a wireless transmitter.

Yet still another feature of the present application further includes formatting the radiofrequency signal according to a WiFi standard.

Still yet another feature of the present application further includes receiving information related to the radiofrequency signal at a base station, and displaying an image from the target camera on a display.

One aspect of the present application includes an apparatus comprising a remotely operated submersible having: a first signal receiver structured to receive a first control transmission through a liquid environment from a remote control station, the first control transmission including a command and a heartbeat, a second signal receiver structured to receive a second control transmission through a liquid environment from a remote control station, the second control transmission including a command and a heartbeat, and a controller structured to use the command from the first signal receiver or the command from the second signal receiver to manipulate a system on the remotely operated submersible, the controller having a control circuit structured to use the command from the first signal receiver upon receipt of the heartbeat from the first control transmission and use the command from the second signal receiver upon receipt of the heartbeat from the second control transmission when the heartbeat from the first control transmission is no longer received.

A feature of the present application includes wherein the second signal receiver is a WiFi radio, and wherein the WiFi radio is structured to transmit image information to a base station.

Another feature of the present application includes wherein the image information is a moving image.

Still another feature of the present application further includes a third control receiver structured to receive a third control transmission through a liquid environment from the remote control station.

Yet another feature of the present application includes wherein the third control receiver is a spread spectrum radio.

Still yet another feature of the present application includes wherein the control circuit is further structured to use a command from the third signal receiver when the heartbeat from the first control transmission and the heartbeat from the second control transmission is no longer received.

Yet still another feature of the present application includes wherein the spread spectrum radio is a firmware only radio, and wherein the remotely operated submersible is configured to concurrently monitor the first control receiver, second control receiver, and the third control receiver.

Another aspect of the present application includes an apparatus comprising a robotic drone structured to be operated beneath the surface and within a body of liquid, at least two radio receivers structured to operate within the liquid and for receiving commands from a base station where the commands are used to effectuate an action of the robotic drone, a first radio receiver structured to receive a first command and the second radio receiver structured to receive a second command redundant to the first command, and a control circuit that uses the second command when the first command is determined to be invalid.

A feature of the present application includes wherein the first command is determined to be invalid when a heartbeat is no longer received from the first radio receiver.

Another feature of the present application includes wherein the second radio receiver is a WiFi radio structured to transmit outbound video images.

Still another feature of the present application further includes a third radio receiver structured to operate within the liquid and for receiving commands from a base station where the commands are used to effectuate an action of the robotic drone, the third radio receiver structured to receive a third command.

Yet another feature of the present application includes wherein the robotic drone is configured to concurrently monitor the first radio receiver, second radio receiver, and the third radio receiver.

Still yet another feature of the present application includes wherein the third command is redundant to the first command and to the second command, and wherein the control circuit further uses the third command when the first command is determined to be invalid.

Yet still another feature of the present application includes wherein the third radio receiver is a firmware radio, and wherein the control circuit of the first and second command is performed in an electronic circuit that carries out instructions of a computer program, and wherein the control circuit further extends to a hardware based evaluation of a heartbeat received from the third radio receiver.

Still another aspect of the present application includes a method comprising operating a remotely operated submersible in an interior of a transformer tank, receiving a first signal in the remotely operated submersible, the first signal including a first command and a first heartbeat, receiving a second signal in the remotely operated submersible, the second signal including a first command and a first heartbeat, using the first command to effectuate an action of the remotely operated submersible, wherein the first command is the same as the second command, and at a subsequent time to the using the first command, and upon failure to receive the first heartbeat, using the second command to effectuate an action of the remotely operated submersible.

A feature of the present application further includes receiving a third signal in the remotely operated submersible, the third signal including a third command and a third heartbeat.

Another feature of the present application includes wherein the receiving a first signal, receiving a second signal, and receiving a third signal, occur concurrent with one another.

Still another feature of the present application includes wherein the second signal is a signal sent via WiFi radio, and wherein the third signal is a spread spectrum signal.

Yet another feature of the present application further includes subsequent time to the using the second command, and upon failure to receive the second heartbeat, using the third command to effectuate an action of the remotely operated submersible.

Still yet another feature of the present application includes upon failure to receive the first heartbeat, the second heartbeat, and the third heartbeat, activating an emergency ascent protocol to decrease the depth of the remotely operated submersible.

Yet still another feature of the present application includes wherein the activating includes energizing a recirculating ballast system.

Embodiments of the present invention include an inspection system for inspecting a machine, comprising: an inspection vehicle constructed for wireless operation while submersed in a dielectric liquid medium, wherein the inspection vehicle is self-propelled; a controller operative to direct activities of the inspection vehicle; and a plurality of status interrogation systems disposed on the inspection vehicle, wherein the plurality of status interrogation systems are operative to capture inspection data regarding a plurality of inspection procedures performed on the machine.

In a refinement, the inspection system further comprises a base station, wherein the controller is coupled to at least one of the status interrogation systems and operative to wirelessly transmit the captured data to the base station.

In another refinement, the plurality of status interrogation systems includes an ultrasound sensor operative to measure a thickness.

In yet another refinement, the plurality of status interrogation systems includes a microphone operative to sense sound waves associated with a partial discharge.

In still another refinement, the microphone is a plurality of microphones.

In yet still another refinement, the controller is coupled to the plurality of microphones; and the controller is operative to triangulate a location of the partial discharge; or the system further comprises a base station, wherein the controller is operative to wirelessly transmit captured data to the base station, and wherein the base station is operative to triangulate the location of the partial discharge.

In a further refinement, the plurality of status interrogation systems includes a magnetometer operative to quantify a magnetic field of the machine.

In a yet further refinement, the magnetometer is a multiaxis magnetometer.

In a still further refinement, the plurality of status interrogation systems includes an aliquot collection system operative to collect aliquot samples of the dielectric liquid medium.

In a yet still further refinement, the plurality of status interrogation systems includes a mechanical sampling system operative to mechanically obtain samples within the machine.

In another further refinement, the plurality of status interrogation systems includes a chemical sensor operative to sense contaminants in the dielectric liquid medium.

In yet another further refinement, the plurality of status interrogation systems includes an infrared sensor operative to sense a temperature.

In still another further refinement, the controller is a part of the inspection vehicle and operative to autonomously operate the inspection vehicle and/or the plurality of status interrogation systems.

In yet still another further refinement, the inspection system further comprises a base station operative to wirelessly direct the activities of the inspection vehicle, wherein the controller is a part of the base station.

Embodiments of the present invention include a method for performing an inspection of a machine, comprising: providing a plurality of status interrogation systems on an inspection vehicle, wherein the plurality of status interrogation systems are operative to capture inspection data regarding a plurality of inspection procedures to be performed on the machine; immersing the inspection vehicle within a dielectric liquid medium inside a housing of the machine; operating a base station to wirelessly direct a maneuvering of the inspection vehicle within the machine and to wirelessly direct the plurality of inspection procedures of the inspection vehicle using the plurality of status interrogation systems while immersed within the dielectric medium.

In a refinement, the plurality of status interrogation systems includes an ultrasound sensor, further comprising measuring a thickness while the inspection vehicle is immersed within the dielectric liquid medium using the ultrasound sensor.

In another refinement, the plurality of status interrogation systems includes a microphone operative to sense sound waves associated with a partial discharge event, further comprising further comprising determining a location of a partial discharge event within the housing using the microphone while the inspection vehicle is immersed within the dielectric liquid medium.

In yet another refinement, the plurality of status interrogation systems includes a magnetometer, further comprising sensing a magnetic field strength in the machine using the magnetometer while the inspection vehicle is immersed within the dielectric liquid medium.

In still another refinement, the plurality of status interrogation systems includes at least one of: an aliquot collection system operative to collect aliquot samples of the medium while the inspection vehicle is immersed in the dielectric liquid medium; and a mechanical sampling system operative to mechanically collect samples within the machine while the inspection vehicle is immersed within the dielectric liquid medium.

In yet still another refinement, the plurality of status interrogation systems includes a chemical sensor, further comprising sensing for contaminants in the dielectric liquid medium using the chemical sensor while the inspection vehicle is immersed within the dielectric liquid medium.

In a further refinement, the plurality of status interrogation systems includes an infrared thermometry sensor, further comprising sensing a temperature using the infrared thermometry sensor while the inspection vehicle is immersed within the dielectric liquid medium.

Embodiments of the present invention include an inspection system for inspecting a machine, comprising: an inspection vehicle constructed for operation while submersed within a dielectric liquid medium, wherein the inspection vehicle is self-propelled; a base station operative to direct activities of the inspection vehicle; means for communicating between the base station and the inspection vehicle; and a plurality of means for interrogating the status of the machine, wherein the means for interrogating are disposed on the inspection vehicle.

In one aspect the present disclosure includes an inspection system comprising: an inspection vehicle operable in an enclosed liquid medium with components located therein; at least one sensor operably coupled with the inspection vehicle; a control system including an electronic controller operably coupled with the inspection vehicle, the control system configured to display data transmitted from the sensor and display input data from an operator on one or more display devices in real time.

In refining aspects the inspection system includes input data from the operator including a plurality of input modes; wherein the input modes includes at least one of a voice input, a manual input and a location input; wherein the controller ties input from the operator to corresponding sensor data such that the operator input and corresponding sensor data input is retrievable together by the control system; wherein the sensor data and the operator input data are stored to a memory associated with the control system; wherein the controller defines and displays an inspection task list during operation of the inspection vehicle; wherein the controller is configured to automatically generate an inspection chart during operation of the inspection vehicle; wherein the inspection chart includes at least one of a field inspection item and an associated inspection location; wherein the controller records inspection data transmitted from the inspection vehicle for a first field item listed in the inspection chart; wherein the controller is operable to move the inspection vehicle to a second inspection location after completion of inspection and recordation of data at a first inspection location defined by the inspection chart; wherein the controller populates a second field item in the inspection chart; wherein the operator input includes an input of a certainty level of an inspection result; wherein the controller is operable to retrieve inspection and repair history of a component and determine additional field items to inspect based on the repair history; wherein the control system is operable to retrieve and display data from one or more previous inspection events and overlay the previous inspection data with data obtained in a current inspection event; wherein the operator is located remotely from the inspection location; and wherein the control system is operable to overlay display data transmitted from the sensor and display input data from an operator.

Another aspect of the present disclosure includes a method for inspecting components within a housing at least partially filled with a liquid, the method comprising: moving an inspection vehicle to a first location within the housing; sensing a field inspection item associated with a component at the first location; transmitting data obtained during the sensing event to a control system; displaying a portion of the transmitted data on a display unit; displaying input data provided by an operator with the transmitted data on one or more display units.

In refining aspects, the overlaying of the input data occurs in real time as the inspection vehicle is in operation; wherein input data from the operator includes at least one of a voice input, a manual input and a location input; comprising tying the input from the operator to corresponding sensor data and storing each together in a memory device; comprising displaying an inspection task list during operation of the inspection vehicle; comprising automatically generating an inspection chart during operation of the inspection vehicle; comprising inspecting at least one field item associated with the inspection chart; comprising recording inspection data transmitted from the inspection vehicle for a first field item listed in the inspection chart; comprising moving the inspection vehicle to a second inspection location after recording data at a first inspection location; comprising populating a second field item in the inspection chart; comprising inputting a certainty level of an inspection result; comprising analyzing inspection and repair history of a component and generating additional field items to inspect based on the analyzing; comprising displaying an inspection check list for the additional field items; comprising retrieving and displaying data from one or more previous inspection events and overlaying the display with data obtained in a current inspection event; further comprising transmitting inspection data to an expert at a remote location for analysis; and further comprising overlaying input data provided by an operator with the transmitted data.

Another aspect of the present disclosure a method comprising: moving a submersible inspection vehicle to a first inspection area; transmitting one or more of a voice input, a location input or a manual input to a control system from the operator; generating an inspection task list for the submersible inspection vehicle based at least partially on the input from an operator; displaying an inspection chart for a first field item associated with the task list; and sensing and recording inspection data for the first field item.

In refining aspects, the present disclosure further comprising: populating the inspection task list with a second field item on the inspection chart after completing inspection of the first field item; adding a voice over input, a location input and/or a manual input to the inspection data; moving the inspection vehicle to a second inspection area after completing inspection tasks at the first inspection area; wherein the input includes a voice or type overlay to characterize a certainty level of the inspection results; comprising: analyzing inspection and repairing history of a component; determining additional field items to inspect based on analysis of the inspection and repair history; and further comprising displaying inspection images and data from previous inspections along with data from a current inspection.

One aspect of the present application includes a method comprising viewing an object with a plurality of cameras on a submersible immersed in a liquid to form a series of images, estimating a pose of an object in the images, performing a bundle adjustment on features of the object in the images, computing depth-maps based on the series of images to form a 3D dense reconstruction, creating a point cloud upon fusing individual depth-maps from the computing depth-maps, converting the point could to a mesh to form a model, and rectifying the model with pre-existing data of the object.

A feature of the present application includes wherein the viewing the object is performed beneath the surface of a liquid.

Another feature of the present application further includes recording a pose orientation of the submersible along with images taken at the pose orientation.

Still another feature of the present application includes wherein the rectifying is performed with a CAD model.

Yet another feature of the present application includes wherein the rectifying is performed with a model of the object from a prior inspection that included the viewing, estimating, performing, computing, creating, and converting.

Still yet another feature of the present application further includes introducing at least one of a texture and an annotation to the model.

Yet still another feature of the present application includes wherein the bundle adjustment is performed in each camera to generate sparse maps from each camera.

A further feature of the present application includes wherein the converting also includes projecting a local neighborhood of a point along the point's normal, and connecting unconnected points.

A still further feature of the present application includes wherein the converting is performed without telemetry.

Another aspect of the present application includes an apparatus comprising a vision based modelling system for generating a model of a submerged object of interest located in a working liquid, the vision based modelling system structured to: capture a set of images from a plurality of cameras mounted on a submersible vehicle, estimate a pose of an object in the set of images, perform a bundle adjustment on features of the object in the images, create a point cloud upon fusing individual depth-maps based from the set of images, convert the point could to a mesh to form a model, and rectify the model with pre-existing data of the object.

A feature of the present application includes wherein the vision based modelling system structured to compute depth-maps based on the series of images to form a 3D dense reconstruction.

Another feature of the present application further includes a computer having a computer readable memory, the vision based modelling system expressed as a programming instruction and stored in the computer readable memory.

Still another feature of the present application includes wherein the vision based modelling system is hosted in a distributed computing environment having at least two computers.

Yet another feature of the present application includes wherein the pre-existing data is a prior model of the object from a previous inspection that produced the prior model using the vision based modelling system.

Still yet another feature of the present application includes wherein the vision based modelling system is further structured to introduce at least one of a texture and an annotation to the model, and wherein the bundle adjustment is performed on images from each camera to generate sparse maps of the images from each camera.

Yet still another feature of the present application includes wherein the vision based modelling system is further structured to project a local neighborhood of a point along the point's normal, and connecting unconnected points; and which further includes a submersible vehicle having a plurality of cameras, and wherein the vision based modelling system is further structured to store a pose orientation of the submersible vehicle with image frames taken at the pose orientation.

Still another aspect of the present application includes an apparatus comprising: a first computer structured to receive images of an object as viewed through a liquid from a plurality of cameras on board a submersible vehicle, and a vision based modelling system configured to execute a 2D tracker module, a 3D sparse reconstruction module that utilizes bundle adjustment, a 3D dense reconstruction module to provide a point cloud, a model generation module which converts the point cloud to a mesh, and an image rectification module utilizing stored information about the object to rectify images taken in a liquid medium with the stored information about the object, wherein the first computer is structured to execute at least one of the 2D tracker module, 3D sparse reconstruction module, 3D dense reconstruction module, model generation module, and image rectification module.

A feature of the present application further includes a tank containing a liquid, and a submersible vehicle that includes the plurality of cameras.

Another feature of the present application includes wherein the 2D tracker module includes the ability to determine a pose estimate of the object.

Still another feature of the present application includes wherein the 3D spare reconstruction module includes a routine to perform a global bundle adjustment with telemetry integration.

Yet another feature of the present application includes wherein the 3D dense reconstruction includes a routine to determine depth-maps using information from the 3D spare reconstruction.

Still yet another feature of the present application includes wherein the model generation module uses a point cloud developed from the 3D dense reconstruction module and converts the point cloud to a mesh.

Yet still another feature of the present application includes wherein the image rectification module uses a prior model to compare a vision-based model created from the model generation module.

A further feature of the present application includes wherein the prior model is a CAD model or a prior vision based model formed from the vision based modelling system.

One aspect of the present application includes an apparatus that comprises a remotely operable vehicle that is submersible. The remotely operable vehicle includes a signal receiver structured to receive a command through a liquid environment from a remote control station, a plurality of cameras fixed in position relative to one another with an overlapping field of view with each of the plurality of camera being operable to produce a video stream, and a transmitter configured to transmit the video streams to a processing device. The processing device is configured to process the video streams to output a three dimensional map based on the video streams.

In one embodiment, the processing device is a computer wirelessly connected to the remotely operable vehicle. In another embodiment, the processing device is included with a controller on the remotely operable vehicle.

In a further embodiment, the plurality of cameras are oriented on the remotely operable vehicle so the three dimensional map provides a quasi-spherical field of view.

In yet another embodiment, the processing device is configured to determine an observation position of the remotely operable vehicle in the liquid environment based on telemetry data from the remotely operable vehicle and a model of a structure that contains the liquid environment. In a further embodiment, the remotely operable vehicle includes a propulsion system with one or more motors.

In still another embodiment, the apparatus includes a base station having a signal receiver complementary to a signal transmitter of the remotely operable vehicle. The base station further includes a signal transmitter complementary to the signal receiver of the remotely operable vehicle. The remotely operable vehicle is structured to operate submerged in a tank that includes an electrical transformer submerged in an organic polymer liquid.

According to another aspect of the present application, an apparatus includes a remotely operable vehicle structured to be operated beneath the surface and within a body of liquid. The remotely operable vehicle includes a transmitter is structured to broadcast a signal with the remotely operable vehicle submerged in a liquid, and a plurality of cameras fixed in position relative to one another. Each of the plurality of cameras is structured to capture a video stream from the remotely operable vehicle within the liquid. A processor is configured to receive and process the video streams to determine an observation position of the remotely operable vehicle within the liquid and output a three dimensional field of view based on the video streams and the observation position.

In one embodiment, the processing device is at least one of a computer wirelessly connected to the remotely operable vehicle and a controller on the remotely operable vehicle. In another embodiment, the plurality of cameras are oriented on the remotely operable vehicle to provide a quasi-spherical field of view.

In yet another embodiment, the processing device is configured to determine the observation position of the remotely operable vehicle in the liquid environment based on telemetry data from the remotely operable vehicle and a model of a structure containing the liquid environment.

According to another aspect, a method includes: inserting a submersible, remotely operable vehicle into an interior of a transformer tank that includes an electrical transformer submerged in a liquid coolant; propelling the remotely operable vehicle through the liquid coolant in the transformer tank to inspect the electrical transformer; operating a plurality of cameras fixed on the remotely operable vehicle to produce video streams of the interior of the transformer tank; determining an observation position of the remotely operable vehicle based on telemetry data and a model of the electrical transformer; and processing the video streams from each of the plurality of cameras to output a three dimensional field of view of the interior of the transformer tank and the electrical transformer from the observation position of the remotely operable vehicle.

In one embodiment, the method includes updating the observation position and the three dimensional field of view in real time while the remotely operable vehicle is propelled through the liquid coolant.

In another embodiment, the method includes calibrating each of the plurality of cameras for operation in the liquid coolant before determining the observation position. In a refinement of this embodiment, calibrating each of the cameras includes first calibrating each of the plurality of cameras in air and then calibrating each of the plurality of cameras in the liquid coolant.

In yet another embodiment, the method includes filtering frames of each of the video streams from each of the plurality of cameras. In a further embodiment, determining the observation position includes referencing a pose of the remotely operable vehicle with respect to interior faces of the transformer tank.

In still another embodiment, the method includes mapping the electrical transformer based on the three dimensional field of view. In a further embodiment of the method, the plurality of cameras are arranged to provide a quasi-spherical three-dimensional field of view. In another embodiment, the method includes displaying the three dimensional field of view on a display.

In one aspect the present disclosure includes an inspection vehicle having a propulsion device operable in an enclosed tank at least partially filled with a liquid medium; at least one sensor operable with the inspection vehicle; a control system including an electronic controller in electronic communication with the inspection vehicle; and one or more maintenance tools operable with the inspection vehicle.

In refining aspects the one or more maintenance tools includes at least one of a suction pump, a grasping device, a cutting device, an impact device, a magnet, a welder and a rotary tool; wherein the suction pump is in fluid communication with an inlet port formed in a housing of the inspection vehicle; an outlet port formed in the housing of the inspection vehicle, the outlet port in fluid communication with the inlet port; wherein the suction pump is operable for drawing in a quantity of the liquid with entrained solid particulate through the inlet port and for discharging the liquid and solid particulate through the outlet port; further comprising a filter positioned proximate to the outlet port, the filter configured to trap solid particulate and permit liquid to flow therethrough; wherein the suction pump includes a rotatable impeller; wherein the impeller is operable to also provide a propelling thrust for the inspection vehicle within the liquid medium; wherein the one or more maintenance tools includes a repair apparatus; wherein the repair apparatus includes one or more injector nozzles coupled to the inspection vehicle; wherein the sensor transmits a location of a damaged component and the inspection vehicle is maneuvered to the location and the one or more injector nozzles eject a liquid repair compound onto the damaged component; wherein the repair compound is capable of curing in the liquid medium; wherein liquid medium includes one of a petroleum base mineral oil, a synthetic oil or other non-aqueous liquid; and wherein the liquid repair compound includes one of a two part acrylic paste, a UV hardening adhesive, a pre-impregnated fiberglass patch or a combination thereof; and wherein the repair apparatus is operable to repair a structural defect, an outer surface defect and/or an insulation layer defect.

In another aspect, the present disclosure includes a method for performing maintenance operations within a housing at least partially filled with a liquid, the method comprising: moving a liquid propelled inspection vehicle within the housing; sensing, with a sensor, a region within the housing that requires maintenance; and performing a maintenance procedure on the region with the inspection vehicle.

In refining aspects the maintenance procedure includes at least one of suction of liquid and solid particle debris into the inspection vehicle and discharging the solid particle debris into a filter, grasping and moving an object, cutting an object, threading or unthreading a threaded fastener, impacting an object, and welding; wherein the maintenance procedure includes repairing an outer surface and/or repairing a structural defect of a component within the housing; wherein the component is high tension coil and the outer surface is at least partially formed from an insulation material; wherein the repairing includes ejecting a liquid compound from the inspection vehicle onto the component; wherein the liquid compound includes one of a two part acrylic paste, a UV hardening adhesive or a pre-impregnated fiberglass patch; and further comprising curing the liquid compound with a light source.

In another aspect an inspection and maintenance system comprising: an inspection vehicle maneuverable within a housing at least partially filled with a liquid medium; a control system operable for locating an area requiring maintenance and/or repair; and one or more tools operably coupled with the inspection vehicle configured to perform a repair procedure and/or a maintenance procedure on a component surrounded by the liquid medium.

In refining aspects the inspection and maintenance wherein the one or more tools are configured for a vacuum system; wherein the vacuum system includes a suction pump in fluid communication with an inlet port and an outlet port formed in a housing of the inspection vehicle; wherein the vacuum system includes a filter in fluid communication with the inlet port; wherein the one or more tools are configured for a repair system; and wherein the repair system includes one or more injection nozzles coupled to the inspection vehicle, the one or more nozzles configured to eject a repair compound onto a damaged component; wherein the repair compound is formed to cure and harden in the liquid medium; and wherein the one or more tools include a grasping device, a cutting device, an impact device, a magnet, a welder and a rotary tool.

In one aspect the present disclosure includes an inspection system comprising: an inspection vehicle having a propulsion device operable in a liquid medium; at least one sensor operably coupled with the inspection vehicle; a control system including an electronic controller operably coupled with the inspection vehicle; a tether connected to the inspection vehicle; and a controllable buoyancy system operably coupled to the tether and the control system.

In refining aspects the controllable buoyancy system includes one or more floating bodies and buoyant elements connected to the tether; a gas conduit and an electrical conduit associated with the tether being connected to the one or more floating bodies and buoyant elements; wherein at least one of the floating bodies and the buoyant elements further comprise an inlet valve connected to the tether configured to ingress a flow of gas and/or liquid; an outlet valve connected to the tether configured to egress a flow of gas and/or liquid; a discharge exchange valve in fluid communication with the liquid medium in the housing configured to control a volume of gas and a volume of liquid within the floating bodies and the buoyant elements; a gas pump operably connected to the gas conduit wherein the controller transmits control commands to the gas pump and to the valves to define a buoyancy level of the floating bodies and the buoyancy elements such that the buoyancy level of the floating bodies and the buoyancy elements can be changed individually or together; wherein one or more floating bodies include a floating body propulsion system operable to generate directionally controlled thrust to the floating body in the liquid medium such that the floating bodies can be controlled individually or together; wherein a reel connected to the tether, the reel being operable to deploy and retract the tether into/from the liquid medium; the reel includes at least one of manual control means and an electrically controlled means; wherein a tether cleaning device operable to remove a portion of the liquid medium from the tether during retraction; wherein the tether cleaning device includes a sponge or brush wiper; wherein the tether cleaning device includes a detergent cleaning device; and a remote control station operable to transmit and receive vehicle control signals through the tether.

In another aspect the present disclosure includes an a method for inspecting components within a housing at least partially filled with a liquid, the method comprising: connecting a tether to an inspection vehicle; deploying the inspection vehicle into the housing; moving the inspection vehicle within the housing with a liquid drive propulsion device; sensing a portion of the components with a sensor operably coupled to the inspection vehicle; and controlling movement of the tether with a controllable buoyancy system.

In refining aspects the controllable buoyancy system includes one or more floating bodies connected to the tether; adjusting a volume of gas and a volume of liquid within the one or more floating bodies to control a buoyancy level; adjusting includes controlling gas flow with one or more valves coupled to the one or more floating bodies; maneuvering the one or more floating bodies by way of a floating body propulsion system operable within the liquid; automatically controlling a location of a floating body based on a predetermined control algorithm; wherein the controllable buoyancy system includes one or more buoyant elements connected to the tether; controlling a buoyancy level of each of the one or more buoyant elements individually or together; deploying and retracting the tether from/onto a reel; wherein the deploying and retracting includes at least one of manual control means and an electrical control means cleaning the tether with a tether cleaning device; wherein the cleaning includes removing liquid from the tether with a sponge or a wiper coupled to the cleaning device; wherein the cleaning includes applying a detergent solution to the tether; controlling the tether buoyancy system and the inspection vehicle via a remote control station.

In another aspect, the present disclosure includes a tether system for a liquid propelled inspection vehicle comprising: a tether configured to connect a control system to the inspection vehicle; a controllable buoyancy system operably coupled to the tether.

In refining aspects the controllable buoyancy system includes one or more floating bodies connected to the tether; wherein the one or more floating bodies include a floating body propulsion system operable to maneuver the one or more floating bodies within the liquid medium; wherein the controllable buoyancy system includes a gas conduit associated with the tether and connected to the one or more floating bodies; wherein the controllable buoyancy system includes a gas pump operably connected to the gas conduit, wherein the controller transmits commands to the gas pump to deliver gas to the one or more floating bodies; a control system operable to control a buoyancy level and a position of the one or more floating bodies; wherein at least one of the floating bodies and the buoyant elements include at least one of an inlet valve, an outlet valve, and a discharge exchange valve operable for controlling a gas volume and a liquid volume internal to the at least one floating body and the at least one buoyant element either individually or together.

In one aspect, the present disclosure includes a deployment apparatus for a submersible inspection vehicle comprising: a rotatable mount connectable to a housing configured to hold a liquid; an extendable arm connected to the rotatable mount; and a tether slidably coupled to the extendable arm and adapted to connect with the inspection vehicle during operation.

In refining aspects the extendable arm includes a plurality of telescoping sections operable to extend and retract a distal end of the extendable arm; wherein the extendable arm includes a plurality of scissor jack links operable to extend and retract a distal end of the extendable arm; wherein the extendable arm includes a plurality of elongate articulating legs operable to move relative to one another; comprising a pivot joint connected between adjacent articulating legs; wherein the pivot joint is a spherical joint to permit angular rotation in any direction; an actuator system coupled to the extendable arm; wherein the actuator system includes at least one of an electronic actuator and a mechanical actuator; wherein the actuator system includes at least one of a pulley, a cable and a biasing member; wherein the mount is rotatable and further comprising an electric motor operably coupled to the rotatable mount to control a position of the extendable arm; a resting fixture adapted to engage with a wall of the housing; an actuating rod extending through the resting fixture being operably connected to the extendable arm; a control system operable to release or retract the tether and control movement of the extendable arm during operation of the inspection vehicle; wherein the tether includes at least one of a mechanical, electrical and pneumatic connection operably coupled with the inspection vehicle.

In another aspect the present disclosure includes a method for deploying an inspection vehicle within a housing at least partially filled with a liquid medium, the method comprising: positioning rotatable mount with an extendable arm proximate an access port located in a wall of the housing; running a tether line between a control mechanism and the inspection vehicle; rotating the arm with the rotatable mount to a desired angular location; moving a distal end of the extendable arm to a desired distance from the rotatable mount; and lowering the inspection vehicle into liquid medium with the tether line.

In refining aspects, the method includes sending control signals to the inspection vehicle through the tether line; moving the vehicle through the liquid in response to the control signals; moving the extendable arm in response to movement of the inspection vehicle; and maneuvering the tether around components internal to the housing with the extendable arm.

In another aspect the present disclosure includes a deployment system for an inspection vehicle comprising: a resting fixture configured to engage with a housing over an aperture formed in a wall of the housing; a mount extending from the resting fixture being configured to fit through the aperture; an extendable arm connected to the mount; a tether engaged along portions of the extendable arm, the tether connectable with the inspection vehicle; and a control mechanism operable to deploy the inspection vehicle from the extendable arm into a liquid medium within the housing.

In refining aspects the extendable arm includes a plurality of telescoping sections operable to extend and retract relative to the mount; wherein the extendable arm includes a scissor jack mechanism to extend and retract relative to the mount; wherein the extendable arm includes a plurality of elongate articulating legs; a pivot joint connected between adjacent articulating legs; wherein the mount is rotatable relative to the housing; an actuator system coupled to the extendable arm, the actuator system operable to move portions of the extendable arm; wherein the actuator system includes at least one of an electronic actuator and a mechanical actuator; wherein the electric actuator is one of a linear actuator and a rotating actuator; wherein the actuator system further comprises an actuator rod connected to the extendable arm; and wherein the control system is operable to move the extendable arm in response to movement of the inspection vehicle.

While the application has been illustrated and described in detail in the drawings and foregoing description, the same is to be considered as illustrative and not restrictive in character, it being understood that only the preferred embodiments have been shown and described and that all changes and modifications that come within the spirit of the applications are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the application, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

1. A system for inspecting a machine, the system comprising:
an inspection vehicle constructed for remote operation while submersed in a liquid medium in a tank of the machine, the inspection vehicle communicatively coupled to the base station, the system comprising two or more of the following:
(A) a vision based modelling system for generating, using at least a plurality of images captured by a plurality of cameras coupled to the inspection device, a model of a submerged object of interest located in the tank;
(B) a mapping system for generating, using at least a some of the plurality of images captured by the plurality of cameras coupled to the inspection device, at least one of a three-dimensional map and three-dimensional field of view of an interior of the tank;
(C) a plurality of status interrogation systems disposed on the inspection vehicle, the plurality of status interrogation systems being operative to capture inspection data regarding a plurality of inspection procedures performed on the machine;
(D) a launching container coupled to a port on a side of the tank, the launching container having a launching chamber and an tank-side valve, the launching chamber sized to receive placement of the inspection device from a position exterior to the tank, the tank-side valve operable to selectively permit ingress of the inspection device into the interior of the tank;
(E) a first signal receiver and a second signal receiver coupled to the inspection vehicle, the first signal receiver structured to receive a first control transmission having a first command and a first heartbeat, the second signal receiver structured to receive a second control transmission having a second command and a second heartbeat, a controller of the inspection vehicle structured to (1) use the first command upon receipt by the controller of the first heartbeat to control an operation of the inspection device, and (2) use the second command upon receipt by the controller of the second heartbeat to control the operation of the inspection device when the first heartbeat is no longer received; and
(F) a ballast system having a pump, a pressure vessel reservoir, and an inflatable bladder, the pressure vessel reservoir in fluid communication via the pump with the inflatable bladder, the pump structured to circulate a fluid between the pressure vessel reservoir and the inflatable bladder to achieve variable buoyancy, wherein movement of the fluid out of the pressure vessel reservoir alters a density of the pressure vessel reservoir to provide a buoyant force for the inspection vehicle.

2. The system of claim 1, wherein the machine is an electrical transformer, and the liquid medium is a transformer coolant.

3. The system of either claim 1, further including a base station having a processing device, the base station being external to the tank and communicatively coupled to the inspection vehicle.

4. The system of claim 3, wherein the first control transmission and the second control transmission are received from the base station.

5. The system of either one of claim 3, and wherein the second signal receiver is a WiFi radio that is structured to transmit image information to the base station.

6. The system of claim 5, wherein the image information is a moving image or a video image.

7. The system of any one of claim 3, further including a third signal receiver structured to receive a third control transmission through a liquid environment from the base station, the third control transmission including a third command used to effectuate an action of the inspection vehicle.

8. The system of claim 7, wherein the third signal receiver is a spread spectrum radio.

9. The system of either claim 7, wherein the control circuit is further structured to use a third command received by the third signal receiver when the first heartbeat and the second heartbeat are no longer received.

10. The system of either claim 8, wherein the spread spectrum radio is a firmware only radio.

11. The system of any one of claim 7, wherein the inspection vehicle is configured to concurrently monitor the first signal receiver, the second signal receiver, and the third signal receiver.

12. The system of claim 1, wherein control information of the second command is redundant to control information of the first command, and wherein the control circuit uses the second command when the first command is determined to be invalid.

13. The system of claim 12, wherein the first command is determined to be invalid when the first heartbeat is no longer received by the first signal receiver.

14. The system of claim 7, wherein the third command is redundant to both the first command and the second command, and wherein the control circuit uses the third command when the first command is determined to be invalid.

15. The system of claim 12, wherein the third signal receiver is a firmware radio, and wherein the control circuit of the first and second command is performed in an electronic circuit that carries out instructions of a computer program, and wherein the control circuit further extends to a hardware based evaluation of a third heartbeat received by the third signal receiver.

16. The system of claim 1, wherein the ballast system further includes a valve disposed between the pressure vessel reservoir and the inflatable bladder, the valve having an open state that permits fluid to flow to the inflatable bladder from the pressure vessel reservoir when power is not applied to the valve.

17. The system of claim 1, wherein the fluid is an incompressible fluid, and wherein the pressure vessel also includes a compressible fluid, the compressible fluid expanding to provide a change in density of the pressure vessel reservoir when the incompressible fluid moves from the pressure vessel reservoir to the inflatable bladder.

18. The system of claim 17, wherein a mass of the compressible fluid in the ballast system includes a first amount structured to provide nominal operational changes in buoyancy to the inspection vehicle, the ballast system also including a second amount structured to provide an emergency ascent change in buoyancy to the inspection vehicle when the valve is in the open state.

19. The system of claim 17, wherein the valve is a blow valve, and wherein the ballast system further includes a vent valve structured to withdraw the incompressible fluid from the inflatable bladder via action of the pump.

20. The system of claim 16, wherein the vent valve is in a normally closed state when the valve is not energized.

21.-1007. (canceled)
